(19) United States
(12) Patent Application Publication
(10) Pub. No.: US 2007/0248261 A1
(43) Pub. Date: Oct. 25, 2007

(54) Systems and methods for collaborative interactive visualization of 3D data sets over a network ("DextroNet")

(75) Inventors: Lu Ping Zhou, Canberra (AU); Luis Serra, Watten Est Condo (SG); Lin Chia Goh, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, S.p.a., Milano (IT)

(21) Appl. No.: 11/649,425

(22) Filed: Jan. 3, 2007

Related U.S. Application Data
(60) Provisional application No. 60/755,658, filed on Dec. 31, 2005.
(60) Provisional application No. 60/845,654, filed on Sep. 19, 2006.
(60) Provisional application No. 60/875,914, filed on Dec. 19, 2006.

(51) Int. Cl. G06K 9/00

(52) U.S. Cl. 382/154

(57) ABSTRACT

Exemplary systems and methods are provided by which multiple persons in remote physical locations can collaboratively interactively visualize a 3D data set substantially simultaneously. In exemplary embodiments of the present invention, there can be, for example, a main workstation and one or more remote workstations connected via a data network. A given main workstation can be, for example, an augmented reality surgical navigation system, or a 3D visualization system, and each workstation can have the same 3D data set loaded. Additionally, a given workstation can combine real-time imagining with previously obtained 3D data, such as, for example, real-time or pre-recorded video, or information such as that provided by a managed 3D ultrasound visualization system. A user at a remote workstation can perform a given diagnostic or therapeutic procedure, such as, for example, surgical navigation or fluoroscopy, or can receive instruction from another user at a main workstation where the commonly stored 3D data set is used to illustrate the lecture. A user at a main workstation can, for example, see the virtual tools used by each remote user as well as their motions, and each remote user can, for example, see the virtual tool of the main user and its respective effects on the data set at the remote workstation. For example, the remote workstation can display the main workstation's virtual tool operating on the 3D data set at the remote workstation via a virtual control panel of said local machine in the same manner as if said virtual tool was a probe associated with that remote workstation. In exemplary embodiments of the present invention each user's virtual tools can be represented by their IP address, a distinct color, and/or other differentiating designation. In exemplary embodiments of the present invention the data network can be either low or high bandwidth. In low bandwidth embodiments a 3D data set can be pre-loaded onto each user's workstation and only the motions of a main user's virtual tool and manipulations of the data set sent over the network. In high bandwidth embodiments, for example, real-time images, such as, for example, video, ultrasound or fluoroscopic images, can be also sent over the network as well.

### CROSS-REFERENCE TO OTHER APPLICATIONS

This application claims the benefit of and incorporates by reference U.S. Provisional Patent Application Nos. (i) 60/755,658, entitled “SYSTEMS AND METHODS FOR COLLABORATIVE INTERACTIVE VISUALIZATION OVER A NETWORK (“DextroNet”), filed on Dec. 31, 2005; (ii) 60/845,654, entitled METHODS AND SYSTEMS FOR INTERACTING WITH A 3D VISUALIZATION SYSTEM USING A 2D INTERFACE (“DextroLap”), filed on Sep. 19, 2006, and (iii) 60/875,914, entitled SYSTEMS AND METHODS FOR COLLABORATIVE INTERACTIVE VISUALIZATION OF 3D DATA SETS OVER A NETWORK (“DEXTRONET”), filed on Dec. 19, 2006.

Additionally, this application also makes reference to (i) co-pending U.S. Utility patent application Ser. No. 10/832,902, entitled “An Augmented Reality Surgical Navigation System Based on a Camera Mounted on a Pointing Device (“Camera Probe”)”, filed on Apr. 27, 2004, and (ii) co-pending U.S. Utility patent application Ser. No. 11/172,729, entitled “System and Method for Three-dimensional Space Management and Visualization of Ultrasound Data (“SonoDex”)”, filed on Jul. 1, 2005.

### TECHNICAL FIELD

The present invention relates to the interactive visualization of three-dimensional (“3D”) data sets, and more particularly to the collaborative interactive visualization of one or more 3D data sets by multiple parties, using a variety of platforms, over a network.

### BACKGROUND OF THE INVENTION

Conventionally, three-dimensional visualization of 3D data sets is done by loading a given 3D data set (or generating one from a plurality of 2D images) into a specialized workstation or computer. Generally, a single user interactively visualizes the 3D data set on the single specialized workstation. For example, this can be done on a Dextroscope™ manufactured by Volume Interactions Pte Ltd of Singapore. A Dextroscope™ is a high-end, true interactive visualization system that can display volumes stereoscopically and that allows full 3D control by users. A DEX-Ray™ system, also provided by Volume Interactions Pte Ltd of Singapore, is a specialized 3D interactive visualization system that combines real-time video with co-registered 3D scan data. The DEX-Ray™ allows a user—generally a surgeon—to “see behind” the actual field of surgery by combining virtual objects segmented from pre-operative scan data with the real-time video into composite images. However, when using a conventional, even high-end, interactive 3D visualization system such as a Dextroscope™ Mor DEX-Ray™, even though there can be multiple display systems, and many people can view those displays by standing near the actual user, the visualization is controlled (and controllable) by only one user at a time. Thus, in such systems there is no true participation or collaboration in the manipulation of the 3D data set under examination by anyone except the person holding the controls.

For example, a DEX-Ray™ system can be used for surgical planning of complex operations such as, for example, neurosurgical procedures. In such surgical planning, as described in the Camera Probe application cited above, a neurosurgeon and his team can obtain pre-operative scan data, segment objects of interest from this data and add planning data such as approaches to be used during surgery. Additionally, as further described in Camera Probe, various points in a given 3D data set can be set as “markers.” The position of the tip of a user's hand held probe from such markers can then be tracked and continuously read out (via visual or even auditory informational cues) throughout the surgery.

Additionally, it is often desirable to have 3D input from the surgical site as the surgery occurs. In such a scenario one or more surgical instruments can be tracked, for example by attaching tracking balls, and interactions between a surgeon and the patient can be better visualized using augmented reality.

Thus, as described in Camera Probe, once surgery begins, combined images of real-time data and virtual objects can be generated and visualized. However, it is generally the case that a surgeon does not dynamically adapt the virtual objects displayed as he operates (including changing the points designated as markers). This is because while operating he has little time to focus on optimizing the visualization and thus exploiting the full capabilities of the 3D visualization system.

Using DEX-Ray™ type systems, a few virtual objects of interest, such as, for example, critical nerves near the tumor or the tumor itself, can be designated prior to the surgery and those objects can be displayed during surgery. The same is the case with marker points. As noted above, Camera Probe describes how a defined number of marker points can also be designated, and the dynamic distance of the probe tip to those objects can be tracked throughout a procedure. While a surgeon could, in theory, adjust the marker points during the procedure, this is generally not done, again, as the surgeon is occupied with the actual procedure and has little time to optimize the augmented reality parameters on the fly.

There are other reasons why surgeons generally do not interact with virtual data during a procedure. First, most navigation system interfaces make such live interaction too cumbersome. Second, a navigation system interface is non-sterile and thus a surgeon would have to perform the adjustments by instructing a nurse or a technician. In the DEX-Ray™ system, while it is feasible to modify the visualization by simply moving the probe through the air (as described in Camera Probe), and thus a surgeon can modify display parameters directly while maintaining sterility, it is often more convenient not to have to modify the visualization environment while operating. In either case, if a dedicated specialist could assist them with such visualizations that would seem to be the best of all worlds.

Similarly, even when using a standard 3D interactive visualization system, such as, for example, the Dextroscope™, for surgical assistance, guidance or planning, it is often difficult to co-ordinate all of the interested persons in one physical locale. Sometimes, for example, a surgeon is involved in a complex operation where it is difficult to completely pre-plan, such as, for example, separation of Siamese twins who share certain cerebral structures. In such procedures it is almost a necessity to continually refer to pre-operative scans during the actual (and lengthy) surgery and to consult with members of the team or even other specialists, depending upon what is seen when the brains are actually exposed. While interactive 3D visualization of pre-operative scan data is often the best manner to analyze it, it is hard for a surgical team to congregate around the display of such a system, even if all concerned parties are in one physical place. Additionally, the more complex the case, the more geographically distant the team tends to be, and all the more difficult to consult pre-operatively with the benefit of the visualization of data.

Finally, if two remote parties desire to discuss use of, or techniques for using, an interactive 3D data set visualization system, such as, for example, where one is instructing the other in such use, it is necessary for both to be able to simultaneously view the 3D data set and other's manipulations.

What is thus needed in the art is a way to allow multiple remote participants to simultaneously operate on a 3D data set in a 3D interactive visualization system as if they were physically present.

### SUMMARY OF THE INVENTION

Exemplary systems and methods are provided by which multiple persons in remote physical locations can collaboratively interactively visualize a 3D data set substantially simultaneously. In exemplary embodiments of the present invention, there can be, for example, a main workstation and one or more remote workstations connected via a data network. A given main workstation can be, for example, an augmented reality surgical navigation system, or a 3D visualization system, and each workstation can have the same 3D data set loaded. Additionally, a given workstation can combine real-time imagining with previously obtained 3D data, such as, for example, real-time or pre-recorded video, or information such as that provided by a managed 3D ultrasound visualization system. A user at a remote workstation can perform a given diagnostic or therapeutic procedure, such as, for example, surgical navigation or fluoroscopy, or can receive instruction from another user at a main workstation where the commonly stored 3D data set is used to illustrate the lecture. A user at a main workstation can, for example, see the virtual tools used by each remote user as well as their motions, and each remote user can, for example, see the virtual tool of the main user and its respective effects on the data set at the remote workstation. For example, the remote workstation can display the main workstation's virtual tool operating on the 3D data set at the remote workstation via a virtual control panel of said local machine in the same manner as if said virtual tool was a probe associated with that remote workstation. In exemplary embodiments of the present invention each user's virtual tools can be represented by their IP address, a distinct color, and/or other differentiating designation. In exemplary embodiments of the present invention the data network can be either low or high bandwidth. In low bandwidth embodiments a 3D data set can be pre-loaded onto each user's workstation and only the motions of a main user's virtual tool and manipulations of the data set sent over the network. In high bandwidth embodiments, for example, real-time images, such as, for example, video, ultrasound or fluoroscopic images, can be also sent over the network as well.

### BRIEF DESCRIPTION OF THE DRAWINGS

FIG. 1 depicts exemplary process flow for an exemplary teacher-type workstation according to an exemplary embodiment of the present invention;

FIG. 2 is a system level diagram of various exemplary workstations connected across a network according to an exemplary embodiment of the present invention;

FIG. 3 depicts exemplary process flow for an exemplary student workstation according to an exemplary embodiment of the present invention;

FIG. 4 depicts exemplary process flow for an exemplary Surgeon workstation according to an exemplary embodiment of the present invention;

FIG. 5 depicts exemplary process flow for an exemplary Visualization Assistant workstation according to an exemplary embodiment of the present invention;

FIG. 6 depicts an exemplary Surgeon's standard (disengaged) view according to an exemplary embodiment of the present invention;

FIG. 7 depicts an exemplary Surgeon's engaged view according to an exemplary embodiment of the present invention; and

FIG. 8 depicts an exemplary Visualization Assistant's view according to an exemplary embodiment of the present invention;

FIG. 9 depicts an exemplary Teacher-Student paradigm architecture according to an exemplary embodiment of the present invention;

FIGS. 10(a)-(e) depicts exemplary views of a Teacher and two Students connected over an exemplary DextroNet according to an exemplary embodiment of the present invention;

FIGS. 11-13 depict FIGS. 10(a)-(c) magnified and sequentially;

FIGS. 14(a)-(c) depict exemplary views of a 3D data set as seen by the exemplary Teacher and two Students of FIGS. 10 in lock-on mode;

FIGS. 15-17 depict the views of FIGS. 14(a)-(c) magnified and sequentially;

FIGS. 18(a)-(c) respectively depict exemplary views of the 3D data set of FIGS. 14(a)-(c) where the Teacher has taken a measurement, and Student 1 has switched to disengaged view mode;

FIGS. 19-21 depict the views of FIGS. 18(a)-(c) magnified and sequentially; FIGS. 22(a)-(c) respectively depict the exemplary views of FIGS. 18(a)-(c) after the Teacher has moved his pen;

FIGS. 23-25 depict the views of FIGS. 22(a)-(c) magnified and sequentially; FIGS. 26-30 depict an exemplary sequence from a teacher's perspective wherein two students join a networking session according to an exemplary embodiment of the present invention;

FIGS. 31 depict two exemplary views of a visualization assistant according to an exemplary embodiment of the present invention;

FIGS. 32-33 depict the two views of FIGS. 31 magnified and sequentially;

FIG. 34 depicts an exemplary surgeon's view corresponding to the visualization assistant views of FIGS. 31 according to an exemplary embodiment of the present invention;

FIGS. 35 respectively depict exemplary visualization assistant's and surgeon's views as both parties locate a given point on an exemplary phantom object according to an exemplary embodiment of the present invention;

FIGS. 36-37 respectively depict the views of FIGS. 35 magnified and sequentially;

FIGS. 38 depict an exemplary visualization assistant aiding a surgeon to locate a point on an exemplary object according to an exemplary embodiment of the present invention;

FIGS. 39-40 respectively depict the views of FIGS. 38 magnified and sequentially;

FIGS. 41 depict further exemplary views of each of the assistant and surgeon collaboratively locating a point on an exemplary object according to an exemplary embodiment of the present invention;

FIGS. 42-43 respectively depict the views of FIGS. 41 magnified and sequentially;

FIG. 44 depicts an exemplary fluoroscopy image;

FIG. 45 depicts an exemplary interventional cardiologist's view;

FIG. 46 depicts an exemplary visualization assistant's view corresponding to FIG. 45 according to an exemplary embodiment of the present invention;

FIG. 47 depicts an exemplary picture-in-picture image generated by the exemplary visualization assistant of FIG. 46 according to an exemplary embodiment of the present invention;

FIG. 48 depicts other exemplary 3D views of the visualization assistant of FIGS. 46-47 according to an exemplary embodiment of the present invention;

FIG. 49 depicts an alternative exemplary interventional cardiologist's view according to an exemplary embodiment of the present invention;

FIG. 50 depicts an exemplary first stage of an exemplary role-switch process according to an exemplary embodiment of the present invention;

FIG. 51 depicts an exemplary second stage of an exemplary role-switch process according to an exemplary embodiment of the present invention;

FIG. 52 depicts an exemplary third and final stage of an exemplary role-switch process according to an exemplary embodiment of the present invention;

FIGS. 53(a) and (b) depict exemplary data sending queues on an exemplary teacher (or main user) system according to an exemplary embodiment of the present invention;

FIG. 54 depicts an exemplary message updating format according to an exemplary embodiment of the present invention;

FIGS. 55(a)-(c) depict exemplary updating messages for an exemplary control panel, widget and tool, using the exemplary message format of FIG. 54, according to an exemplary embodiment of the present invention;

FIG. 56 depicts an exemplary message regarding a file transfer utilizing the exemplary message format of FIG. 54 according to an exemplary embodiment of the present invention;

FIG. 57 depicts an alternative exemplary message updating format according to an exemplary embodiment of the present invention; and

FIGS. 58(a) and (b) depict exemplary file transfer messages utilizing the exemplary message format of FIG. 54, according to an exemplary embodiment of the present invention.

It is noted that the patent or application file contains at least one drawing executed in color. Copies of this patent or patent application publication with color drawings will be provided by the U.S. Patent Office upon request and payment of the necessary fees.

### DETAILED DESCRIPTION OF THE INVENTION

I. Overview

In exemplary embodiments of the present invention, various types of 3D interactive visualization systems can be connected over a data network, so that persons remote from one another can operate on the same 3D data set substantially simultaneously for a variety of purposes. In exemplary embodiments of the present invention, two or more persons can be remotely located from one another and can each have a given 3D data set loaded onto their workstations. In general, such exemplary embodiments contemplate a “main user” and one or more “remote users.” The participants can, for example, be collaborators on a surgical planning project, such as, for example, a team of doctors planning the separation of Siamese twins, or they can, for example, be a teacher or lecturer and a group of students or attendees. Additionally, for example, the participants can comprise (i) a surgeon or other clinician operating or performing a diagnostic or therapeutic procedure on a patient using a surgical navigation system (such as, for example, a Dex-Ray™ system) or some other diagnostic or therapeutic system (such as, for example, a Cathlab machine, a managed ultrasound system, etc.) and (ii) a visualization specialist dynamically modifying and visualizing virtual objects in the relevant 3D data set from some remote location as the surgeon or clinician progresses, not being burdened by the physical limitations of the treatment or operating room. Or, alternatively, the participants can include a teacher and one or more students in various educational, professional, review, or customer support contexts.

In what follows, the present invention will be described using various possible paradigms, or exemplary uses, the invention not being limited by any of such exemplary uses. It is understood that functionalities of the present invention are applicable to a wide variety of applications where study of, or collaborations of various types in, the sophisticated visualization of a 3D data set is desirable or useful.

For ease of illustration, various exemplary embodiments of the present invention will sometimes be referred to as a “DextroNet”, which is a contemplated trademark to be used by the assignee hereof in connection with such various embodiments.

A. Dextroscope™ to Dextroscope™ Type Interaction

In exemplary embodiments of the present invention, a DextroNet can be used, for example, for remote customer training or technical support, or remote consultation between the manufacturer of a 3D interactive visualization system and its customers. For example, a DextroNet can be used by a manufacturer of interactive 3D visualization systems to offer remote on-demand technical support services to its customers. In such a use, for example, a customer can connect with a training center any time that he has a question regarding the use of a given 3D interactive visualization system provided by such a manufacturer. Once connected, a remote training technician can, for example, show a customer how to use a given tool, such as, for example, the Contour Editor on the Dextroscope™. To avoid requiring the customer to send his entire data set (with potential issues of patient confidentiality and time wasted in transferring the data) such exemplary training could be performed on a standard data set that is loaded by both parties at the start of the remote training session. Another service that can be provided to customers that exploits the use of a DextroNet, can, for example, involve preparing (segmenting) patient data for a customer off-line. For example, in a medical context, a customer can ftp data associated with one or more patients or cases of interest, and a “radiological services” department can segment it, and send it back to the customer. In connection with such a service, an on-line demonstration of what was done, or even remote training on the actual patient data which the customer is dealing with could be provided according to an exemplary embodiment of the present invention.

In exemplary embodiments of the present invention, remote consultation can also be supported. In such embodiments, a team of specialists such as, for example, surgeons and radiologists, imaging technicians, consulting physicians, etc., can discuss a case, various possible surgical approaches to take in the case, and similar issues, all remotely over a DextroNet. For example, a radiologist can give provide his view, a vascular neurosurgeon his view, and a craniofacial expert yet another, all with reference to, and virtually “pointing” at various volumetric objects in, a given 3D data set generated from scanning data of the case.

B. Dextroscope™ to DEX-Ray™ Type Interactions

As described in Camera Probe, a DEX-Ray system can be used as a surgical navigation device. Such devices can be connected over a DextroNet to standard interactive 3D display systems. Thus, in exemplary embodiments of the present invention, 3D data manipulation capabilities can be “outsourced” to remove the constraints imposed by a surgeon's sterile field. For example, when a surgeon has a DEX-Ray™ type probe inside a patient's skull, he is generally unable to control the interface of the surgical navigation system, unless he starts shouting commands to someone near the base computer. That, of course, would also be undesirable since such a computer is generally fully occupied with controlling the probe and rendering images/video.

With the probe inside a patient's skull, and a surgeon trying to find his way around the patient's brain (i.e., pointing at different regions, and not being able to point beyond tissue he has not cut yet), a surgeon would need help to inspect other imaging modalities, other segmented structures (tumor, vessels, nerves (such as via diffusion tensor imaging, for example)) without changing the probe's position very much. In such a scenario a surgeon can point with the probe, and can also talk/hear, but cannot afford to move in and out of the skull too often. In this situation it would be useful to have another surgeon (or an assistant with technical expertise) help in providing different visualizations. Such different visualizations could, for example, show which vessels the surgeon is nearest to, which nerves surround the tumor, etc. Such “visualization assistant” can be connected to the surgeon's navigation system via a DextroNet.

C. Dextroscope™ to Cathlab™ Type Interactions

Alternatively, in exemplary embodiments of the present invention, a similar paradigm to that of a DexRay™ to Dextroscope™ interaction can, for example, utilize online information in the form of an X-Ray fluoroscopy display. Here a remote assistant can, for example, help to fine tune the coregistration between substantially real-time X-Ray views (2D projections) and 3D views (from, for example, CT or MR scans of a heart) generated from prior scans of the individual. Because vessels are not visible in X-Rays, an interventional cardiologist is forced to inject contrast to make them opaque for a few seconds so as to see them. Injection of contrast is not indicated for people with renal problems, and in any case, contrast should be minimized for the sake of the patient (for both health as well as hospital bill considerations). Therefore, a visualization assistant could use the brief seconds of contrast flow to synchronize the X-Ray view of patient with, for example, a pre-operative CT. This information could be presented, for example, as augmented virtual objects over the X-Ray views, for example, it can be displayed in another monitor next to the X-Ray views. For example, a heart can be beating in the X-Ray views, and the CT could also beat in with it, or simply show a frozen instant that can help in guiding the cardiologist to follow the right vessel with a catheter.

In exemplary embodiments of the present invention, it can be assumed that only one person controls the interactions that affect the 3D data (a “main user”), and that the other participants (“remote users”) connected over a DextroNet can watch those effects, but cannot change the data itself, rather just their own viewpoints of the data. Additionally, in such exemplary embodiments a DextroNet can, for example, send only the main user's 3D interaction details over the network and then have those interactions executed at each remote workstation or system. This is in contrast to conventional systems where one user sends data regarding his interactions to a remote server, and the remote server then does the computations and sends back final computed images, without indicating to a remote viewer the sequence of steps or operations that generated the final images of the 3D data.

Such conventional solutions, such as, for example, SGI's VizServer™, offer only one-way networks. In exemplary embodiments of the present invention, a DextroNet can be a many way network. Approaches such as that of the VizServer™ rely on the assumption that a user only requires the final projection from a given 3D scene. If just a projection (or even, for example, a pair of projections for stereo) is needed, then a remote computer can calculate (render) an image and send the resulting pixels to the client, who then sees an image indistinguishable from what he would have obtained by rendering locally. The user can move the cursor to, say, cause a rotation operation, and the command can be sent to the remote server, the 3D model can be rotated, the model can be rendered again, and the image sent to a client for viewing. However, such a conventional approach does not allow other users to insert their own 3D interaction devices (such as a stylus, probe, etc.) into the 3D model, since there is no depth information about the model with respect to the stylus. It also does not allow a client to produce detachable viewpoints (described below), since all that is available are the pixels coming from the viewpoint of one user.

Moreover, such an approach cannot demonstrate to a remote user exactly what steps were taken to obtain a final rendering. If he was interested in actually learning such interactive command sequences, he could not. In contrast, in exemplary embodiments of the present invention, the 3D models can be available at each workstation (for example, at the respective stations of a teacher and students, or, for example, of a visualization assistant and surgeon, or, for example, of a visualization assistant and other diagnostician or therapist performing a procedure on a physical patient) and then the 3D of the model can be combined with the 3D of the users (i.e., the tools, and other objects), and then having each station can perform its own rendering.

To affect data remotely, in exemplary embodiments of the present invention, the 3D interactions of a main user's stylus can be arranged, for example, to interact with a (remote) virtual control panel of a remote user. In such exemplary embodiments, such control panel interactions need not be translated to system commands on the remote machine such as, for example, “press the cut button” or “slide the zoom slider to 2.0”, etc. Rather, in such exemplary embodiments, a given main user's operation can appear in the remote user's world, for example, as being effected on the remote user's machine as a result of the main user's tool being manipulated, by displaying an image of the main user's tool on the remote user's machine. On the remote user's side, when a main user's tool appears at a position above a button on a remote user's virtual control panel, and its state is, for example, “start action” (one of four exemplary basic states of a tool), the button can then pressed and no special command needed. In this way, a remote tool can work by the same principle as do local tools on either the main user's or the remote user's sides. Thus, compared with using extra system commands to effect manipulations instigated at the main user's machine (or using the conventional VizServer™ approach), this can achieve a more seamless integration. Another reason for not using system level commands is to avoid an inconsistent view on a remote user's side. If, for example, stylus interaction with a virtual control panel on a remote user's side is not consistent, although the tool still can function via system commands, a remote user can be confused if he sees that a tool is above button “A” while function or operation “B” happens. If the display of the tool's position, etc., can be synchronized, as described above, extra system commands are not needed and the tool will take care of itself.

It is noted that the calibrations of a virtual control panel can vary between users on different platforms. This is because there can be several hardware and software configurations of the various 3D visualization systems that can be connected via an exemplary DextroNet. For example, to illustrate using various systems provided by the assignee hereof, Volume Interactions Pte Ltd, a DextroBeam™ does not have a itreflected” calibration since it has no mirror, while a DextroLAP™ system uses a mouse and does not use a 3D tracker. Thus, in exemplary embodiments of the present invention, a main user's 3D calibration can be sent to all connected remote users, who can, in general, be connected via various 3D interactive visualization system platforms of different makes and models. Such calibration sending can insure, for example, that the 3D interactions performed by a main user hit the right buttons at the right time on a remote user's. Thus, when connecting to a DextroNet, a protocol can, for example, cause the control panel on the remote user's side to be the same as on the main user's side (as regards position, orientation, size, etc.), so that the main user's operations on his control panel can be duplicated on the various remote users' machines.

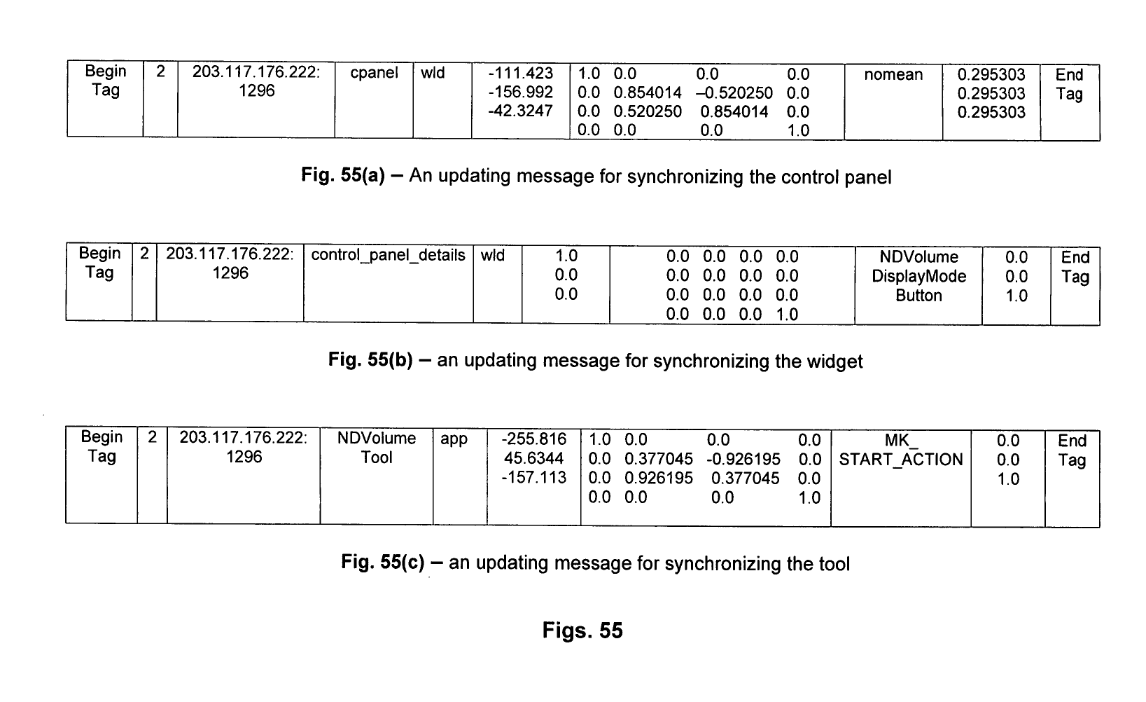

When a main workstation synchronizes interface and viewpoint with a remote workstation, it can, for example, send the parameters of its control panel, as described below in connection with FIG. 55(a), as well as the position and orientation of the displayed objects, as described below in connection with FIG. 55(b), to the remote workstation. Thus, when the remote workstation receives these parameters, it can, for example, update its own control panel and locally displayed objects using this information. Once this process has been accomplished, a main user's tool can, for example, be used to manipulate a remote control panel, and the initial viewpoints of the main user and the remote user(s) can be the same.

Various exemplary paradigms are described in this application. It is noted that for economy of words features may be described in detail in connection with the “Teacher-Student” paradigm that are also applicable to the “Surgeon-Visualization Assistant” paradigm, or vice versa, and will not be repeated. It is understood that the “Surgeon-Visualization Assistant” paradigm functions as does the “Teacher-Student” paradigm, the latter adding recorded or real-time video, real-time imaging (e.g., fluoroscopy, ultrasound, etc.) or real-time instrument positional information, each co-registered to the 3D dataset.

D. DextroNet Educational (Teacher-Student) Paradigm

In exemplary embodiments of the present invention a DextroNet connection can be used educationally. For example, a DextroNet can be used to instruct students on surgical procedures and planning or, for example, the use of an interactive 3D visualization system, such as, for example, the Dextroscope™. In addition, an exemplary DextroNet can be used for anatomical instruction. For example, such an implementation can be used to familiarize students with particularly complex anatomical areas of the body. Furthermore, an exemplary DextroNet can also be used, for example, for pathological instruction, and can thus be used as a supplementary teaching tool for post-mortem exams (this may be especially useful where a patient may have died during surgery, and pre-operation plans and scan data for such a patient are available).

In exemplary embodiments of the present invention, an instructor (who could also be, for example, a doctor, a surgeon, or other specialist) who is familiar with the Dextroscope™, DextroBeam™, or DEX-Ray™ systems or their equivalents, can, for example, teach at least one remotely located student via a DextroNet. Students can have the same viewpoint vis-à-vis the 3D model as the instructor, or, for example, can have a different viewpoint. For example, a student may have one display (or display window) with the instructor's viewpoint, and another display (or display window) with a different viewpoint. Alternatively, for example, a student or instructor could toggle between different viewpoints. This can, for example, be like having a picture-in-picture, with one picture being the remote viewpoint and the other the local picture, similar to how video conferencing operates. In such an exemplary embodiment, both pictures could be generated at the local workstation (one with the local parameters, and the other with the remote parameters), or, for example, the remote picture could be rendered remotely, and sent in a manner similar to that of the VizServer™ approach (sending only the final pixels, but not the interaction steps). Thus, a given user could see exactly what a remote user is seeing, removing all doubt as to “are you seeing what I am seeing?”

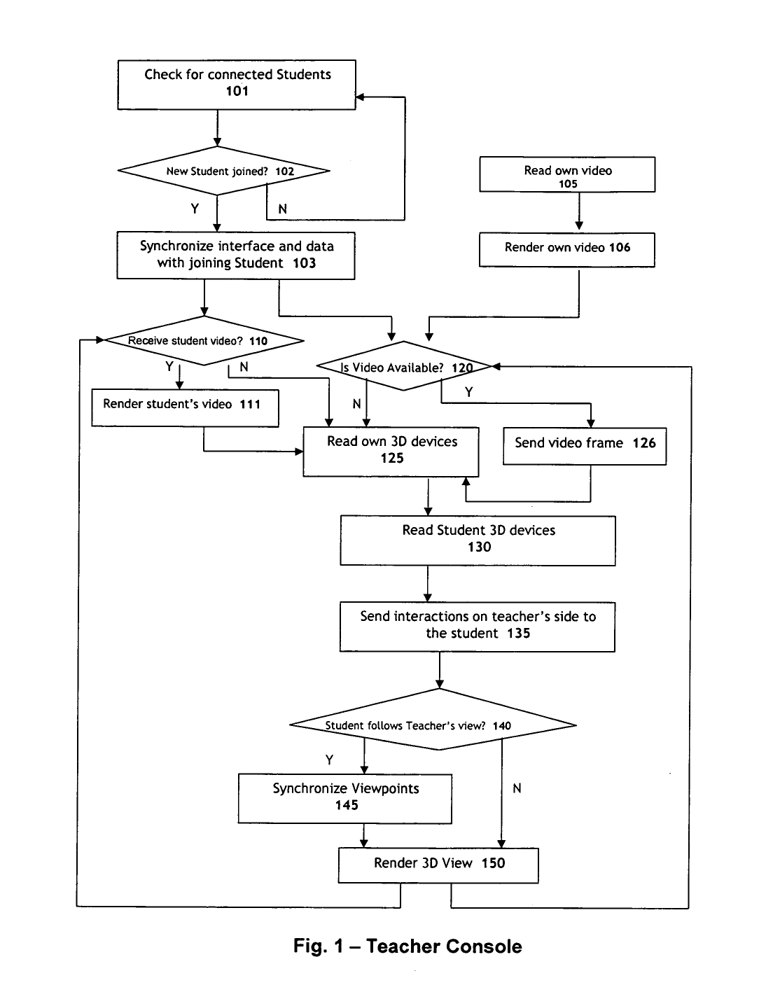

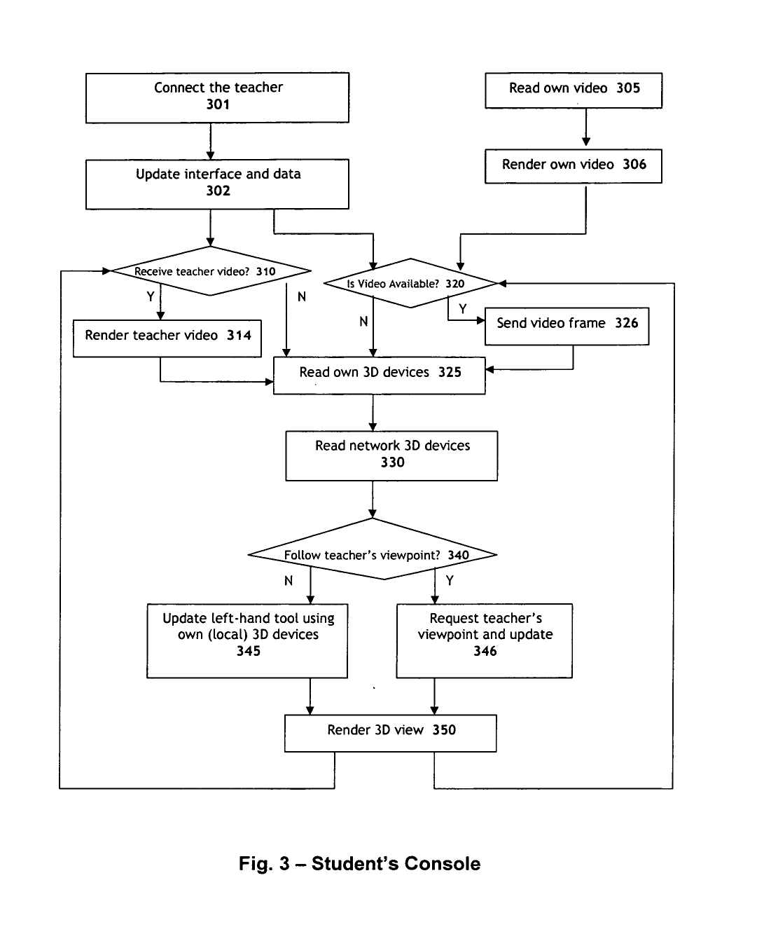

For ease of illustration, the participants in such an educational embodiment will be referred to as “teacher” or “instructor” (main user) and “student” (remote user). An exemplary teacher-student paradigm is next described in connection with FIGS. 1 and 3.

In exemplary embodiments of the present invention, a teacher can, for example, not be able to see a student's real-time view image, but can be informed what a student is looking at (which can imply the student's interest area) by the pointing direction of the student's tool which is displayed in the teacher's world. While one cannot “know” exactly the viewpoint of a remote station from the appearance of a remote stylus, one can infer something about its position from known or assumed facts. For example that the stylus is used by a right-handed person who is pointing forward with it, etc.

Such an exemplary scenario is designed to allow a teacher to be able to teach multiple students. Thus, a teacher need not be disturbed unless a student raises a question by voice or other signal. Then, based on the needs of such a questioning student, an exemplary teacher can, for example, rotate a given object and easily align his viewpoint to the student's viewpoint, since he can substantially determine how the student is looking at an object from the direction of that student's tool. Alternatively, teacher and student can reverse their roles, which, in exemplary embodiments of the present invention, can be easily accomplished, for example, by a couple of button clicks, as described below (“Role Switch”). As noted, in exemplary embodiments of the present invention, in a teacher-student paradigm, a student cannot, for example, manipulate an object locally except for certain operations that do not alter a voxel or voxels as belonging to a particular object, such operations including, for example, translating, rotating and/or pointing to the object, or zooming (changing magnification on the object. This is generally necessary to prevent conflicting instructions or interactions with the 3D data set.

In general, the local control that a remote user (such as, for example, a student, a surgeon, or a visualization assistant not acting as a teacher) can exercise can often be limited. This is because, in general, a teacher's (or visualization assistant's) manipulation of the data set is implemented locally on each student's (or surgeon's) machine, as described above. I.e., the main user's interactions are sent across the network and implemented locally. The main user thus has control of the remote user's (local) machine. In such exemplary embodiments, if a student is allowed to change his or her local copy of the data set in a way that the teacher's manipulations no longer make sense, there can be confusion. For example, on a standard Dextroscope™ a user has complete control of the segmentation of the objects in the 3D data set. He can change that segmentation by changing, for example, the color look up table of an object. Alternatively, he can leave the segmentation alone and just change the colors or transparency associated with an already segmented object. While this latter operation will not change the original contents of an object, it can change its visualization parameters.

It is further noted that there are many tools and operations in Dextroscope™ type systems, as well as in interactive 3D data set visualization systems in general, that operate based upon certain assumptions about the size of the objects being manipulated. For example, there are pointing tools which operate by casting a ray from the tip of a tool to the nearest surface of an object. If the surface of an object has gotten closer to such a pointing tool or gotten farther away from such a pointing tool because a local user changed the segmentation of the object, when a teacher picks up his pointing tool and points at the object, when implemented on a student's screen such a pointing tool may touch an entirely different object. In fact, on the student's machine it could go right through what is, on the teacher's machine, the surface of the object. In general, drilling tools, picking tools, contour extraction tools, isosurface generation tools and a variety of other tools can be similarly dependent upon the size of the objects they are operating upon. Therefore, as noted, in exemplary embodiments of present invention, the local control panel of a student can be surrendered to the control of the teacher. In such exemplary embodiments, all that a student can do is disengage from the viewpoint of the teacher and rotate, translate, magnify (zoom) or adjust the color or transparency (but not the size) of objects as he may desire. Thus, the relationship between the teacher and each object is preserved. It is noted that there is always an issue of how much local control to give to a student. In exemplary embodiments of the present invention, that issue, in general, can be resolved by allowing any local action which does not change the actual data set.

Nonetheless, in exemplary embodiments of the present invention, increasing degrees of complexity can be added by allowing a local user to perform certain operations which do not “really” effect his local data but, rather, operate on local copies of the data whose effects can then be displayed, while the main user's operations are displayed in a “ghosted” manner.

For example, a teacher may be illustrating to one or more students how to take various measurements between objects in a 3D data set using a variety of tools. The teacher can take measurements and those will, of course, be seen by the student. However, the teacher may also desire to test the student's ability to take similar measurements and may ask him to apply what he has just been taught, and to take additional measurements that the teacher has not yet made. A student can, for example, take those measurements and they can, for example, be displayed on his machine. The teacher can then, for example, take a snapshot of the student's machine and evaluate the competency of the student. In similar fashion, a student can be allowed to manipulate the data set which can be displayed on his display wherein the “real” data set and its ureal” manipulations by the teacher can also be shown, but in a “ghosted” manner. In this way, all of the teacher's manipulations can operate on ghosted boundaries of objects, as displayed on the student's machine, and the student's local operations can be displayed on his machine, to the extent necessary (i.e., to the extent that they would have affected the 3D data set) in a solid fashion. Thus, a student can, for example, be allowed to perform other manipulations besides translation, rotation, pointing, and/or zooming, etc., as described above, but all at the cost of greater complexity and additional local processing.

It is noted that the above-described exemplary embodiment requires that a student create a copy of an entire data set (including 3D objects as well as control panel) when he enters such an “enhanced” disengaged mode. Under those circumstances a student can, for example, operate on the local (copy) data set, while the teacher can operate on the original data set, shown on the remote user's, or student's, machine in a ghosted fashion. Thus, two independent graphics processes can, for example, operate in parallel on the same (student's) workstation. If the teacher wants to see a novel approach developed by the student, he can take a snapshot of the student's view and they can both discuss it.

In exemplary embodiments of the present invention, using role-switch, where the teacher role can thus be passed around from participant to participant, a student can take over control from a teacher. He can, for example, continue the teacher's work on the object or give his opinion by demonstrating how to conduct an operation or other procedure. This allows for collaboration by all participants. Because in such exemplary embodiments only one teacher exists at a given time over a network, such collaboration can be serial, without conflict problems.

In exemplary embodiments of the present invention, a DextroNet can be supported by various networks of different bandwidth. In one exemplary embodiment, when DextroNet is used for educational instruction, a low speed network can, for example, be used. Each of the 3D interactive visualization systems connected via an exemplary DextroNet can, for example, have a local copy of the imaging and video data for a surgical plan, surgical procedure, or anatomical structure. Thus, tracking data, control signals, or graphical or image parameter data, which are typically small in size, can be sent across the network. Generally speaking, in a DextroNet the networking information can be, for example, divided into two types: message and file. Messages can include, for example, tracking data, control signals, etc. Files can include, for example, graphical and image data, which can be compressed before it is sent. This is described more fully below.

As noted, in exemplary embodiments of the present invention, actions introduced by one user can be transferred to the remote location of a least one other user (student or teacher), where the second workstation locally calculates the corresponding image. Voice communication between networked participants can be out of band, such as, for example, via telephone in a low speed network embodiment, or, for example, in an exemplary high-speed network embodiment, through a voice-over-network system, such as, for example, Voice Over Internet Protocol (“VoIP”). In addition, a high-speed network can accommodate the transfer of mono or stereo video information being generated by a camera probe as described in the Camera Probe application. This video information can, for example, be combined with a computer generated image, or may be viewable on a separate display or display window. Displaying video (or image snapshots), which is not 3D, can generally only be seen as a “background.” This is because an image or a video (series of images) are projections of the real world and do not contain 3D information. Therefore, objects visible in such images or video cannot be accurately positioned in front of 3D objects. Such display possibilities are described more fully below.

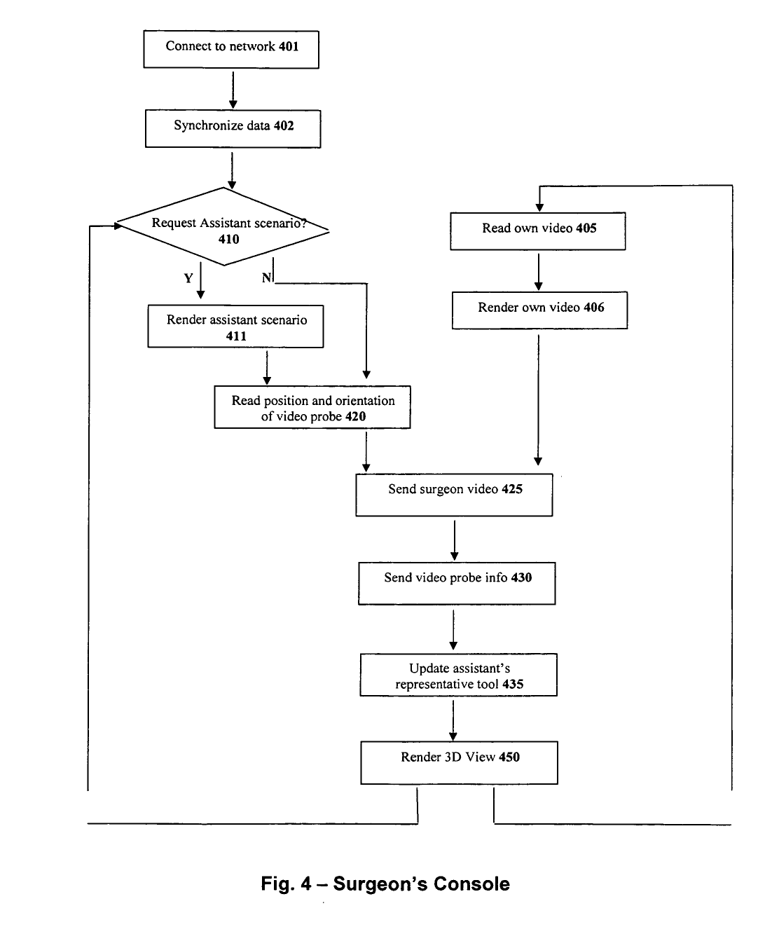

In exemplary embodiments of the present invention, a DextroNet can, for example, support working both collaboratively and independently. An exemplary system can, for example, be used as a stand-alone platform for surgical planning and individual training. In such an embodiment, for example, a system configuration can be locally optimized. The interface's position and orientation on the student's system can thus be different from those on the instructor's system. However, if the networking function is activated, a student's system can, for example, have its system configuration changed to match This is described in detail below as the Surgeon-Assistant paradigm in connection with FIGS. 4-8.

A visualization assistant's task can be, for example, to be in voice contact with, for example, the surgeon as he operates, and to dynamically manipulate the 3D display to best assist the surgeon. Other remote users could observe but, for example, as remote users, would not be free to manipulate the data.

For example, assume a surgeon uses a DEX-Ray™ system in connection with a neurosurgical procedure. In such an exemplary implementation his main display is restricted to those parts of the data set viewable form the viewpoint of the camera, as described in the Camera Probe application. The visualization assistant, however, can be free to view the virtual data from any viewpoint. In exemplary embodiments of the present invention a visualization assistant can have two displays, and see both the surgeon's viewpoint as well as his viewpoint. For example, he can view the surgery from the opposite viewpoint (i.e., that of someone fixed to a tumor or other intracranial structure and watch as the surgeon “comes into” his point of view from the “outside”.

For example, say a surgeon is operating near the optic nerve. As described in the Camera Probe application, a user can set one or more points in the data set as markers, and watch the dynamic distance of the probe tip to those markers being continuously read out. In addition, a user can do the same thing with one or more tracked surgical instruments (which would not acquire a video image), so that a visualization specialist can, for example, offer input as a surgeon is actually operating. While the surgeon cannot afford to devote the entire display to positions near the optic nerve, a visualization assistant can.

Thus, for example, a visualization assistant can digitally zoom the area where the surgeon is operating, set five marker points along the optic nerve near where the surgeon is, and monitor the distance to each, alerting the surgeon if he comes within a certain safety margin. Additionally, the new markers set by the visualization assistant, and the dynamic distances from each such marker can also be visible, and audible, as the instructor's system. This can avoid mismatch problems that may exist between coordinate systems.

E. DextroNet Surgeon-Visualization Assistant Paradigms

In another exemplary embodiment of the present invention, an instructor can, for example, teach at least one student located remotely, and a “visualization assistant” can assist the instructor by manipulating images and advising the steps necessary to see what such an assistant sees, or alternatively, by the teacher role being periodically transferred to such an assistant so that all can see his viewpoint. For example, a visualization assistant can manipulate images in order to highlight objects of interest (such as by, for example, altering the color look table or transparency of an object); magnify (zoom) objects of interest; change the orientation or viewpoint; play, stop, rewind, fast forward or pause video images of a recorded procedure; provide a split screen with different viewpoints; combine video images with computer generated images for display; toggle between displaying mono and stereo images (whether they are video images or computer generated images); as well as perform other related image manipulation and presentation tasks. By having a visualization assistant participate, in addition to an instructor and students, an instructor can, for example, concentrate on teaching the students, rather than devoting attention to the manipulation of images. In addition, students who may not be familiar with the operation of 3D interactive imaging systems can be assisted in obtaining the viewpoints and information that they may need when the assistant is passed the system control and thus becomes the teacher.

In exemplary embodiments of the present invention a surgeon or physician and a “visualization assistant” can collaborate during actual surgeries or other medical procedures over a DextroNet. In such embodiments the visualization assistant can generally act as main user, and the physician as remote user. The surgeon or physician can, for example, be operating or performing some medical, diagnostic or therapeutic procedure on a patient in an operating or treatment room, and the visualization assistant can be remotely located, for example, in the surgery department, in a gallery above the surgery, in an adjacent room, or in a different place altogether. the case may be, on the surgeon's system display, because the visualization assistant, a main user, controls the 3D data set.

As described in Camera Probe, a user can identify various virtual structures to include in a combined (augmented reality) image. Ideally this can be done dynamically as the surgery progresses, and at each stage the segmentations relevant to that stage can be visualized. Practically, however, for a surgeon working alone this is usually not possible as the surgeon is neither a visualization expert nor mentally free to exploit the capabilities of the system in a dynamic way. However, a visualization assistant is. As the surgeon comes near a given area, the visualization assistant can add and remove structures to best guide the surgeon. For example, he can segment objects “on the fly” if some structure becomes relevant which was not segmented prior to surgery, such as, for example, a portion of a cerebral structure which has fingers or fine threads of tumor which did not come through on any pre-operative scan. Thus, in exemplary embodiments of the present invention, a remote viewer can have more freedom and can thus do any image processing that was not done during preplanning, such as, for example, adjusting colorization, transparency, segmentation thresholds, etc., to list a few.

To use an analogy, a surgeon can be seen as analogous to a football coach having his assistant (visualization assistant) watching the game from a bird's eye view high in a press box above the playing field, and talking to the coach over a radio as he sees patterns in the other team's maneuvers. Such a consultant, in exemplary embodiments of the present invention, can, for example, see both his screen as well as the surgeon's, and the consultant can thus dynamically control the virtual objects displayed on both, so as to best support the surgeon as he operates.

II. Teacher-Student Interactions

A. Exemplary Process Flow

What will next be described is process flow according to exemplary embodiments of the present invention in an exemplary teacher-student paradigm.

FIG. 1 depicts an exemplary teacher type console according to an exemplary embodiment of the present invention. With reference thereto, at 101 an exemplary system can check for any students that have connected. Thus, at 102 there can be a decision whether a new student has joined or not. If yes, at 103 the interface and data can be synchronized between the teacher console and the student console for the student that has just joined. If no, process flow can return to 101 where the system can continue to check for any students that may have joined.

Returning to 103, once a new student has joined a DextroNet, such as, for example, by explicitly clicking a button on his console's 3D interface, a teacher can, for example, send the student messages to synchronize their respective interfaces and objects, such as for example, sliders, buttons, etc. Such messages can include, for example, the position, orientation, and size of the teacher's control panel, the states of virtual window gadgets (“widgets”) on the control panel, such as, for example, buttons up or down, color look up table settings, the position, orientation and size of virtual objects in the data set, and any available video. Alternatively, If a teacher finds the data on the student's side to be too different from his own then the teacher can choose to perform a complete synchronization of the entire dataset between his and the student's respective consoles. This can be accomplished, for example, by the teacher's console compressing the dataset (excluding snapshots and recordings) and transferring it to the student newly joining the DextroNet session. Once the interface, as well as the data shared by the teacher and newly joining student, have been synchronized, the preparations for their collaborative interactive visualization have been completed and process flow can continue to the main loop comprising the remainder of FIG. 1, as next described.

At 110, an exemplary teacher system can query whether student video has been received. This can occur if the student is operating a Dex-Ray™ type system, for example. If yes, process flow can continue to 111 where said student's video can be rendered and process flow can continue to 125. If at 110 no student video has been received, process flow can move directly to 125. Additionally, if the teacher's workstation has video available it can be read at 105 and rendered at 106, and process flow can move to 120 where the system can query whether any such video is available.

As noted, at 120, the availability of teacher video is determined. If yes, the video frame can be sent at 126, and process flow can move to 125. If no, process flow can move directly to 125, where teacher 3D devices can be read. Here, the teacher can update the positions, orientations and states of his virtual tools (such as, for example, a stylus, an avatar indicating current position of teacher in the data set, or a drill) from the local tracking system which continually tracks the movement and state of the three-dimensional controls by which an operator interacts with the dataset. For example, in a standard Dextroscope™ running a colonoscopy application, such 3D controls can be, for example, a stylus and a joystick held by a user (here the teacher) in each of his right and left hands, respectively. Or, for example, if running other applications on a Dextroscope™, a user can, for example, hold a 6D controller in his left hand instead. Once the teacher's side 3D devices have been read at 125, the network (student) 3D devices can be read at 130, where the teacher workstation can, for example, update the position, orientation and state of the representative tool of the student via messages received from the student's workstation over the network.

From 130, process flow can, for example, move to 135 where interactions on the teacher side can be sent across the network to the student. Here, the teacher can send the positions, orientations and states of any tools he is using, such as, for example, cropping tools, drills, slice viewer tools, etc., as well as his keyboard events, to the student. Such positions and orientations can be converted to world coordinates, as described below in the Data Format section. From 135, process flow can, for example, move to 140 where it can be determined whether or not the student currently desires to follow the teacher's view at the local student display. If yes, at 145 the viewpoints can be synchronized. I.e., once the teacher has received a student's request for synchronization of viewpoints, the teacher can send the position, orientation and size of the virtual objects in his workstation to the student. If no at 140, and the student thus chooses to follow his own viewpoint, process flow can continue to 150 where the 3D view of the dataset can be rendered. Because these interactions are ongoing, from 150 process flow loops backs around to 110 and 120 where, for example, it can repeat as long as a DextroNet session is active, and interactions and manipulations of the 3D data set are continually being sent over the network. Moreover, as described below, a student can toggle between seeing the teacher's viewpoint and seeing his own (local) viewpoint, not restricted by that of the teacher. The current state of the student's choice of viewpoint can thus continually be tested for and recognized at each loop through 140.

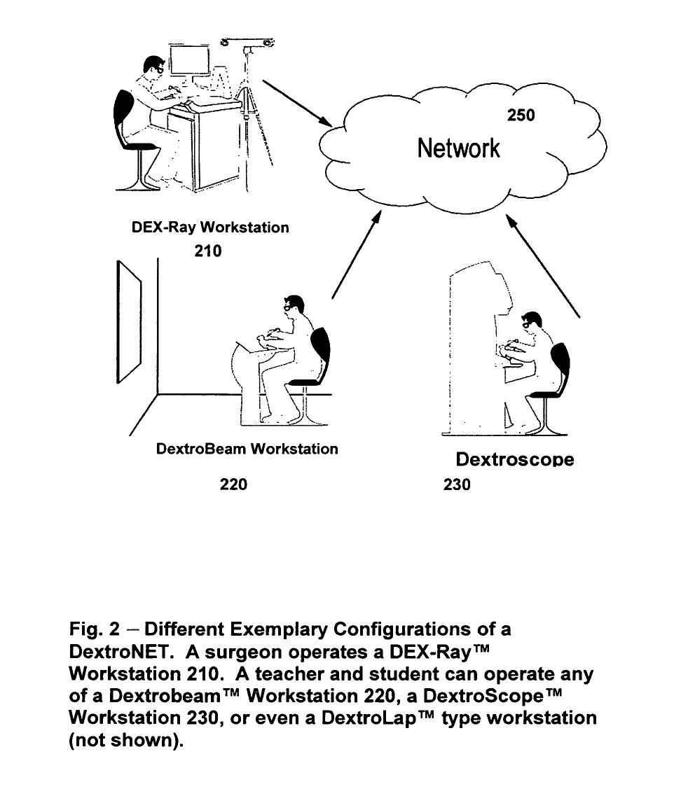

Before describing process flow at a corresponding student console, various exemplary configurations of a DextroNet according to exemplary embodiments of the present invention will next be described in connection with FIG. 2.

FIG. 2 illustrates an exemplary DextroNet network 250 and various consoles connected to it. The exemplary connected devices are all products or prototype products of Volume Interactions Pte Ltd of Singapore. For example, a DEX-Ray™ type workstation 210 can be connected to a DextroNet. As described above, a DEX-Ray™ type workstation is a workstation implementing the technology described in the Camera Probe application. Such technology is useful in a variety of contexts including, for example, neurosurgical planning and navigation. In a DEX-Ray™ type workstation, a combined view of segmented and processed preoperative 3D scan data, or virtual data, and real time video, of, for example, a brain, can be generated. A DEX-Ray™ type workstation can function as a teacher console where a neurosurgeon, using a DEX-Ray™ type workstation, can illustrate to others connected across a network such combined images as he implements surgical planning or even as he performs surgery. Or, more conveniently, the DEX-Ray™ type workstation can operate as a student, letting a visualization assistant act as teacher.

Continuing with reference to FIG. 2, 220 and 230 illustrate Dextroscope™ type workstations connected to a DextroNet. In a standard Dextroscope™ type workstation, a 3D dataset can be interactively visualized; however, unlike a DEX-Ray™ type console, live video is generally not captured and integrated. However, in a standard Dextroscope prerecorded video can be integrated into a 3D dataset and manipulated, such as, for example, as can arise in a “postmortem” analysis and review of a neurosurgery wherein a DEX-Ray was used.

The DextroBeam Workstation 220 and the Dextroscope Workstation 230 are different flavors of essentially the same device, differing primarily as to the display interface. The DextroBeam, instead of having a connected display as in a standard computer workstation, uses a projector to project its display on, for example, a wall or screen, as is shown in 220. Conversely, the Dextroscope generally has two displays. One is an integrated monitor which projects an image onto a mirror so that an operator can have a reach-in interactive feel as he operates on a loaded 3D dataset with his hands grasping 3D controllers under the mirror. The other is a standard display monitor which displays the same content as that projected onto the mirror.

Thus, as shown in FIG. 2, a variety of collaborative interactive paradigms are available using an exemplary DextroNet network according to exemplary embodiments of the present invention. A DEX-Ray™ workstation 210 can collaborate with a Dextroscope™ workstation 230 or with a DextroBeam workstation 220. Or, for example, it can also collaborate with another DEX-Ray™ workstation 210 (not shown). Additionally, a DextroBeam workstation 220 can collaboratively interact with another DextroBeam workstation 220 or with a Dextroscope workstation 230 across the network 250.

Additionally, although not shown in FIG. 2, other 3D interactive visualization systems can be connected to a DextroNet. For example, there is a version of RadioDexter™—the software which runs on the Dextroscope™ and DextroBeam™ systems, also provided by Volume Interactions—that can be run on a laptop (or other PC), where 3D manipulations are mapped to 2D controls, such as a standard mouse and keyboard. The functionality of such software is described in detail in the DextroLap application. Such software may thus be referred to herein as “DextroLap.” Although a DextroLap console is not shown in FIG. 2, it can also just as well be connected to a DextroNet.

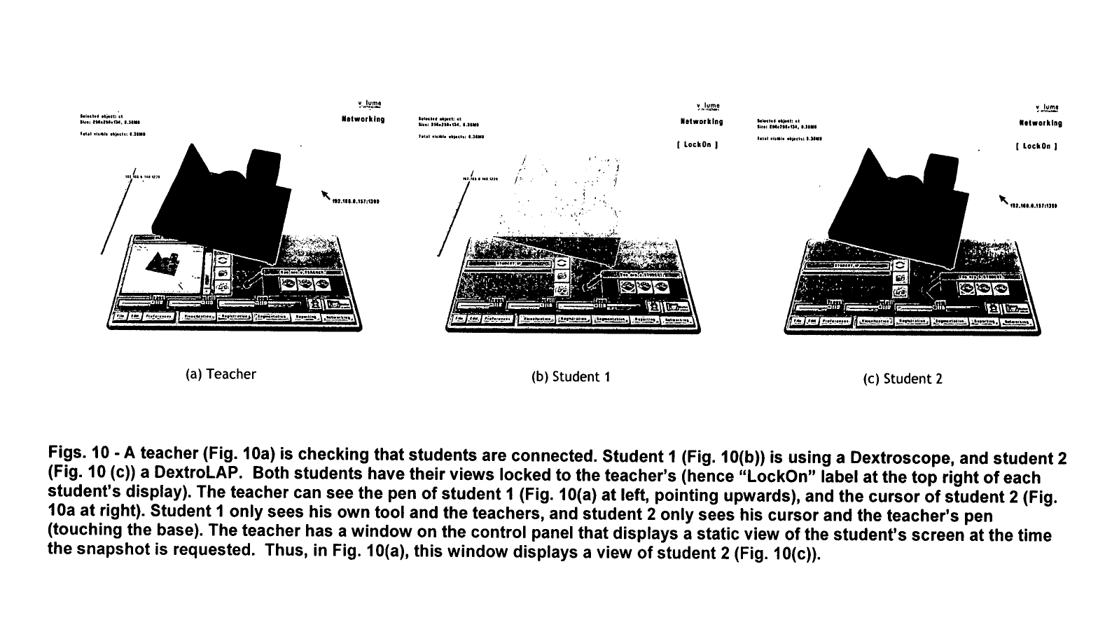

Additionally, there can be more than two collaborating workstations over a DextroNet, especially in a teacher-student context, where one teacher can manipulate a dataset and any number of students connected across network 250 can participate or observe. In such exemplary embodiment, all of the other students could, for example, be able to see each student's virtual tool as well as the teacher's. The teacher could, for example, see each student's IP address, as well as their virtual tool's location and snapshots or real time video of their display, as described below in connection with FIGS. 10-30.

In alternative exemplary embodiments of the present invention, the controlling function, i.e., the operating functionality described herein as the teacher, can be passed from participant to participant, allowing any connected system to broadcast its interactions with the data set to the other participants. In such an exemplary embodiment an icon or message could, for example, identify which system is the then operating teacher.

Given such various collaborative possibilities which a DextroNet can offer, process flow on a student workstation will next be described, it being understood that a teacher-student interaction can utilize any of the possible connections described above in connection with FIG. 2 (whether they are depicted in FIG. 2 or not).

With reference to FIG. 3, at 301, a student console seeks to connect to an available teacher. This can be done, for example, by the student console first broadcasting a request to join a DextroNet session on the Internet. If there is a teacher available, the student can, for example, receive an acknowledgement and then be able to connect. If there is no teacher active on the Internet (or other data network, such as, for example, a VPN), the student can, for example, connect to the servers as may be specified by a given system configuration and wait for a teacher.

Once a teacher is connected at 301, process flow can move to 302 where a student console seeks to update the interface and data relative to a 3D dataset that the student and teacher are collaboratively interacting with. Thus, at 302 a student can, for example, update his control panel with parameters of position, orientation and size of both the teacher's interface and dataset from the teacher's data sent over the network. He can also align the state of widgets on his control panel with those on the teacher's system via the messages received over the network. These messages can, for example, be related to the up and down state of buttons on the virtual control panel, the selection of module pages (as, for example, exist in the Dextroscope; such pages indicate the various possible modules or operational modes a user is in, such as registration, segmentation, visualization, etc.), the current value of slider bars, a selection of combo boxes, color look up table settings, etc.

Once his interface has been updated, at 302 a student can, for example, also receive data synchronization messages, such as, for example, the position, orientation, size, transparency and level of detail of the virtual objects in the 3D dataset. As noted, he can also request that the teacher send the entire compressed dataset under analysis if the difference between the student's version of the dataset and the teacher's version of the same dataset is determined by the student (or in some automated processes, by the student's system) to be too large. In such cases the student console can then decompress the data and reload the remote scenario. Alternatively, a teacher can send an interaction list instead of the entire dataset and let the student workstation successively catch up to the teacher's version of the dataset by running locally on the student's machine all of the interactions of the dataset that the teacher had implemented starting at some point in time. Once the interface and the data have been updated, thus bringing the student console in synchronization with the teacher console, process flow can move to 310 and 320, as next described.

At 310 it can be determined whether the teacher console has sent any video. If yes, the teacher video can be rendered at 314 and process flow can move to 325. If no at 310, process flow can move directly to 325. Addressing the inverse of the video issue, i.e., whether the student console has video that it should send to the teacher console, a decision at 320 can determine whether a video frame is available. Prior to describing process flow at 320, it is noted that if there is student side video, the student console can read it at 305, render it at 306, note that it is available at 320 and then send it at 326. From 326, process flow can also move to 325. If, for example, no student video is available, process flow can move directly from 320 to 325.

At 325, the student console can read its own 3D devices (e.g., stylus and controller or their equivalent—i.e., the actual physical interfaces a user interacts with). This can allow it to calculate the position, orientation and state of its virtual tools as given, for example, by the actual tracked positions of the stylus and 3D controller. If the student is using a DextroLap system, then the mouse and keyboard substitutes for the 3D devices can be read at 325. At 330 the student console can, for example, read the teacher 3D devices which allow it to update the position, orientation and state of the representative tools of the teacher as well as any keyboard events, from messages received across the DextroNet. From 330, process flow can move to 340 where it can be determined whether the student chooses to control his own viewpoint or to follow that of the teacher. If no, and the student chooses to control his own viewpoint, process flow can then move to 345 where the student can ignore the networking messages related to, for example, the teacher's left hand tool (in this example the left hand tool controls where, positionally, in a 3D data set a given user is, and what object(s) is (are) currently selected, if any; this is akin to a mouse moving a cursor in 2D) and read his own left hand tool's position, orientation and state directly from his local joystick or 6D controller, for example. If yes at 340, and thus the student chooses to follow the teacher's perspective, his machine can, at 346, send a message to the teacher's machine asking for the current position and orientation of the teacher's virtual object(s). Once he receives a reply, he can then update his own object(s).

Regardless of which choice is made at 340, process flow can move from either 345 or 346 to 350 where the 3D view of the student console rendered, process flow can then loop back to decisions 310 and 320 so that, as described above, DextroNet interactive process flow can continually repeat throughout a session.

B. Exemplary Features of Teacher-Student Interactions

Given the basic teacher-student paradigm described above, the following features can be implemented in exemplary embodiments of the present invention. The following assumes users on systems that have two-handed virtual tools, that have one button switch per tool, and that utilize a virtual control panel with buttons and sliders to control a visualization application. Such exemplary systems can be, for example, a Dextroscope™ or DextroBeam™ system of Volume Interactions Pte Ltd of Singapore, running RadioDexter™ software.

1. Reduction of Tracking Load

In exemplary embodiments of the present invention, in order to deal with the variability of network data transfer rates, reduce the traffic load imposed on the network, as well as ensure that key user interactions on 3D objects are not missed, four states of the button switch of virtual tool, check, start action, do action and end action, can, for example, be exploited. In a “check” state, users do not click a stylus that controls the virtual tool, but just move it (this generates position and orientation data, but no ‘button pressed’data). Thus, such a virtual tool appears as only roaming in the virtual world without performing any active operation, but can be seen as pointing at objects, and, in fact, can trigger some objects to change their status, although not in a permanent way. For example, a drill tool can show a see-through view of a 3D object as the virtual tool interacts with it, but will not drill the object unless the button is pressed. In a “start action” state, the button of the stylus can be pressed, and if it is kept down it can activate a “do action” state. Once a user, for example, releases the button of the stylus, a tool can enter an “end action” state and then can change back to a “check” state. Thus, most of time a virtual tool is in the “check” state, which is a relatively unimportant state compared with those states when a tool actually functions.

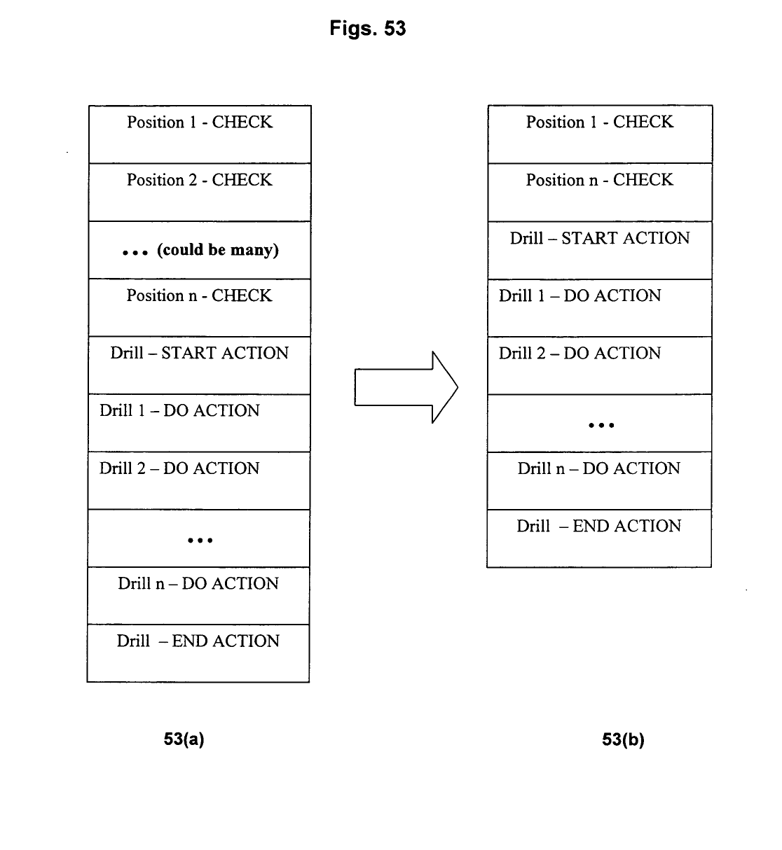

Thus, in “check” state, a virtual tool can appear as only roaming in the virtual world without performing any active operation, such as, for example, moving from one position to another. Data packets transmitting such a tool's position and orientation in this state can be thought of as being “insignificant” data packets. When there is a congested network, a teacher's “sending” buffer will likely be full of unsent packets. In such a circumstance, in exemplary embodiments of the present invention DextroNet software can check the “sending” buffer, and throw those packets with a “check” state out. Since most of the time a virtual tool is in the “check” state, the traffic load can thereby be greatly reduced. This can be illustrated with reference to FIG. 53. For example, suppose that a teacher has a set of messages as presented in FIG. 53(a) in his “sending” buffer. When a network connection is slow, he can, for example, send just the messages shown in FIG. 53(b) to a student. In this case, the student will see the teacher's tool “jump” say from position 1 to position N, and then perform, for example, a drilling operation, but none of the information of the actual drilling operation is lost.

In exemplary embodiments of the present invention, DextroNet traffic load control can capitalize on this fact. Important messages can be assigned a transfer priority. Normally, when network speed is fast, every motion of a teacher's tool can, for example, be transferred to a student. Thus, a student can watch the continuous movement of a teacher's tool. However, if a teacher's system detects that networking speed has slowed (for example, by noting that too many messages are queued in a sending out buffer), it can, in exemplary embodiments of the present invention, discard the messages of “check” state type. In this way, a student can keep up with the teacher's pace even in congested network conditions. The tradeoff with such a message “compression” (lossy) scheme is that in such a mode a teacher's tool in the student's local view can, for example, be seen as not moving so smoothly. Nonetheless, important manipulations on virtual objects will not be missed.

It is noted that this reduction need not happen when networking speed is fast. The switch can be, for example, the length of the queue in the teacher's “sending” buffer. When there is no “reduction”, the teacher's tool can move smoothly in the student's world. When “reduction” does take place, the movement of the teacher's tool is not continuous. However, teacher's operations on any virtual objects will not be missed, and a student's tool can keep up with the pace of the teacher's tool. In this way exemplary embodiments of the present invention can dynamically adapt to the available networking speed and display the teacher's tool in multi-resolution (i.e., coarse and smooth).

2. Viewpoint Control

As noted, in exemplary embodiments of the present invention, a DextroNet student can either control a given 3D object, or follow a teacher's viewpoint. If the student chooses local control of the 3D object, his local manipulations, such as, for example, rotation, translation and zoom (digital magnification) of an object do not affect the position of the 3D objects in the world of the teacher or of other students. However, the teacher can see the student's virtual tool's position and orientation relative to the 3D objects, thus allowing the teacher to infer the viewpoint of the student, as noted above. In such an exemplary scenario, a student can rotate the object in his world to find another area or orientation of interest than that currently selected by the teacher, and can, for example, communicate this to the teacher vocally and/or by pointing to it. The teacher can then, for example, turn to the specified place when he receives the student's message and notice the position pointed to by the student in the teacher's world. On the other hand, if the student chooses to follow the teacher's view, all motions in the teacher's world will be shared with the student's local world.

In exemplary embodiments of the present invention, there can be specific commands which can be sent over the network to switch between these two states, and to reposition the remote virtual tools relative to the viewpoint of the user. Such commands can, for example, drive the decision at 140 and 340 in FIGS. 1 and 3, respectively.

3. Data Synchronization

In exemplary embodiments of the present invention, there can be two synchronization modes, simple and complete. An exemplary simple synchronization mode can, for example, communicate only the position, orientation, size, transparency, and detail level of an object. These parameters can be considered as “light-weight” in the sense that they can be transferred over a data network without requiring much bandwidth. Thus, in exemplary embodiments of the present invention a teacher module can, for example, implement such a simple synchronization once it detects a new student joining the network.

In exemplary embodiments of the present invention, a complete synchronization can, for example, be performed only when a user explicitly requests it (such as at 145 in FIG. 1, for example). This involves compressing and transferring all of the teacher's data (except data captured for reporting purposes, such as snapshots and 3D recordings). In exemplary embodiments of the present invention this synchronization can be optional, inasmuch as it can take time. In such embodiments a teacher can only start a complete synchronization when the student requires it. If there are multiple students, for example, the data can only be sent to a student who makes such a request. Additional, a complete synchronization can be used as a recovery strategy when a substantial deviation develops between the two sides. Where there is no throughput limit due to bandwidth availability, such complete synchronizations can be made automatically, periodically or at the occurrence of certain defined events.

C. Synchronization of 3D Interface (Control Panel)

In exemplary embodiments of the present invention, an exemplary synchronization can comprise two processes, synchronization of calibration and synchronization of widgets, as next described.

1. Synchronization of Calibration

When using a Dextroscope™ or a DextroBeam™ type system, for example, a virtual control panel has to be precisely calibrated with a physical base (e.g., made of acrylic) where the 3D tracker rests during interactions, so that a virtual tool can touch the corresponding part of the virtual control panel. Thus, calibration and configuration are local, varying from machine to machine. This can cause mismatch problems while networking. For example, a teacher's tool may not be able to touch a given student's control panel due to a calibration and/or configuration mismatch. To avoid this problem, in exemplary embodiments of the present invention, teacher and student control panels can be synchronized as follows. When a networking session is activated, the position, orientation and size of a teacher's control panel can be sent to the student, which can replace the parameters of the student's own control panel. When the networking session terminates, the original configuration of the student's machine can be restored, thus allowing him to work alone.

2. Synchronization of Widgets

When a networking session starts, the initial states of the control panel on both sides can, for example, be different, such as for example, the positions of slider bars, the state of buttons and tabs, the list of color lookup tables, etc. All of these parameters need to be aligned for networking.

D. Connections Between Different Interactive Platforms

In exemplary embodiments of the present invention, connections between different types of interactive platforms can be supported, such as, for example, between a Dextroscope™ and a DextroBeam. Thus, teacher on a Dextroscope can instruct multiple remote students gathering in front of a DextroBeam, or, for example, a teacher can instruct the local students in front of a DextroBeam and a remote student on a Dextroscope™ can watch.

In exemplary embodiments of the present invention, another supported connection can be that between 3D interactive platforms and 2D desktop workstations, such as, for example, a Dextroscope™ and a DextroLap system, as noted above. Such a system can allow participants to use only a desktop workstation without the 3D input devices of stylus and joystick, where the interaction between the users and the system is performed via mouse and keyboard (as described in the DextroLap application). In such a scenario the input devices of the teacher and the student will likely not be the same. This can be most useful as students lacking a 3D stylus and joystick can still watch the teacher, who is operating in full 3D, and communicate with the teacher by using their mouse and keyboard. On a desktop workstation, keyboard events can be transferred and interpolated as well as actions from the tracking system. In such exemplary embodiments the key name and its modifier need to be packed into the network message. For example, a DextroLAP cursor has a 3D position. This position can be sent to the teacher, and the teacher can then see a the student's cursor moving in 3D.

In exemplary embodiments of the present invention various interactive visualization systems running on Unix and Windows systems can all be connected across a DextroNet.

E. Automatic Teacher Detection

In exemplary embodiments of the present invention, when a teacher and student are all located on a given intranet, a DextroNet can automatically detect the teacher. As described more fully below, if client gets a reply from server, it can then start a network connection with the server, and tell the server whether it is a teacher or a student. The server can, for example, keep a registration list for all clients (role, IP address, port). If the server sees that the newly joining client is a student, he can check if there is a teacher available and send the teacher's IP address and port to the student. Hence, the student can automatically obtain the teacher's information from the server. If there is no existing teacher, the server can, for example, warn the student to quit the networking connection. Or, alternatively, a student can wait until a teacher comes on-line. Thus, in such exemplary embodiments, a student does not need to worry about low level networking tasks such as, for example, configuring the server IP address and port. Once there is a teacher, the student's system can automatically detect it.

III. Surgeon-Visualization Assistant Interactions

A. General

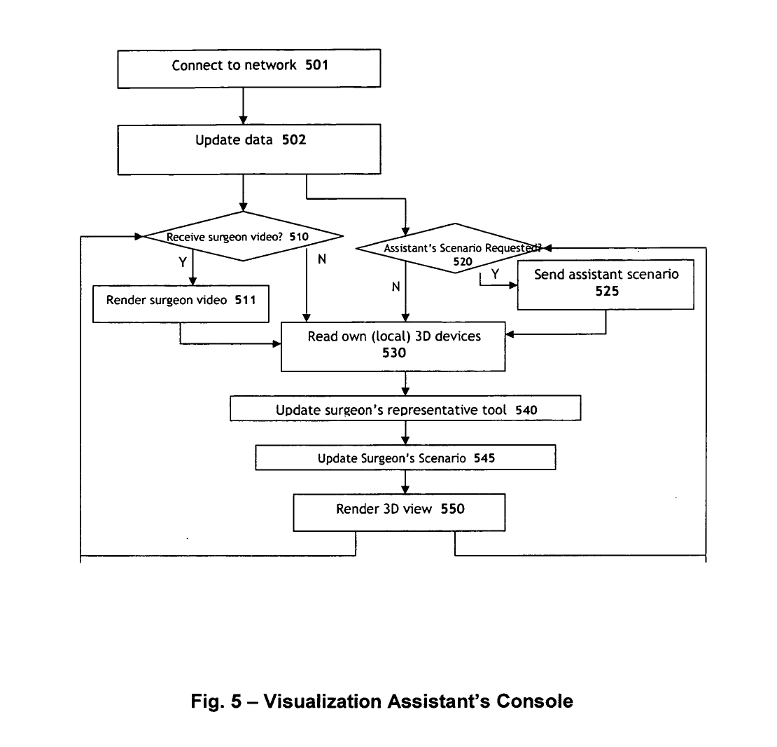

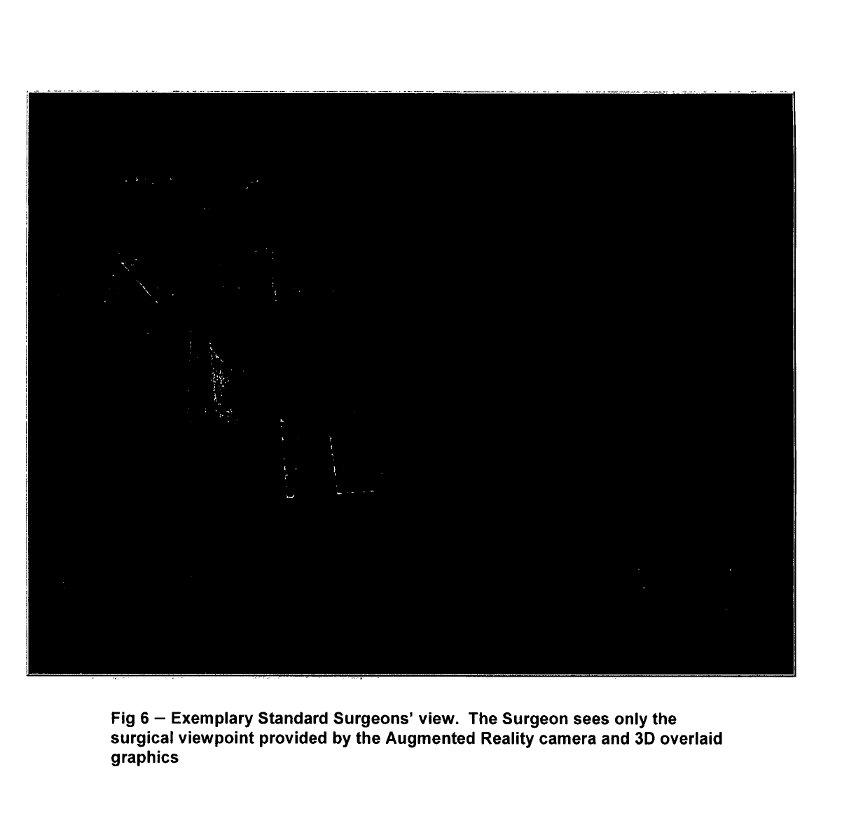

Next described, with reference to FIGS. 4 through 8, is an exemplary collaborative interactive visualization of an exemplary 3D dataset between a Surgeon and a Visualization Assistant according to an exemplary embodiment of the present invention. FIG. 4 is a process flow diagram for an exemplary Surgeon's console. FIG. 5 is an exemplary process flow diagram for a Visualization Assistant's console. FIGS. 6 through 8 depict exemplary views of each of the Surgeon and Visualization Assistant in such a scenario.

In general such paradigms are not restricted to a “surgeon” per se, but can include any scenario where one participant (“Surgeon”) is performing a diagnostic or therapeutic procedure on a given subject, and where pre-procedure imaging data is available for that subject and is co-registered to the physical subject, and where another participant can visualize the subject from a 3D data set created from such pre-procedure imaging data. Thus a “Surgeon” as described includes, for example, a sonographer (as described, for example, in “SonoDex”), an interventional cardiologist using a Cathlab™ machine, a surgeon using a Medtronic surgical navigation system, etc.

In the depicted exemplary interaction the Surgeon is contemplated to be using a DEX-Ray™ type workstation, and thus capturing positional data and real-time video, and the Visualization Assistant can use any type of workstation.

With reference to FIG. 4, at 401, a Surgeon can connect to a network. At 402, the data on the on the Visualization Assistant's side can be synchronized with the data on the Surgeon's side. Once data synchronization has been accomplished, process flow can, for example, move from 402 along two parallel paths. First, at 410 the Surgeon can request the Visualization Assistant's scenario, and if requested, at 411 it can be rendered. If the Visualization Assistant's scenario is not requested then process flow can move from 410 directly to 420 where the Surgeon's console can read the position and orientation of the video probe. Here the Surgeon's console acquires the position and orientation of the video probe (which is local) and converts it to coordinates in the virtual world. From 420 process flow can then, for example, move to 425.

It is noted that in parallel to the processing described above there can also be local video processing. It is recalled that the Surgeon's console, being a DEX-Ray™ type workstation, can also acquire real time video. Thus, at 405 the Surgeon's console can read, and at 406 render, its own video. Process flow can then move to 425 as well.

At 425, a Surgeon's console can send the local video that it has acquired across a network to the Visualization Assistant. From there, process flow can move to 430 where the Surgeon's console sends its video probe information. Here the Surgeon's console sends the position and orientation of the video probe in the virtual world coordinates to the Visualization Assistant. This is merely a transmission of the information acquired at 420. At 435, the Surgeon's console can update the Assistant's representative tool. Here the Surgeon's console can receive and update the position and orientation of the Visualization Assistant's representative tool in the Surgeon's virtual world. This data can be acquired across the network from the Visualization Assistant's console. Finally, at 450, the Surgeon's console can render a 3D view of the 3D dataset which can include the video and the augmented reality, including the position and orientation of the Visualization Assistant's representative tool. It is noted that the current 3D rendering will be a result of interactions with the 3D dataset by both the Surgeon as well as by the Visualization Assistant. The other side of the Surgeon-Visualization Assistant paradigm, focusing on the Visualization Assistant's side, will next be described in connection with FIG. 5.

At 501 a Visualization Assistant can connect to a network, and at 502 he or she can update his or her data. Here the Visualization Assistant needs to update his or her own virtual object positions, orientations and sizes using the Surgeon's data coming across the network.

Process flow can move from 502 in parallel to the decisions at 510 and 520. First, at 510 the determination can be made whether any video from the Surgeon's console has been received. If yes, at 511 the Surgeon's video can be rendered. If no, process flow can move to 530. Second, at decision 520 a determination can be made as to whether the Assistant's scenario should be sent. This can be, for example, in response to a query or request from the Surgeon's workstation.

If the Surgeon has requested the Visualization Assistant's scenario, then at 525 the Assistant's scenario can be sent and the assistant can send either snapshots or video of his view. Such snapshots can be, for example, either stereoscopic or monoscopic. If at 520 the Surgeon has not requested the Visualization Assistant's scenario, then process flow can also move to 530, where process flow had arrived from 510 as well, and the Visualization Assistant's console can read its own 3D devices. Here the Visualization Assistant has full control of his own tool and thus the position, orientation and size of his tools are controlled by his own stylist and joystick. From here process flow can move to 540 where the Surgeon's representative tool can be updated. Here, the Visualization Assistant's console can receive and update the position and orientation of the representative tool of the Surgeon in the Visualization Assistant's virtual world.

Finally, process flow moves to 550 where the Visualization Assistant's console renders the 3D view of the 3D dataset. This 3D view will include the updates to the Visualization Assistant's own 3D devices as well as those of the Surgeon's representative tool and can also include any video received from the Surgeon.

As noted above, a Surgeon-Visualization Assistant paradigm is assumed to involve a DEX-Ray™ to Dextroscope™ type interaction over a DextroNet. This scenario, as noted above, is a variant of the teacher-student paradigm described above. In the Surgeon-Visualization Assistant scenario, the Surgeon generally plays the role of student while the assistant plays the role of teacher. This is because a Surgeon (student) is more limited in his ability to interact with data since he is busy operating; thus he can be primarily involved in watching how the Visualization Assistant (teacher) controls the 3D visual virtual world.

B. Independent Viewpoints

When using a DEX-Ray™ type console in an operating theater, for example, a Surgeon's perspective is limited by the direction of the video probe, as shown in FIG. 6. As described more fully in the Camera Probe Application, a DEX-Ray™ type device renders a 3D scene based upon the position of the video probe and therefore from the viewpoint that the camera in the video probe has. Thus, for example, a Surgeon using a DEX-Ray type console cannot see how the video probe's tip approaches a target from the inside, i.e., from a viewpoint fixed inside the target itself, such as, for example, a viewpoint fixed to a tumor or other intra-cranial structure. However, in a planning system such as that implemented on a Dextroscope™ type machine, an assistant has an unrestricted perspective to examine the target as shown in FIG. 8. Thus, in exemplary embodiments of the present invention, a DextroNet can be used to connect a DEX-Ray™ with a Dextroscope™ in order to assist a Surgeon or provide him with a second pair of eyes that has unrestricted freedom to move through the 3D dataset associated with the actual patient that the Surgeon is operating on. This can be of tremendous use to a Surgeon during a real time complicated operation where multiple visualizations would certainly help the process but are logistically impossible for the Surgeon to do while he is operating. It is in such scenarios that a Visualization Assistant can contribute significantly to the surgical or other hands-on therapeutic (diagnostic) effort.

C. Exchangeable Viewpoints

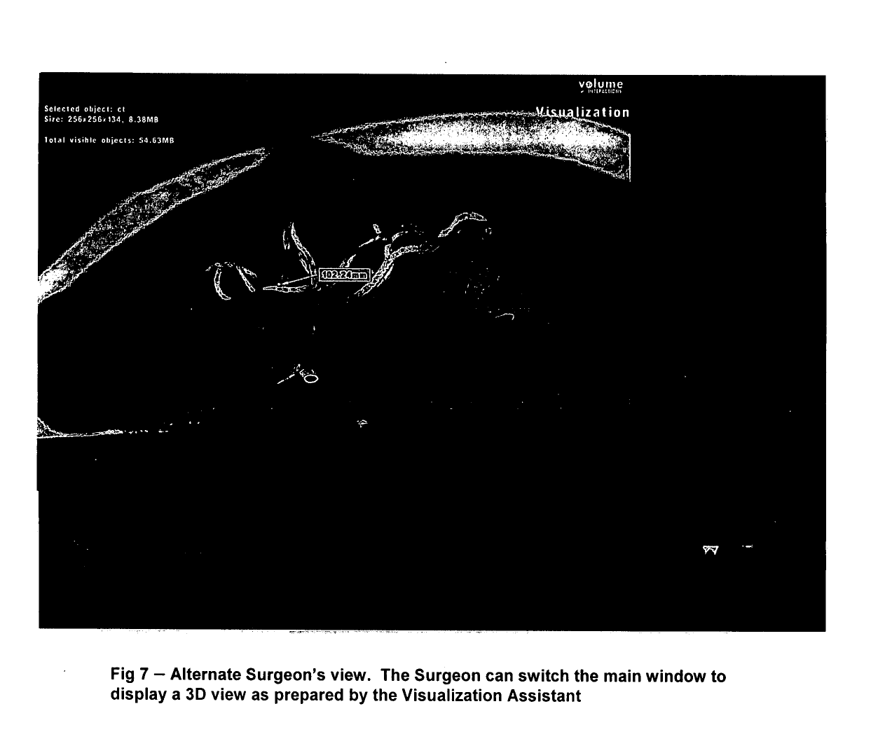

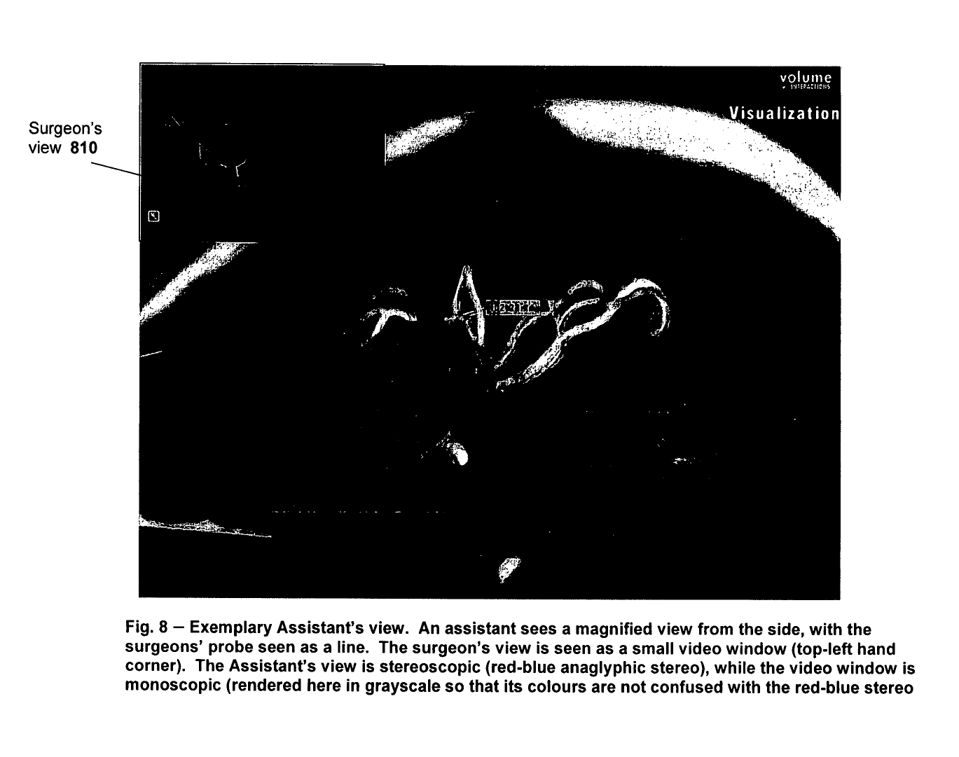

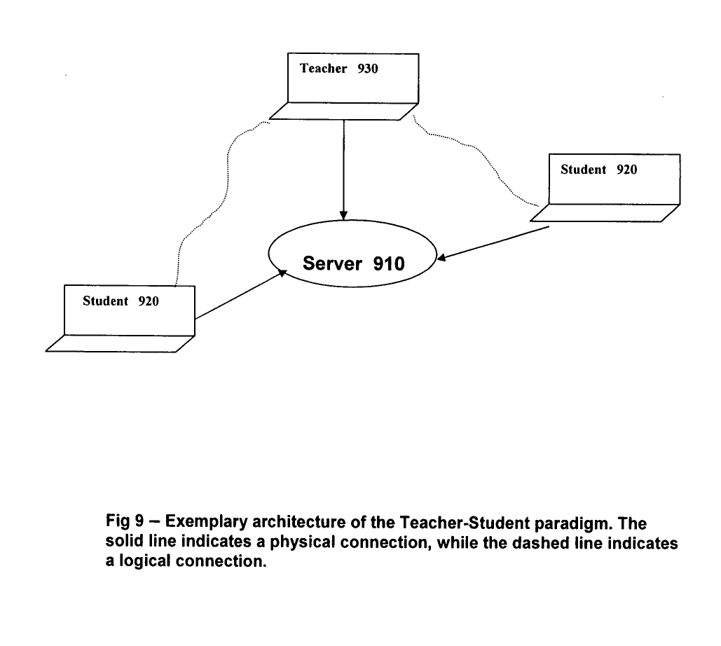

Alternatively, in exemplary embodiments of the present invention, a Surgeon can see the Assistant's viewpoint, an example of which is depicted in FIG. 9. Thus, in exemplary embodiments of the present invention, a Surgeon has two types of views which are available. One is the normal Camera Probe augmented reality view, i.e., a video overlaid image with three 2D tri-planar images, such as is shown in FIG. 6, and the other is a viewpoint from the Visualization Assistant's side such as is shown in FIG. 7. These two types of views can be displayed in two separate windows or displays or, alternatively, can be viewed within a single window which the Surgeon can toggle between. Thus a Surgeon can, for example, toggle between FIGS. 6 and 7. From the Visualization Assistant's view (FIG. 7) a Surgeon can watch the relationship of the virtual object and his tool from a different perspective, such as, for example, a viewpoint located on a target object, such as, for example, a tumor. Moreover, in exemplary embodiments of the present invention, a Visualization Assistant can see the Surgeon's scenario within his display as well. This is illustrated, for example, in FIG. 8. In the main window is the Visualization Assistant's view which is unrestricted by the position of the camera of the video probe tool held by the Surgeon. Additionally, there is a “picture in a picture” view, in FIG. 8 this is shown as a small window 810 in the top left corner of FIG. 8 which shows the Surgeon's view as he sees it. This can be transferred as video frames, and thus, cannot be manipulated in any way by the Visualization Assistant. Thus, FIG. 8 shows a main window displaying a virtual 3D world where the Surgeon's tools are also visible (as the line appearing from top to bottom). The other, smaller, window 810 shows the actual view of the Surgeon which includes the live video signal plus the augmented reality of the 3D objects which are available on the Surgeon's scenario and whose display parameters are chosen and manipulated solely by the Surgeon. Thus, a Visualization Assistant can see the Surgeon's tool in both the 3D world of the main window of FIG. 6 and in the 2D video of the picture within a picture window 810 in the upper left portion of FIG. 8.

IV. Exemplary Interface Interactions

In exemplary embodiments of the present invention, the networking functions of a DextroNet can, for example, be controlled from a “Networking” tab in a main Dextroscope™ 3D interface.

A. Establish a Connection

In exemplary embodiments of the present invention, a user can be provided with a networking module interface. Such an interface can, for example, provide three buttons: “teacher”, “student” and “end networking.” Via such an exemplary interface, users can thus choose to be either a teacher or a student, or to end a DextroNet session. In exemplary embodiments of the present invention, only when a teacher is in the network can a student establish a connection. Otherwise, a student can be informed by a “no teacher exists” message to terminate the connection. If a student has no 3D input device, he can use a mouse for communication, as described, for example, in the DextroLAP application.

B. Teacher Actions

Additionally, there can be additional interface features displayed to a user acting as main user or “teacher.” In such exemplary embodiments a teacher can be provided with a student IP list and a “Synchronization” button. This panel can be made available only to a teacher. When a new student joins, the snapshot of, for example, the student's initial scenario can, for example, be sent to the teacher, and displayed in the student list. Additionally, a student's IP address can, for example, be indicated in a text box. If there are more than one students, a teacher can scroll the list to see other students' IP addresses and snapshots. In exemplary embodiments of the present invention, such snapshots can be used to allow a teacher to gauge the relative synchronization of his and the student's datasets. For example, there are two ways of accomplishing synchronization when initializing networking: simple and complete. Generally speaking, if the teacher and the student load the same dataset, only simple synchronization is needed. However, if the dataset, they have loaded are different, the teacher has to start a complete synchronization, otherwise there will be a disaster later on. The snapshots sent from the various students display their respective initial states (environment and data) on the teacher's side. Hence, a teacher can check whether the students have loaded the same data as the teacher has via the snapshots. If not, he can warn the students and implement a complete synchronization.

C. Student Actions

In exemplary embodiments of the present invention, once a user chooses to be a student, he loses control of his virtual control panel. He can watch the manipulations of the teacher and point to the part where he is interested. However, he is restricted in what he can do since he cannot touch his virtual control panel, which is controlled by the teacher. As noted, the limited set of interactions he can do can be facilitated via specialized buttons (similar to those used for PC implementations as described in DextroLap) or via a specialized “student” virtual control panel, different form the “standard” control panel being manipulated by the teacher across the exemplary DextroNet.

In exemplary embodiments of the present invention, a student has two ways in which he can view a teacher's operations. For example, he can either (i) follow the teacher's viewpoint or (ii) view the dataset from a different perspective than that of the teacher. In such exemplary embodiments he can toggle between these two modes by simply clicking his stylus or some other system defined signal.

In exemplary embodiments of the present invention, when a student is in an “engaged”—or following the teacher's perspective—mode, a red text display of the words “LockOn” can, for example, be provided. In such a mode he cannot rotate or move objects. If he clicks the stylus or sends some other signal to disengage, the “LockOn“text can, for example, disappear, which indicates that he can view the dataset from his own viewpoint. In such a “disengaged” mode a student can, for example, rotate and move a displayed object using, for example, a left-hand tool.

D. Stopping a Network Connection

In the depicted exemplary implementation, since only the teacher's tool can touch the virtual control panel, it is the teacher's responsibility to end a networking function by clicking the “End networking” button. Once networking has ended, a teacher can, for example, keep all the changes he or she has made to the data during the networking session. However, a student can, for example, if desired, restore his scenario to what it was before networking, thus restoring the conditions that were saved prior to his entering a networking session.

In exemplary embodiments of the present invention, during networking, a student's data can be required to be synchronized with the teacher's data. Thus, to avoid spoiling the student's local data, when a student presses the networking button, for example, his own data can be automatically copied to some backup directory before the networking session really starts. Therefore, when he ends the networking session, he can restore his own data by copying it back from the backup directory. In exemplary embodiments of the present invention, this can be automatically done once an “End Networking” button is pressed.

E. Exemplary Server

In exemplary embodiments of the present invention, a DextroNet can be established on a server-client architecture, as shown in FIG. 9. In such an exemplary configuration both teacher 930 and students 920 are clients. They can be, for example, physically connected to a server 910 that can be used to manage the multiply connection, connection registration, and connection query. All the information from the sender (client) can be, for example, first passed to the server 910. The server can, for example, analyze the receiver's IP address, and then pass the message to the specified destination. Thus, in such exemplary embodiments, before activating the networking function on either the teacher or the student side, such a server application must run first. Exemplary server features are next described.

1. Multiple Connection

From a low-level point of view, in exemplary embodiments of the present invention a server can use multiplexing techniques to support multiple connections. It can be, for example, a single process concurrent server, where the arrival of data triggers execution. Time-sharing can, for example, take over if the load is so high that the CPU cannot handle it. Additionally, from a high-level point of view, based on the IP address from the sender (client), the server can unicast, multicast or broadcast the messages to a destination using TCP/IP protocol.

2. Connection Registration

When a client connects to a server, it can, for example, register its IP address and networking role (e.g., teacher or student) on the server. It can be the server's responsibility, for example, to ensure two criteria: (1) there is a teacher before a student joins, and (2) there is only one teacher connected to the server. If criterion (1) is not met, a student can, for example, be warned to quit networking, or, for example, can be advised that he can wait until a teacher connects. If criterion (2) is not met, a second putative teacher can be, for example, warned to quit the networking function, or, for example, he can be queried whether he desires to connect as a student.

3. Connection Query

In exemplary embodiments of the present invention a client can query the server regarding how many peer clients there currently are in the connected environment and who they are. In this way, a client can be aware who is involved in the communication. This can be important to a teacher, who keeps a dynamic list of current students. When the server receives such a “query peers” request, it can, for example, send back all the peer clients' IP addresses and ports to the requester.

4. Answering Server Queries

In exemplary embodiments of the present invention, a server can be auto-detected over a LAN. For example, when a server's UDP socket receives a client's broadcast query about an expected server application from a LAN, it can check the running applications' names to see whether the wanted one is available. If it is, the server can send back its own address (IP:port) to the querying client.

Thus, in exemplary embodiments of the present invention, when a user chooses his networking role (by, for example, pressing a “teacher” or a “student” button on a networking interface in his visualization environment when he joins a networking connection), he can broadcast a query containing the server program name over an intranet. This message can, for example, be sent to a specified port on all intranet machines. If a server program is running, it can keep listening to the specified port. Once it receives a broadcast message from the client, it can check all the running programs' names on the server machine to see if there is a match. If yes, then the server can, for example, send back its own address (IP:port) to the querying client. In the meantime, the client can be waiting for the answer from the server. If no answer comes back after a time period, the client can report an error of “no server running”, and can, for example, resume a normal standalone work state.

5. Server Launch

In exemplary embodiments of the present invention a DextroNet server can run as a standalone application without being installed on a visualization machine. If communication takes place within a LAN, a teacher and student do not have to know the IP address of the server explicitly, for example. DextroNet software can, for example, automatically locate a server. If the communication is over a WAN, the server's IP and port have to be provided to a DextroNet. If, for example, no local server is detected, and there is no remote server, a teacher can, for example, automatically launch a server application on his machine when he tries to start a networking function.

Alternatively, for example, server functions can be combined with the teacher's role. In other words, the teacher's machine can become a server, and the student's machine can remain a client. However, in such exemplary embodiments the teacher's machine's burden can be relatively heavy because of visualization demands form the 3D visualization software as well as communication demands from the DextroNet occurring at the same time. Thus, for example, a DextroNet communication loop can be slowed down by, for example, a Dextroscope™ visualization loop. This can cause more incoming or outgoing data to be left in the waiting buffer. Thus, in exemplary embodiments of the present invention “insignificant” data packets can, for example, be dropped if the data queue is long. That is, such data packets can, for example, be removed from the queue without processing them. “Insignificant” data packets, in this context, refers to those data packets that do not affect the outcome of the program/visualization, such as, for example, those packets that transmit the movement of tools (both teacher's and students' ) that are not performing any major operation (e.g., drilling, cropping, etc.), and thus not affecting the data set.

In this context it is noted, as described in greater detail below, that there are four basic states of a tool: “check”, “start action”, “do action”, and “end action.” In a “check” state, a virtual tool appears as only roaming in the virtual world without performing any active operation, for example, moving from one position to another. Its position and orientation in this state are thought of “insignificant” data packets. When there is a congested networking condition, the teacher's “sending” buffer will be full of unsent packets. Under this circumstance, the software will check the “sending” buffer, throwing those packets with a “check” state. Since most of time a virtual tool is in the “check” state, the traffic load is then greatly reduced. For example, a teacher has the following messages as (a) in his “sending” buffer. When network is slow, he only sends messages as in (b) to the student. In this case, the student will see the teacher's tool “jump” from position 1 to position n, and then perform a drilling.

V. Exemplary Implementations

FIGS. 1049 depict various exemplary implementations of a DextroNet. Such implementations are designed to integrate, for example, into a Dextroscope™ running RadioDexter™ software, or the like, and can thus appear as an additional functional module in such systems. In the depicted example, a teacher and student can communicate with each other through a server that runs a server program. As noted, during each session, there can be multiple students, but only one teacher at a time.

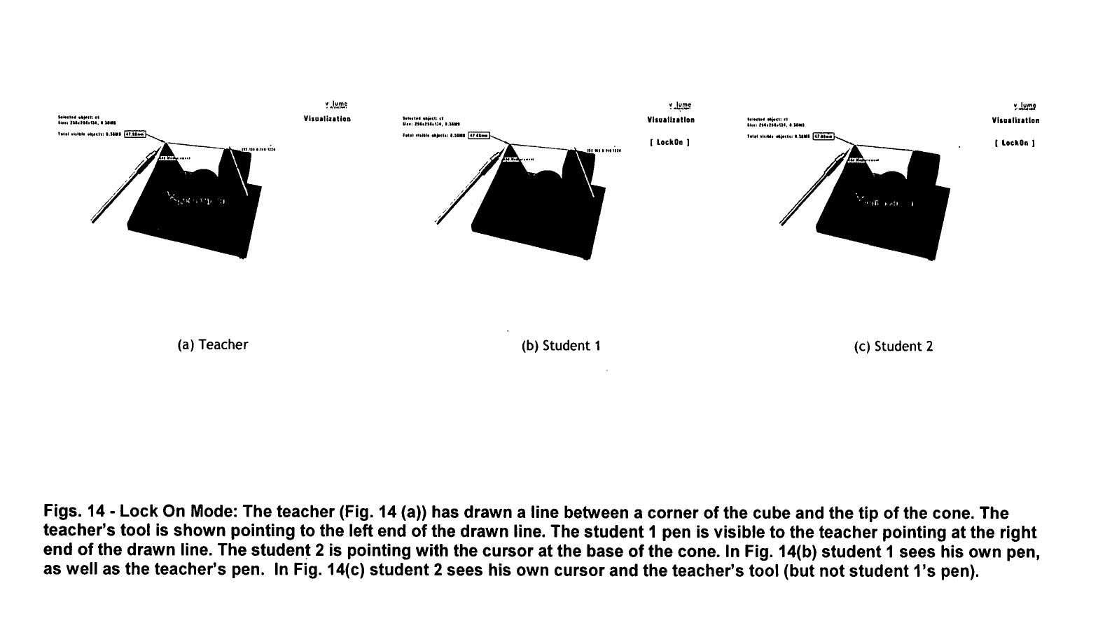

FIGS. 10-25 depict the relationships between the views of an exemplary teacher and two students over time. Each of FIGS. 10, 14,18 and 22 provides three views side by side, each of which are then presented in larger images in the immediately following three figures. These figures will next be described.

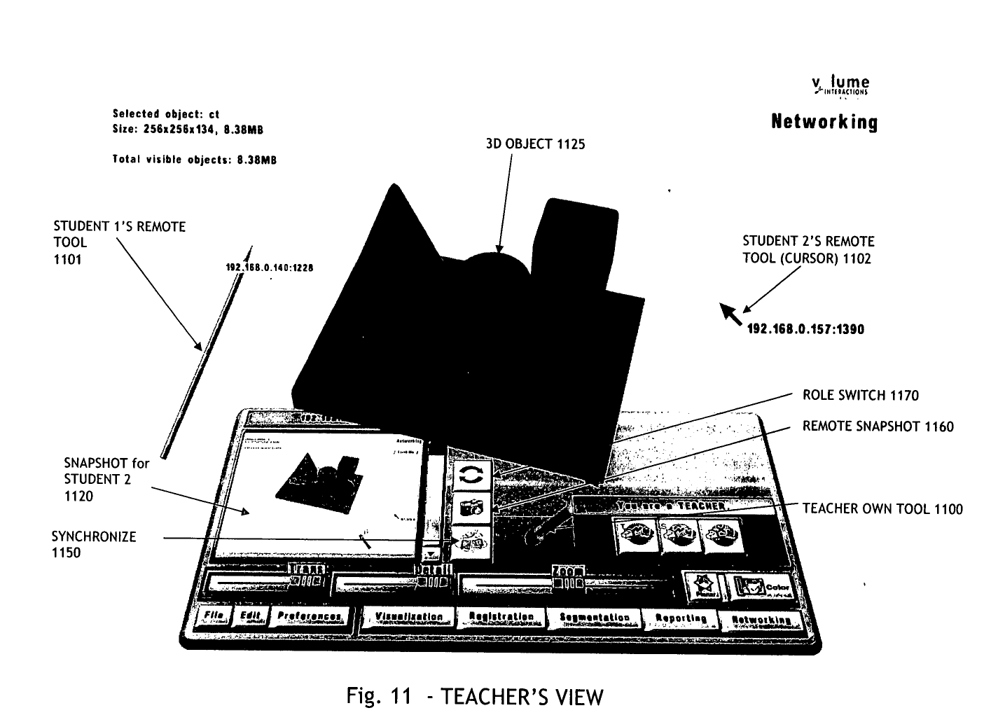

FIGS. 10-25 depict exemplary interactions between, and the respective views seen by each of, an exemplary teacher and two students, according to an exemplary embodiment of the present invention. With reference to FIGS. 10, a teacher can check if students are connected. The teacher's view is shown as FIG. 10(a), and each of FIGS. 10(b) and 10(c) depict respective views of two exemplary students, Student 1 and Student 2. In the depicted example, the Teacher and Student 1 are using a Dextroscope type system and Student 2 is using a DextroLap type system. FIGS. 11-13 show each of these views in better detail, as next described.

With reference to FIG. 11, the Teacher can see his own tool 1100, Student 1's remote tool 1101, and Student 2's remote tool 1102. It is noted that Student 2's remote tool is actually a cursor, inasmuch as he is using a DextroLap type system, and thus does not have full 3D control. Also shown in FIG. 11, is each student's remote tool is accompanied by an IP address which is that of that student's computer. In exemplary embodiments of the present invention, such an IP address could be changed to display the name of the student. Alternatively, both, for example, could be displayed. It may be particularly useful in exemplary embodiments of the present invention that are used for teaching a number of students simultaneously, to have the names of each of the students displayed to a teacher. In this manner the teacher can always know who he is addressing.

Also visible in FIG. 11, the Teacher's view, is a display window 1120 for snapshots of the various students' displays. It is by this snapshot window 1120 that a Teacher can have the capability to see a student's local view. Finally, there are three networking tools, “synchronize” 1150, “remote snapshot” 1160 and “role switch” 1170. Synchronize 1150 can be used to synchronize the data set between student and teacher. This tool can be used if it becomes apparent to the teacher (or to the student) that that states of their respective data sets have drifted so significantly apart so as to create confusion. Remote snapshot 1160 simply acquires the snapshot of a particular student displayed in the snapshot window 1120. This can be facilitated, for example, by the teacher control panel having a scrollable list of connected students. A teacher can then, for example, scroll through the list of students and select one. Then, when the teacher presses, for example, a “capture” button, a snapshot can be requested from the student's workstation. Finally, role switch 1170 allows the roles of teacher and student to be switched. This process can be restricted to be initiated by a teacher; therefore, this button can, for example, only be active on a teacher's machine, as described more fully below.

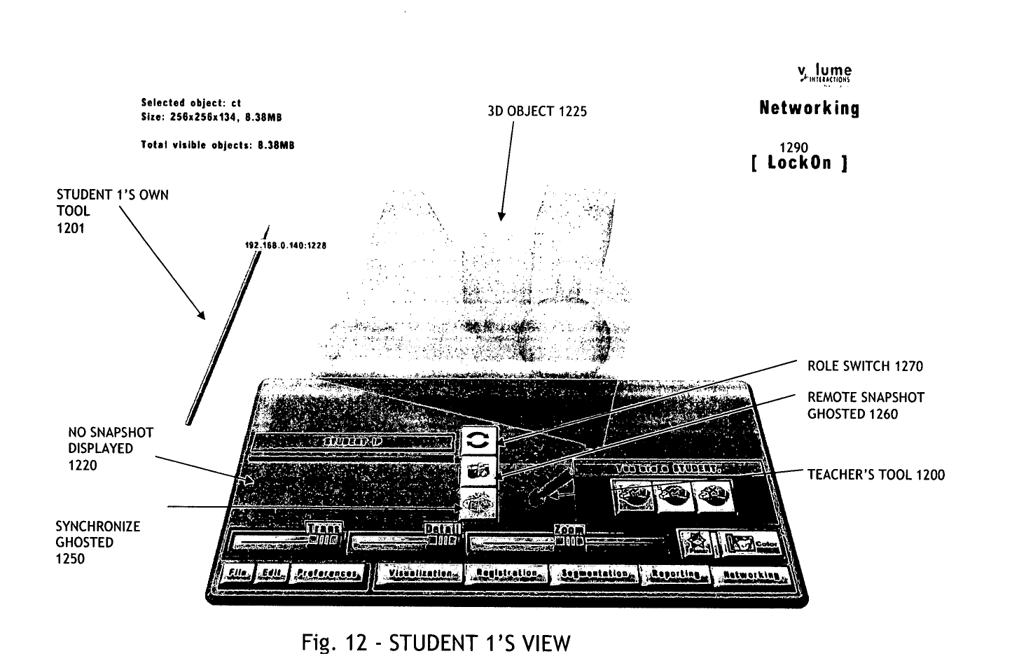

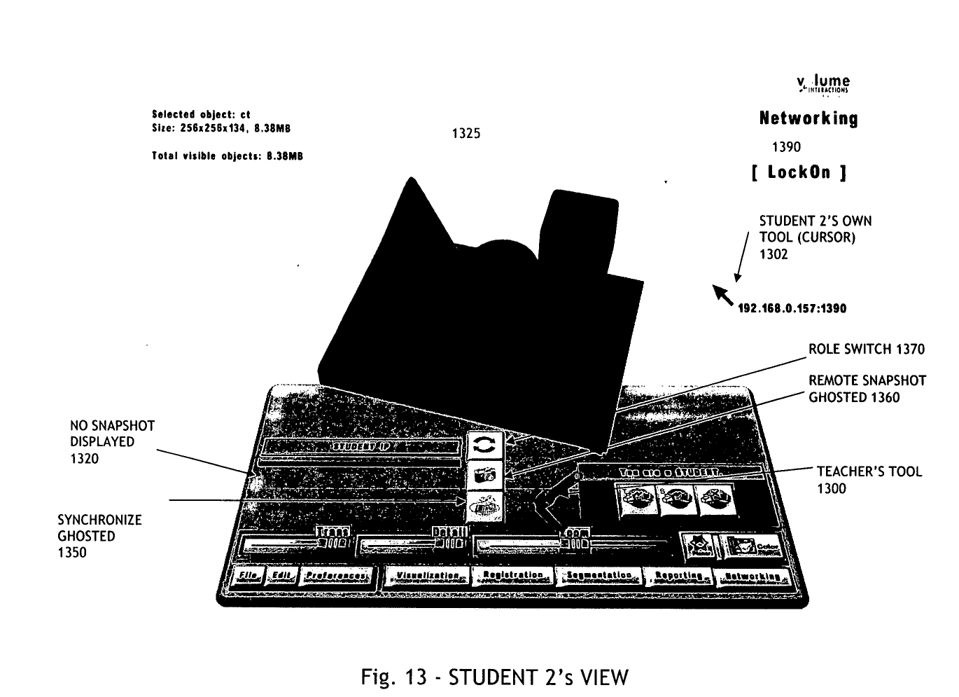

FIG. 12 depicts Student 1's view. It depicts Student 1's tool 1201 as well as the Teacher's tool 1200. It is noted that Student 1's own IP address appears with his tool. This feature can be turned off, or, for example, as with the teacher's view, can be replaced with the student's name or some other identifier. 3D object 1225 seen by the student is the same object which the Teacher's view shows, and is in the same exact perspective or viewpoint. This is because Student 1's view is “locked on” to that of the Teacher. Thus, lock-on sign 1290 is displayed in the upper right area of Student 1's screen. Teacher's tool 1200 is also visible, as are the three networking tools of Synchronize 1250, Remote Snapshot 1260 and Role switch 1270. Because Student 1 is a student, and does not control the networking functionality, there is no snapshot displayed in snapshot window 1220. In fact, if a student wants to see the teacher's view all he need do is lock on to the teacher's view, as is already shown in FIG. 12. Therefore, Remote Snapshot 1260 is ghosted. Synchronize 1250 is also ghosted as is role switch 1270, as only a teacher can implement these functions. FIG. 13 is similar to FIG. 12 and simply illustrates Student 2's view. With reference thereto, the same 3D object 1325 is shown. It is noted that Student 1's view of the 3D object appears more transparent that that of the Teacher and Student 2. This is because although all workstations may be running the same program, such workstations may have different configurations. Some, for example, may have certain features disabled, such as, for example, “ghosting the 3D object when the control panel is touched by a stylus.” Such a feature can, for example, accelerate the interactions of a stylus with a control panel.

This is because depending on the graphics card available to the user (some may be using a DextroLAP system running on a laptop, some may have a fast Dextroscope™) some of the more ‘cosmetic’ functions of 3D interactive visualization software may not produce exactly the same visual results, but will behave identically from the point of view of effects on the 3D objects (which, of course, needs to be exactly the same in order to maintain synchronized views). One such cosmetic function, for example, is visible in FIG. 13. In order to accelerate the display when a user is interacting with the control panel (and hence, in need of responsiveness to click with precision on buttons and sliders) the 3D object's rendered image can be captured and pasted transparently over the 3D view, only refreshing the control panel and stylus. If this is not replicated at a student's workstation, the results on the application will be the same, but the interaction slower, and the visuals of the object would be different (i.e., not transparent).

With reference again to FIG. 13, Student 2 is also in lock-on mode, and thus lock-on sign 1390 is also displayed in FIG. 13. Student 2 can see his own tool, in this case cursor 1302. Also displayed is Student 2's local IP address, which can, for example, in alternative exemplary embodiments, be replaced or augmented with a designator, as described above. Similar to the case of Student 1, there is no snapshot displayed in snapshot window 1320 and networking tools Synchronize 1350 and Remote Snapshot 1360 are both ghosted, as is role switch 1370.

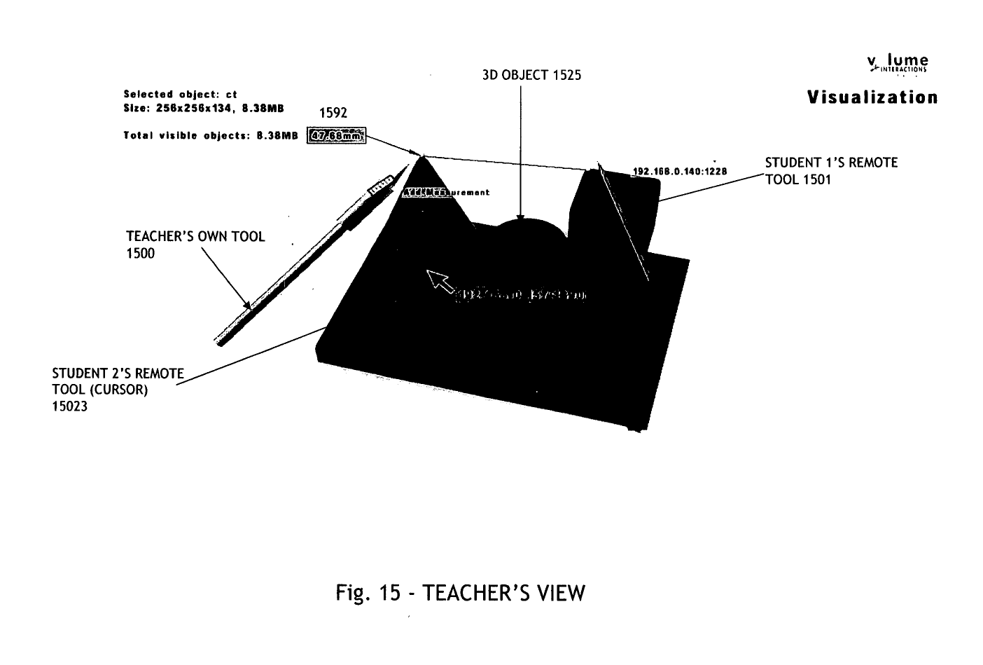

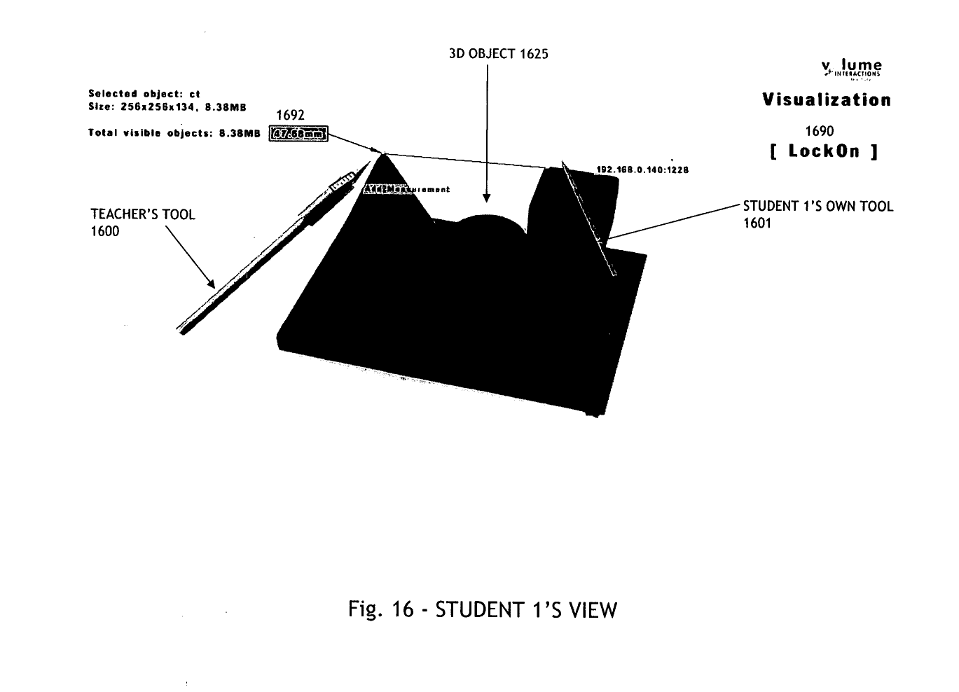

Next described are FIGS. 14-17 which illustrate the Teacher and two Students of FIGS. 10 at an exemplary point in time subsequent to that shown in FIGS. 10-13. With reference to FIGS. 14, the Teacher has drawn a line between a corner of the cuboid object at the rear right side of the 3D object to the tip of the cone object which appears at the rear left side of the 3D object. The Teacher has done this using an exemplary measurement tool and therefore a measurement box appears near the end point of the measurement which displays “47.68 mm”. Both Students are in lock-on mode. Next described is the detail of these three views with reference to FIGS. 15-17.

FIG. 15 shows the Teacher's view. Visible is the Teacher's tool 1500 which was used to make the measurement from the corner of the cuboid object to the tip of the cone object in 3D object 1525. Also visible is Student 1's remote tool 1501 with Student 1's IP address, as well as Student 2's remote tool (a cursor) 1502, along with Student 2's IP address. As can be seen from the Teacher's view of FIG. 15, Student 1 is pointing with his remote tool near the point at which the teacher's measurement began on the cube. Student 2 is pointing somewhere near the base of the cone.

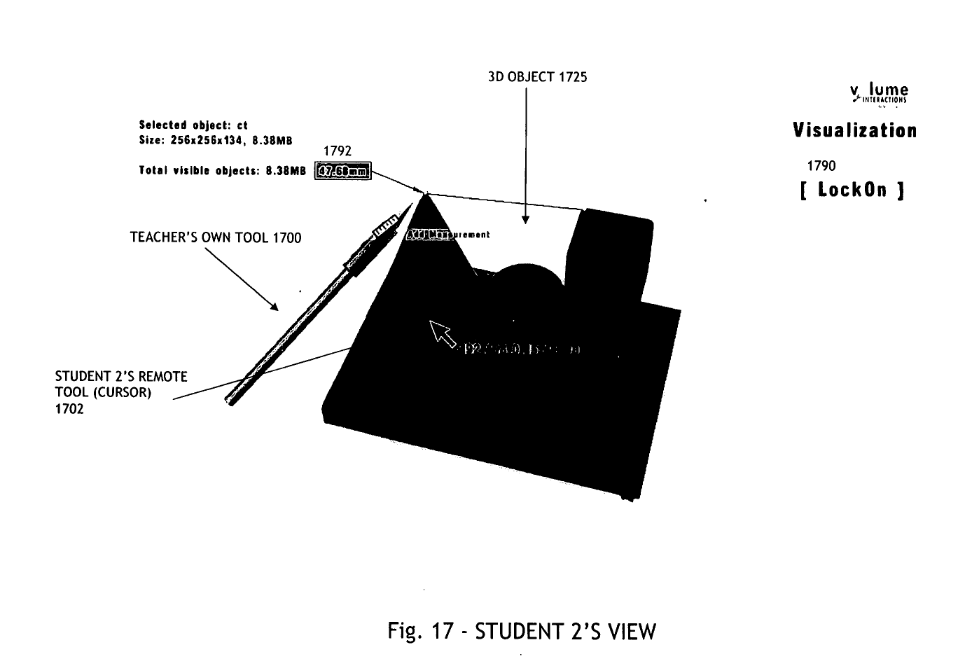

With reference to FIG. 16, Student 1's view, there can be seen Teacher's tool 1600. Teacher's tool, of course, is remote from Student 1. Also visible are Student 1's tool 1601, 3D object 1625 and the measurement line which the teacher has made as well as measurement box 1692. Additionally visible is the lock-on sign 1690, indicating that Student 1 is locked on to the Teacher's view. With reference to FIG. 17, Student 2's view is depicted. Student 2 is locked on to the Teacher's view, and thus lock-on sign 1790 is displayed. Student 2's remote tool 1702 is displayed along with his IP address, as is Teacher's tool 1700. Additionally visible is the measurement line the Teacher has made between the cuboid object and the cone object within 3D object 1725. Accordingly, measurement box 1792, which illustrates the length of the measurement that the teacher has made, is similarly shown.

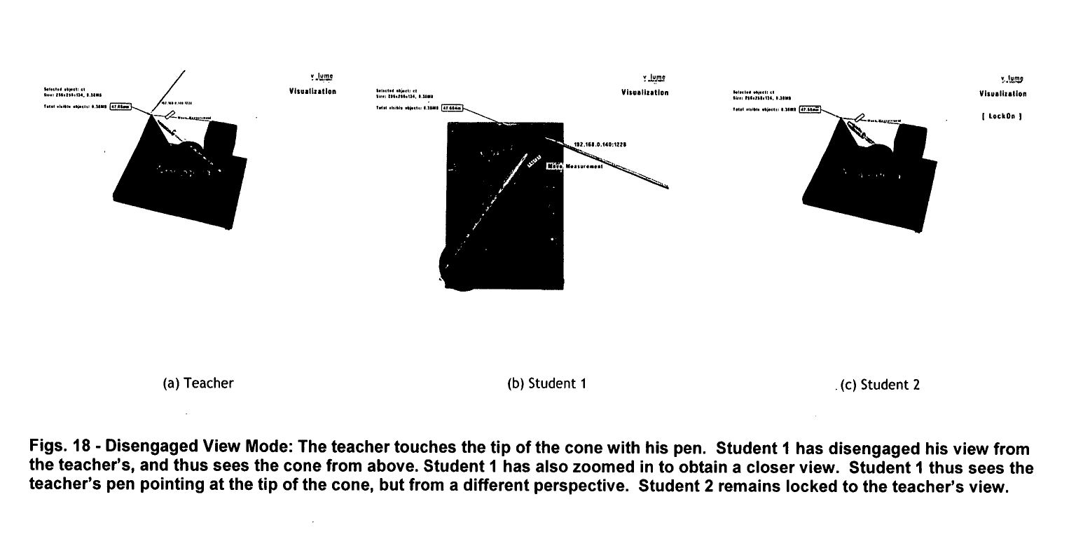

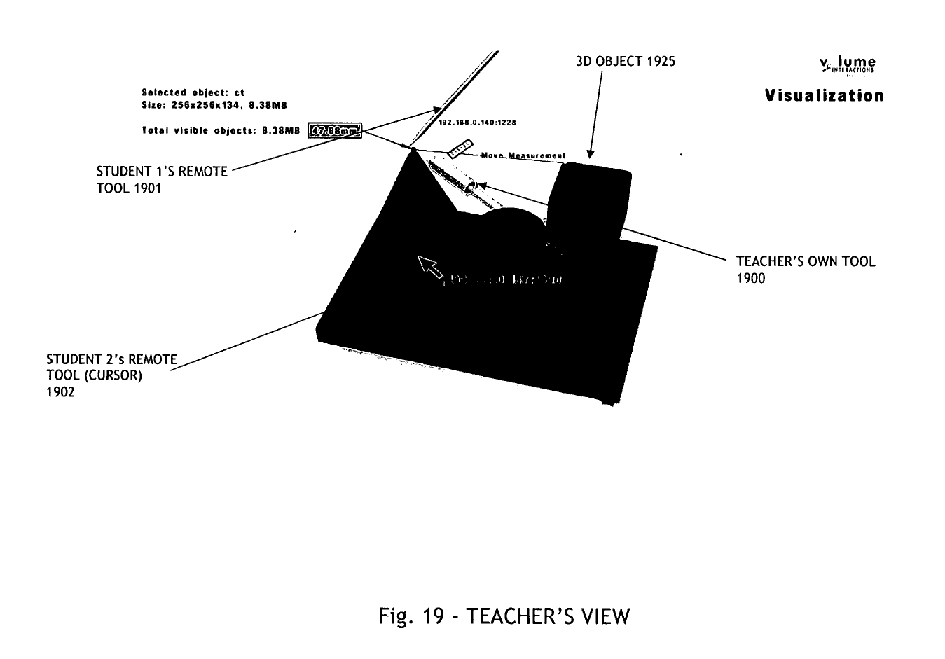

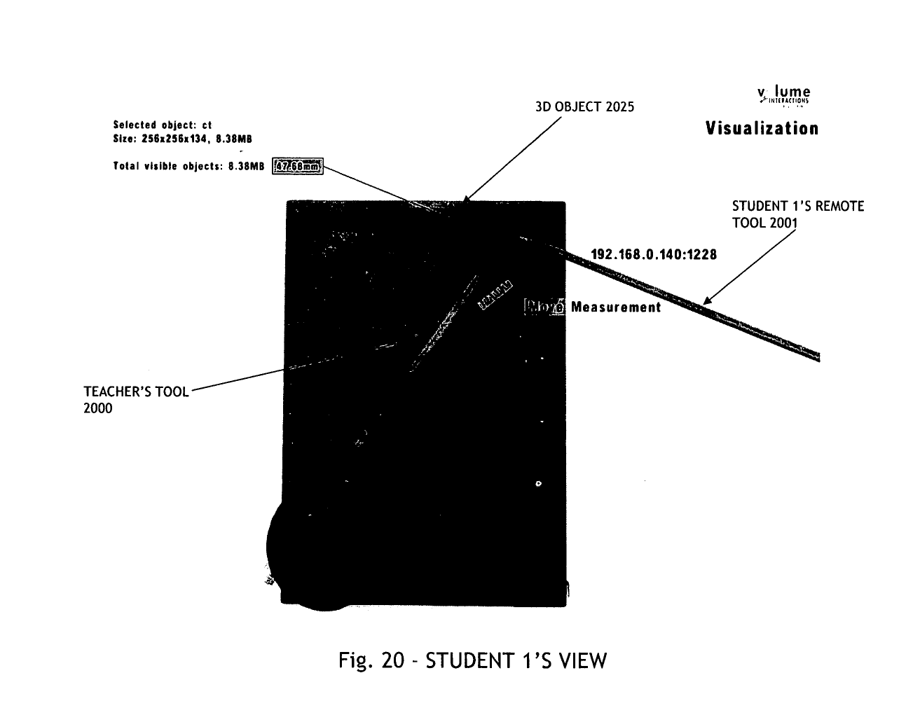

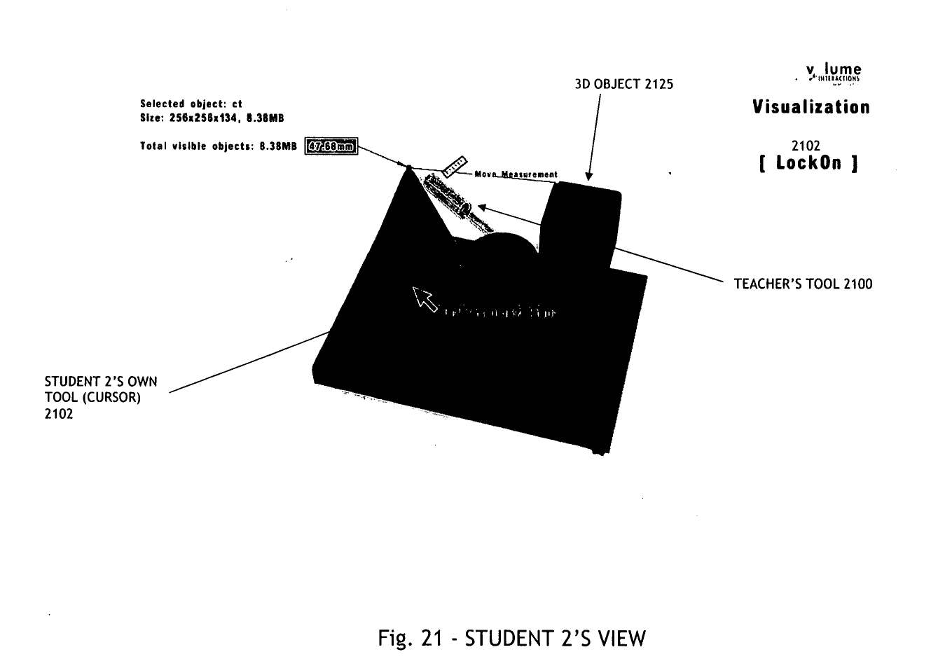

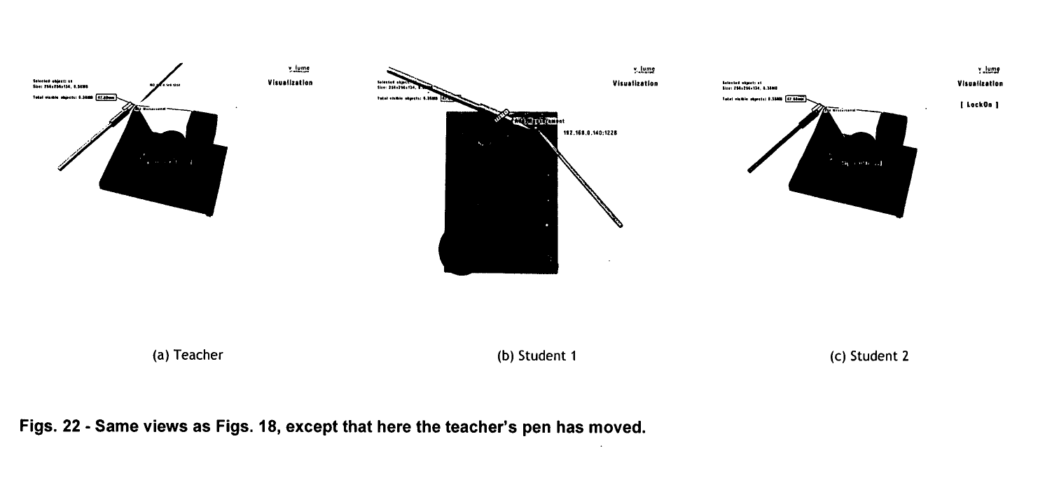

FIGS. 18-21 illustrate the Teacher and Students of FIGS. 10-17 with a significant difference. In FIGS. 18-21, Student 1 has disengaged his view from that of the Teacher's. In detail, and with reference to FIG. 19, the Teacher can see his own tool 1900 and each of Student 1's remote tool 1901 and Student 2's remote tool 1902. As can be seen in FIG. 19, the teacher has just finished making a measurement from the top left rear corner of the cuboid object to the tip of the cone object with his tool 1900. Similarly, with reference to FIG. 20, it is now seen that Student 1 is no longer locked on and therefore the lock-on sign does not appear in this view. Because Student 1 has disengaged from the view of the teacher, he can see 3D object 2025 from above, or any other viewpoint that he chooses. Additionally, in disengaged mode the control panel need not, for example, be shown, as here, and to effect local interactions a student can be shown a set of control buttons appearing on the side of the display, as, for example, described in the DextroLap application, or, for example, a local abbreviated control panel can be provided. Such a local control panel can, for example, be ghosted, as described above, or by virtue of its abbreviated look, not need be ghosted, if easily recognizable as not being the “real” control panel which is under the teacher's control. With reference to FIG. 21, Student 2's view is shown. Student 2 is still locked onto the Teacher so the lock-on sign 2102 is displayed. Student 2 can see both the Teacher's tool 2100 as well as his own tool 2102. He can also see 3D object 2125 and the measurement line that the Teacher has made.

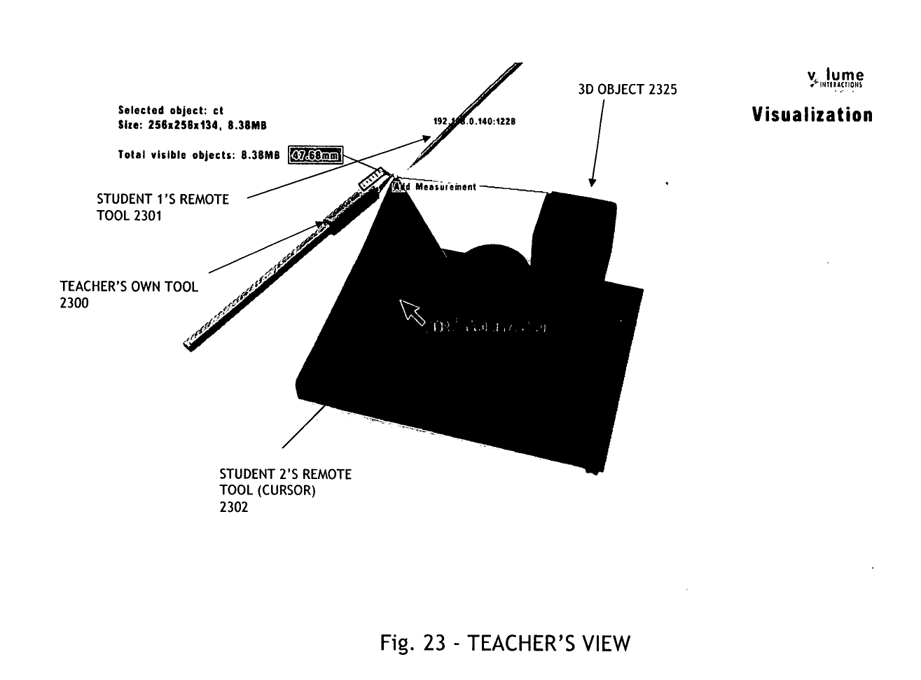

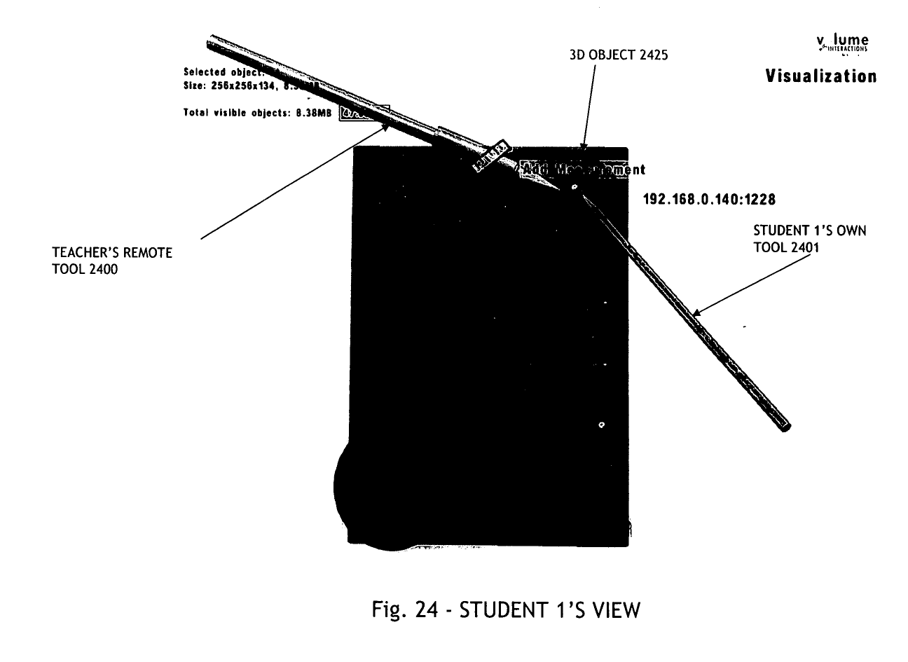

Next described, with reference to FIGS. 22-25, are similar views as those of FIGS. 18 except for a change in position of the teacher's pen. With reference to FIG. 23, the Teacher's view, it is noted that this view is identical to that of FIG. 19 except that the position of the Teacher's tool has moved slightly. Thus, the Teacher's tool 2300 has essentially rotated about the tip of the cone object in 3D object 2325. Still visible are Student 1's remote tool 2301, as well as Student 2's remote tool 2302, in the same position which they had occupied in the view of FIG. 19. With reference to FIG. 24, Student 1's disengaged view, the only things that have changed are the position and orientation of the Teacher's tool 2400 and now here the orientation of Student 1's tool 2401 as well. As can be seen by a comparison of FIGS. 20 and 24, Student 1's tool has rotated downward about the endpoint of the measurement (essentially the tip of the cone in 3D object 2425) so as to make a smaller angle with the measurement line relative to the angle it made with that measurement line in FIG. 20. It is noted that Student 1's view does not depict the cursor of Student 2. This is because, as described above, only the teacher can see all of the students and each student can only see the teacher. Each student is thus effectively oblivious to the existence of the other students (unless, of course, one of the students switches roles and becomes the teacher, a process is described more fully below).

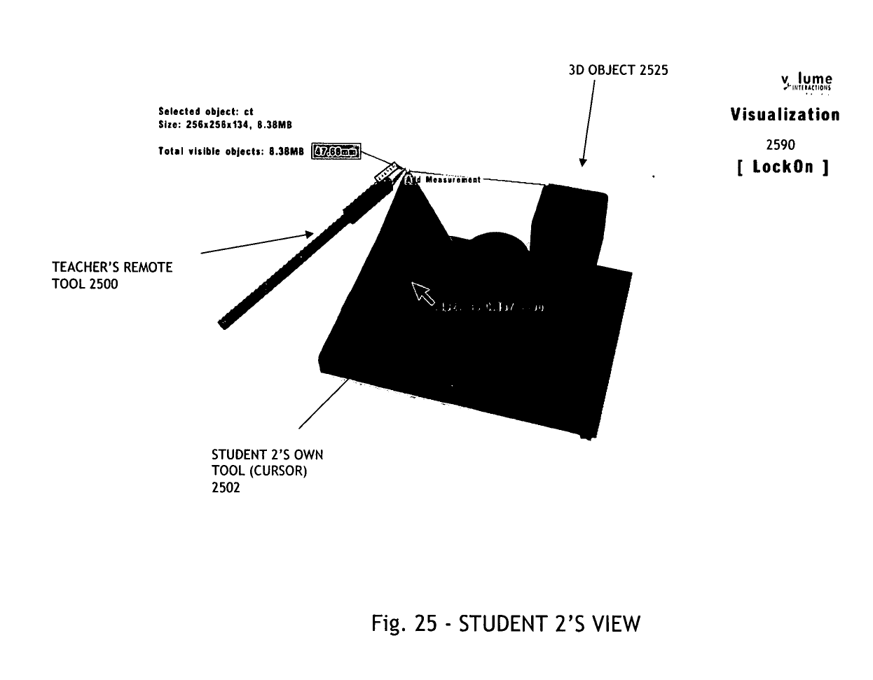

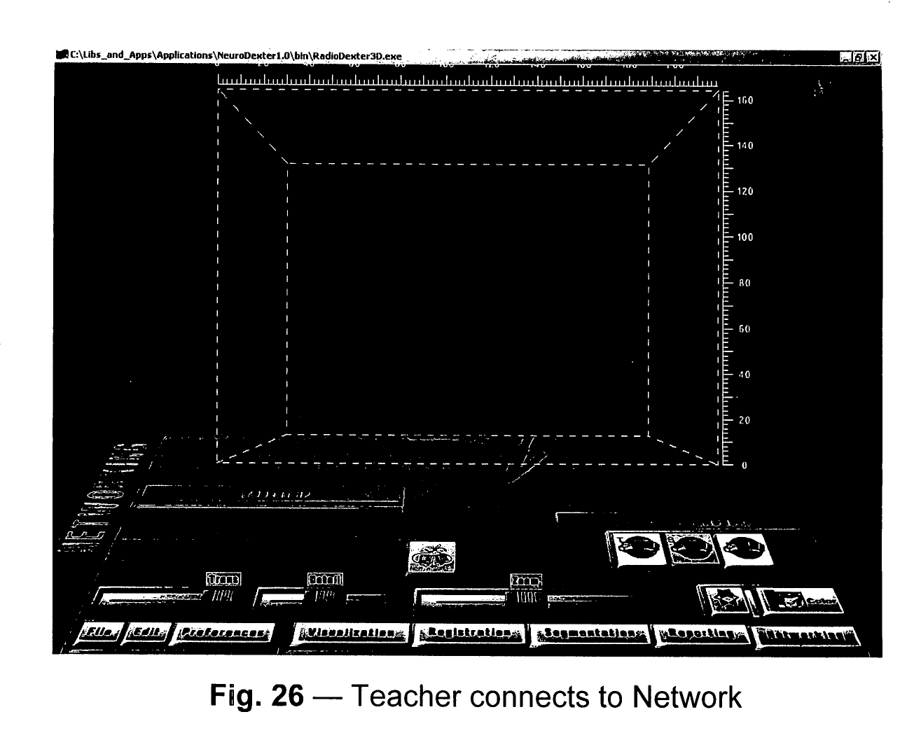

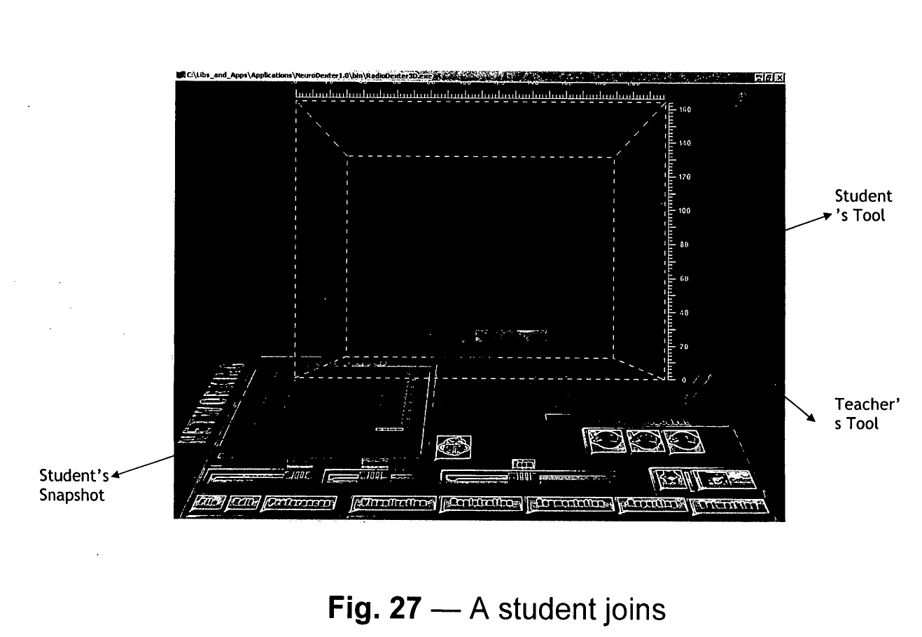

Similarly, FIG. 25 depicts Student 2's view. FIG. 25 is essentially identical to FIG. 21 except for the position and orientation of the Teacher's remote tool 2500. Student 2's own tool 2502 has not moved and nor has 3D object 2525. Student 2 is still in lock-on mode relative to the Teacher's view and therefore lock-on sign 2590 displays in this Student 2 view.

FIGS. 26 through 29 depict an alternate exemplary embodiment where a teacher and two students join a networking session. In FIG. 26 the teacher connects to the network. The system displays the message “you are a TEACHER” and the teacher's virtual tool is visible. No students are yet connected. In FIG. 27 a first student joins. His tool and IP address are seen in the data section and his initial snapshot (as of the time he entered) of his view is visible as well. In FIG. 28 a second student has joined, and his tool and IP address are now available to the teacher as well. Each student's IP address appears as a text box next to their virtual tool. In FIGS. 29 and 30 the teacher synchronizes with each of the first and second student's respectively. The teacher can choose which student to synchronize with by selecting a student form the student list displayed in the left panel of the Networking control panel, as described above.

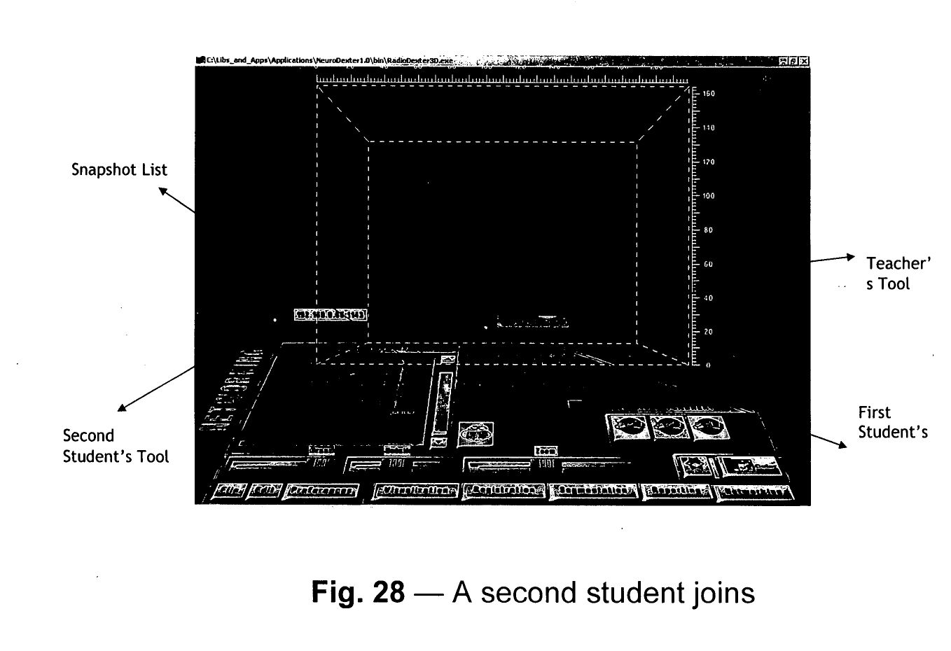

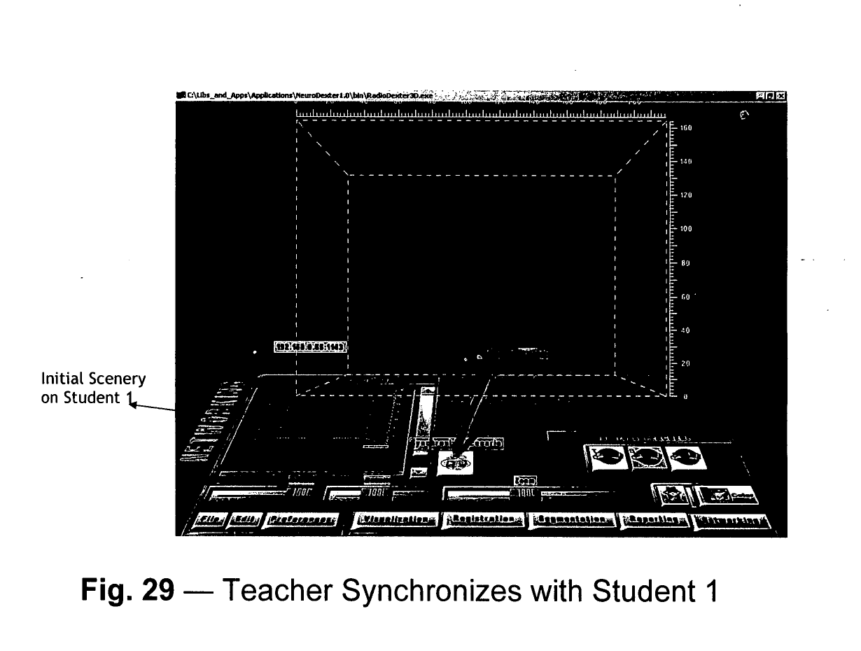

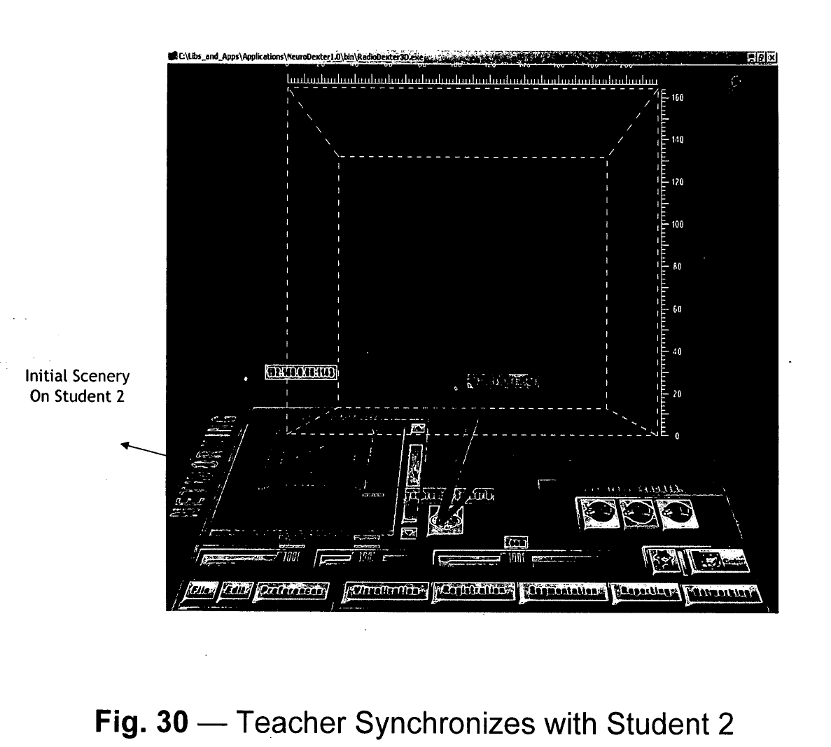

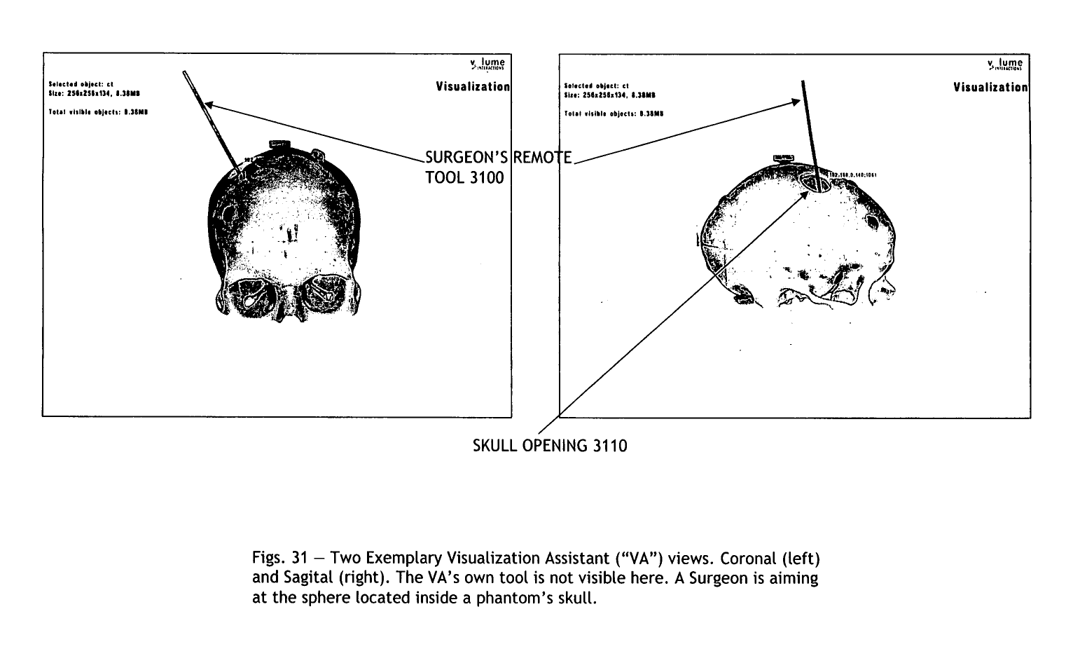

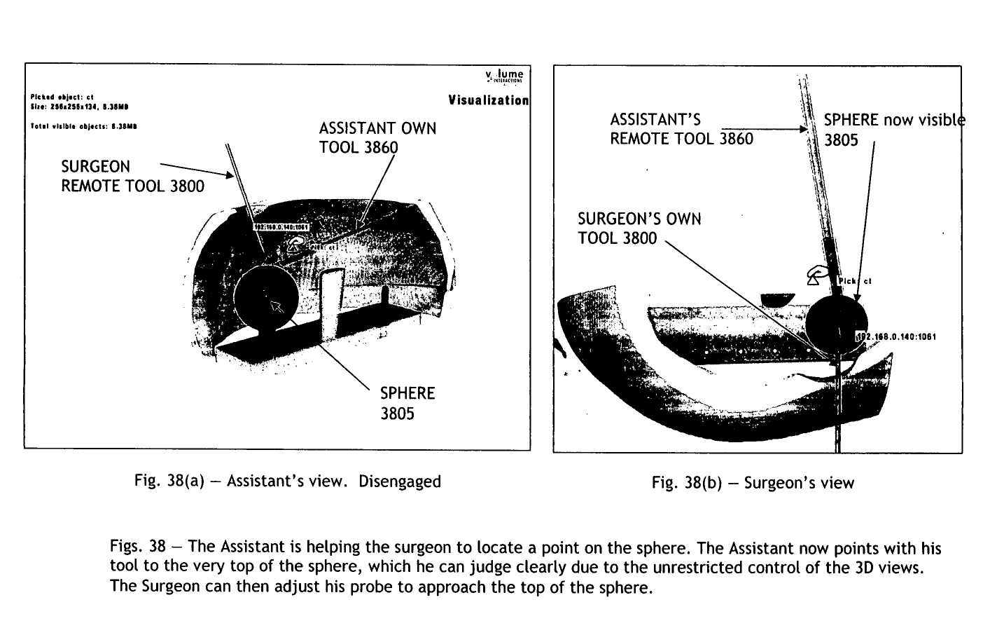

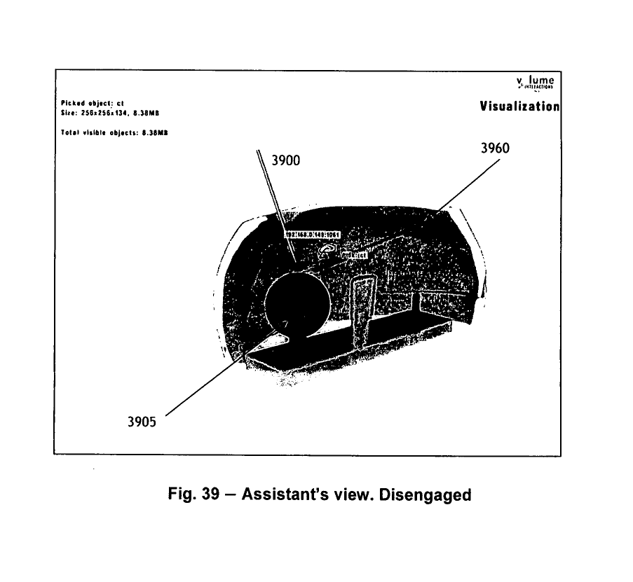

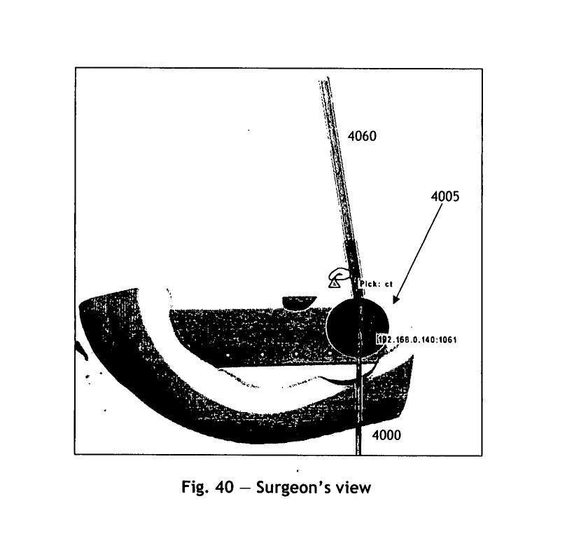

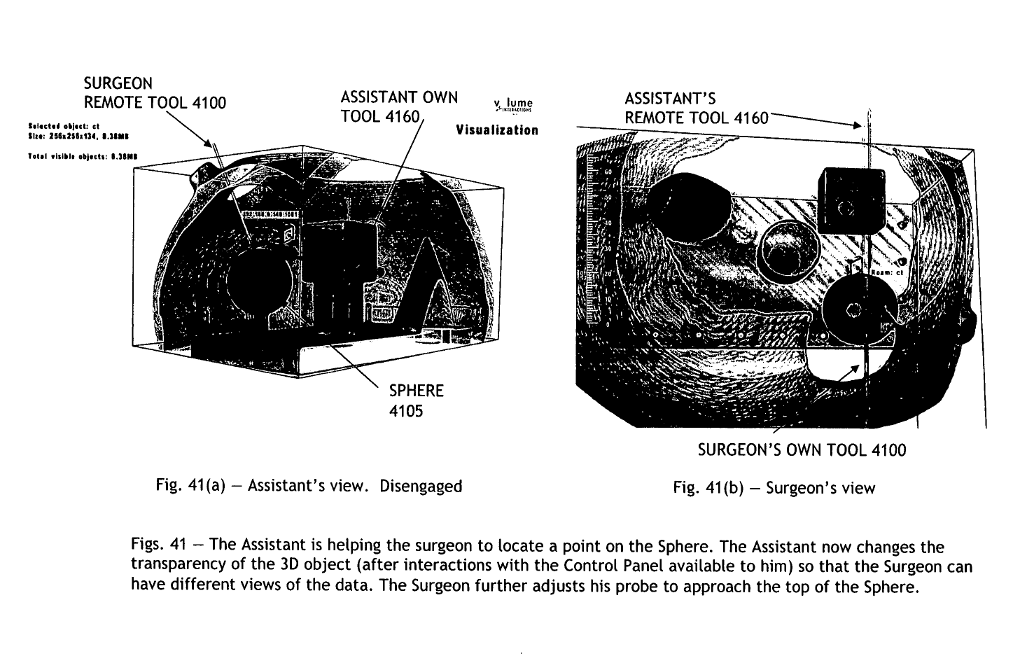

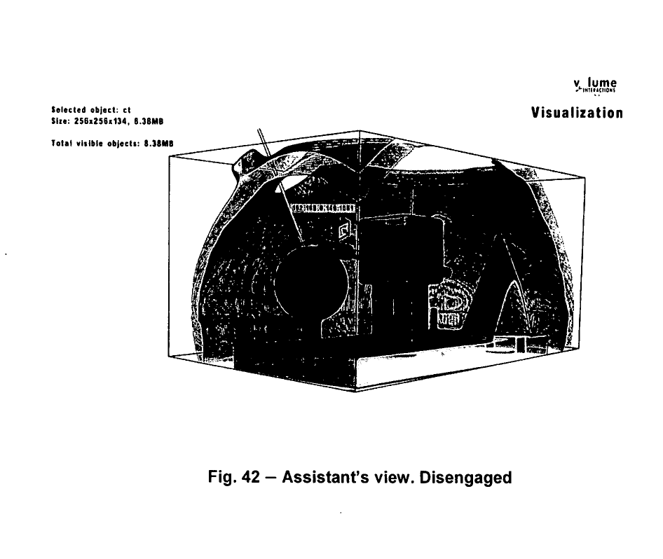

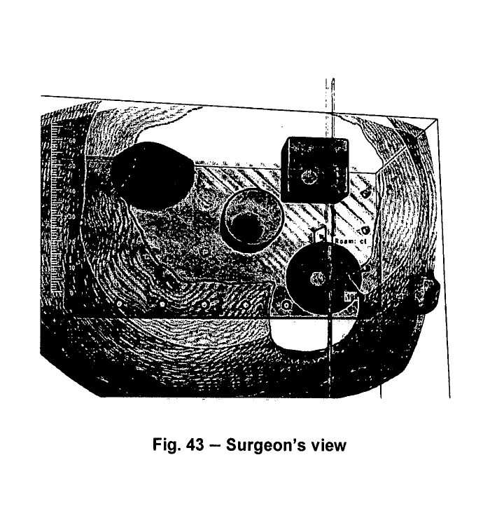

FIGS. 31-43 depict a sequence of various “Surgeon” and “Visualization Assistant” views according to an exemplary embodiment of the present invention. These figures depict how an exemplary collaboration can occur when, for example, a surgeon operates using a DEX-Ray™ type system and a visualization assistant, using, for example, a Dextroscope™ or a DextroBeam type system, is connected over a network to the surgeon's machine. This paradigm can also apply, for example, to any situation where one person is performing a diagnostic or therapeutic procedure and thereby acquiring real-time information regarding a subject, and another person is receiving such real-time data and using it and 3D data regarding the subject to generate visualizations of the subject to assist the first person. Such an exemplary visualization assistant can, for example, use the freedom of viewpoint that he has available (i.e., he can freely rotate, translate and magnify the objects in the 3D data as he may desire, not being restricted to view such objects at the positions and orientations that the surgeon is viewing them at) to see what the surgeon cannot, and thus, for example, to collaboratively guide the surgeon through the patient's tissue in the surgical field. These figures are next described.

FIGS. 31 depict two exemplary Visualization Assistant (“VA”) views. In general, in the surgeon/visualization assistant paradigm, a Surgeon is disengaged from a VA's view, unless he decides to lock-on and see the optimized visualization that the VA has generated, which, in general, will not correlate with the viewpoint and angle of approach that he is physically utilizing in his manipulations of the patient or subject. In the context of FIGS. 31, and in general when a VA is utilized to assist a surgeon using a surgical navigation system, such as, for example, a Dex-Ray™ type system, the Surgeon can act analogously to the student, as described above, and the Visualization Assistant can act analogously to the teacher, as described above. This is due to the fact that an operating surgeon has less freedom with regard to the display of the 3D virtual data inasmuch as his viewpoint is restricted to that of the probe or other instrument that he is holding. For example, using a Dex-Ray™ system, the viewpoint from which the 3D data is seen is identical to that of the camera within the hand held probe. A VA, on the other hand, because he only sees the 3D virtual data, is able to change viewpoints without restriction. Because the Surgeon generally wants to display the augmented reality (or, if using other surgical navigation systems, the 3D data, as seen by a viewpoint substantially similar to that of his tracked instrument), a Surgeon's view is normally disengaged from that of the VA.

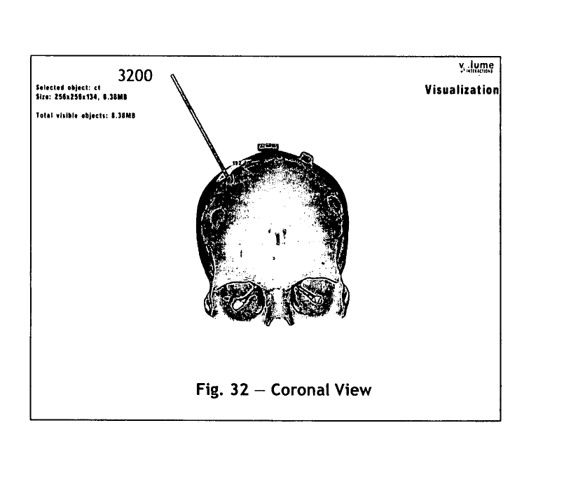

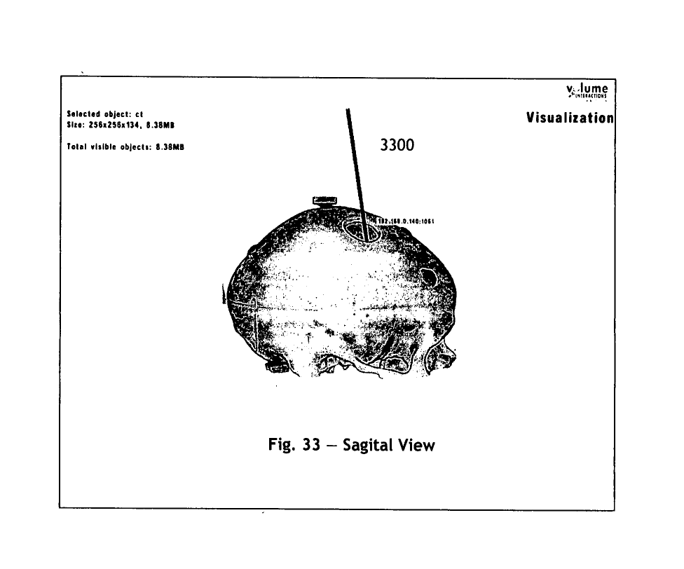

Therefore, with reference to FIGS. 31, the Visualization Assistant has rotated the skull, which represents the object of interest in the Surgeon's operation or procedure, so as to be able to see a coronal view on the left, and a sagital view on the right. In each Visualization Assistant's view, the Surgeon's (acting as Student) remote tool 3100 is visible. In the sagital view, the skull opening is easily seen. It is noted that the Surgeon's point of view, being disengaged, is different from each of these, and will be discussed more fully in connection with FIG. 34 below. As shown in FIG. 34, the Surgeon's actual view is more along the axis of the Surgeon's remote tool 3100, as that is his surgical pathway, as will be seen below. FIGS. 32 and 33 are magnified versions of FIGS. 31, respectively.

FIG. 34 depicts an exemplary Surgeon's view that corresponds to the Visualization Assistant's views of FIGS. 31. This view depicts the actual viewpoint that the Surgeon has, and that is depicted locally on his, for example, Dex-Ray™ type system. The Surgeon's point of view corresponds to (and is thus restricted by) the viewpoint of the camera in the camera probe that he holds, as described in the Camera Probe application, or, for example, if using another surgical navigation system, his physical direction and path of approach into the patient. In FIG. 34, Surgeon's tool 3400 corresponds to the actual camera probe, or navigation probe or instrument, that he holds. Also visible in FIG. 34 is skull opening 2410, the Surgeon's IP address 3416, which, as described above, can be replaced or augmented with some other identifier, and a sphere 3405 which is only partially visible. It is precisely this object that the Visualization Assistant can, by optimizing his point of view, get a better view of, and thereby help the Surgeon locate points upon. It is assumed in FIGS. 31 through 43 that the sphere 3405 (with respect to FIG. 34) represents an object of interest such as, for example, a tumor, that the Surgeon is dealing with.

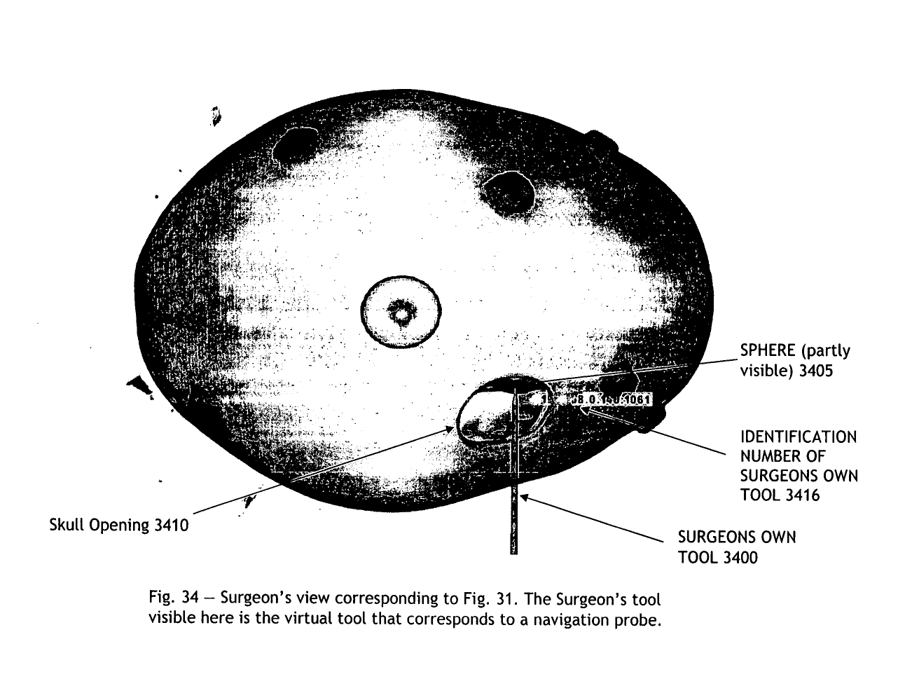

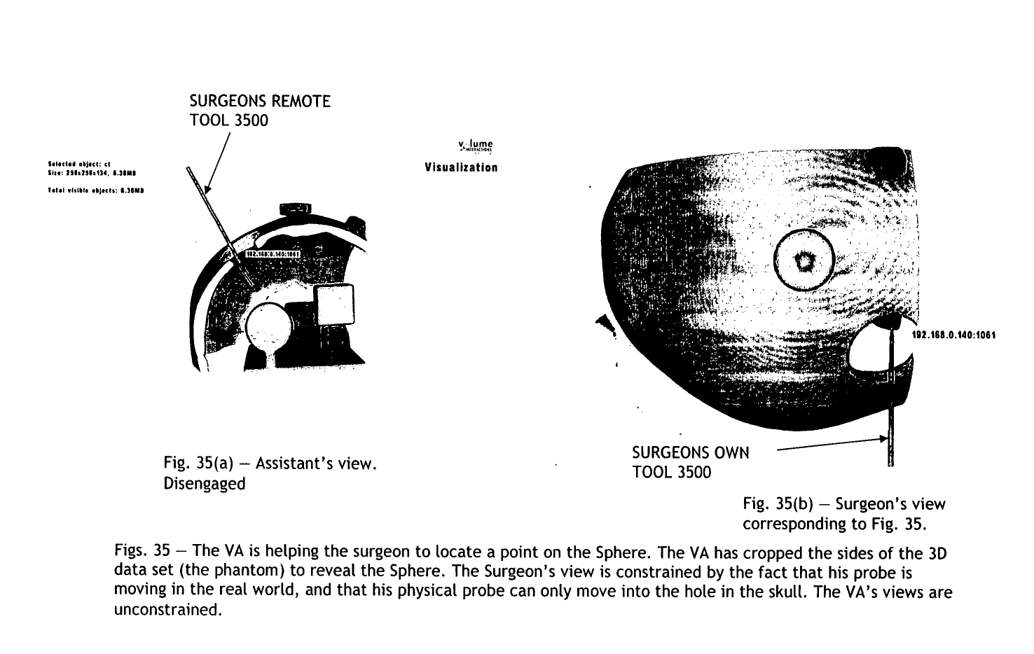

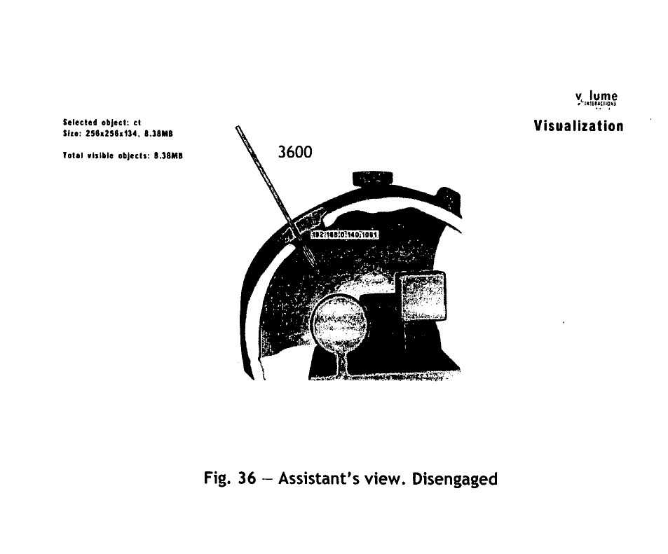

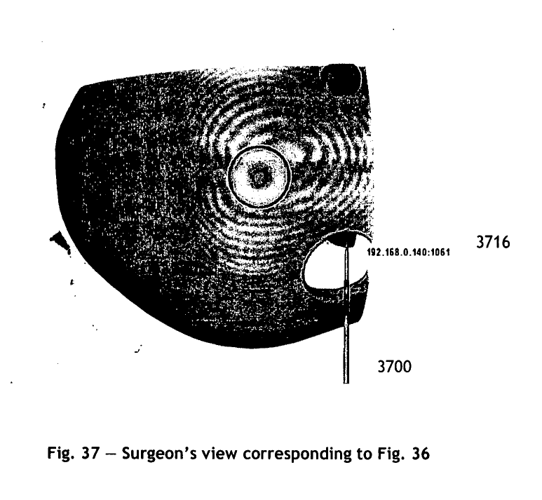

FIGS. 35 depict a Visualization Assistant's view and a corresponding Surgeon's disengaged view of the skull with the skull opening, as described above. In FIGS. 35 the Visualization Assistant aids the Surgeon in locating a point on the sphere. The Visualization Assistant, in his view, has cropped the sides of the skull to reveal the sphere. On the other hand, the Surgeon's view, FIG. 35(b), being constrained by the fact that his probe is moving in the real world, can only move into the actual hole in the skull or skull opening, as described. In contrast, the Visualization Assistant's views are unconstrained, leaving him free to manipulate the data to best visualize this sphere. In each view of FIG. 35(a), the Surgeon's tool 3500 is visible. As can be seen in FIG. 35(b), the axis of the Surgeon's tool corresponds more or less to his viewpoint, whereas in FIG. 35(a) the Visualization Assistant is looking at the objects from behind, relative to the Surgeon's actual path. FIGS. 36 and 37 are respective magnifications of FIGS. 35(a) and (b). As can be seen in FIG. 37, the Surgeon's IP address 3716 is clearly displayed.

VI. Integration with Other Surgical Navigation Systems

In exemplary embodiments of the present invention, it is possible to connect devices with 3D tracking (or 2D tracking) capabilities from varying manufacturers to 3D interactive visualization systems, such as for example, a Dextroscope™ over a DextroNet. Such a “foreign” device will need to be able to provide certain information to a DextroNet in response to queries or commands sent via such a network. For example, Medtronic, of Louisville, Colorado, USA produces various navigation (or image-guided) systems for neurosurgical procedures. One such navigation system is, for example, the TREON™ system. Medtronic also produces application program interface (API) network interface software, that allows data flow from such a navigation system to an outside application in real-time.

Similarly, another manufacturer, BrainLAB AG, of Munich, Germany, has a similar software product. This product uses a custom designed client/server architecture termed VectorVision Link (VV Link) which extends functionality from a Visualization Toolkit (VTK). VV Link enables bidirectional data transfer such as image data sets, visualizations and tool positions in real time. These devices provide registration information and probe coordinate information, in a similar manner to the DEX-Ray™ system. However, because they are not augmented reality based, there is no video information provided. In exemplary embodiments of the present invention, modification of a DextroNet server could incorporate such Stealthlink™ or VV Link software, and after connection, in which patient information and registration details could, for example, be exchanged, a DextroNet could, for example, query these systems to obtain their probe coordinates. Thus, in exemplary embodiments of the present invention, such systems can function as surgeon's workstations, and can provide spatial coordinates to a teacher (VA) workstation. It is noted that unlike the DEX-Ray™ implementation described above, these systems as currently configured would not have the option to display to a Surgeon views from the VA's workstation during surgery. To do so would require them to incorporate software embodying the methods of an exemplary embodiment of the present invention into their navigation systems.

Similarly, as noted above, in exemplary embodiments of the present invention, machines to be connected across an exemplary DextroNet can come from different manufacturers, have different configurations, and be of different types. As described above, surgical navigation systems such as, for example, the Dex-Ray™ system, or the Medtronic or BrainLAB systems, can be connected across a DextroNet to a standard 3D interactive visualization workstation such as, for example, a Dextroscope™, a DextroBeam™, etc. As was further noted above, systems which send only 3D positional data, such as, for example, surgical navigation systems which do not utilize augmented reality, can also be connected.

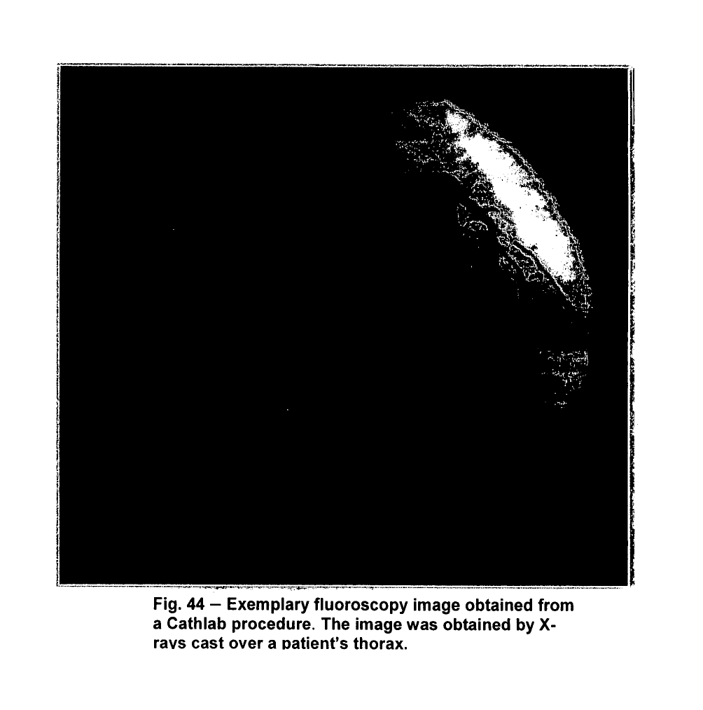

FIGS. 44-49, next described, present yet another alternative use of a DextroNet according to an exemplary embodiment of the present invention. This example involves an exemplary cardiologist generating fluoroscopic images in 2D which are sent across a DextroNet to an interactive 3D visualization system, such as, for example, a Dextroscope™. The paradigm is similar to that of the surgeon and visualization assistant described above. However, in this case, there is no surgeon, but rather, an interventional cardiologist. In such exemplary embodiments a visualization assistant can help such an interventional cardiologist visualize the anatomical structures of his concern, due to the visualization assistant's unconstrained 3D manipulation of a pre-operatively obtained CTA scan.

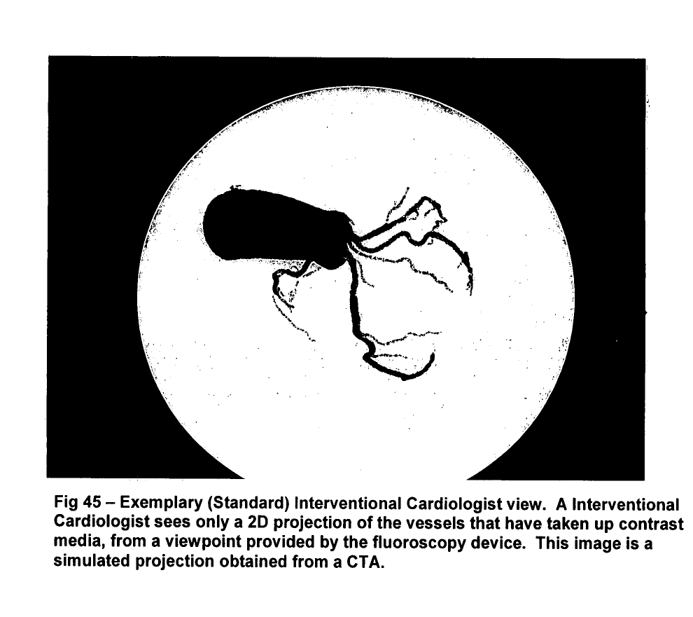

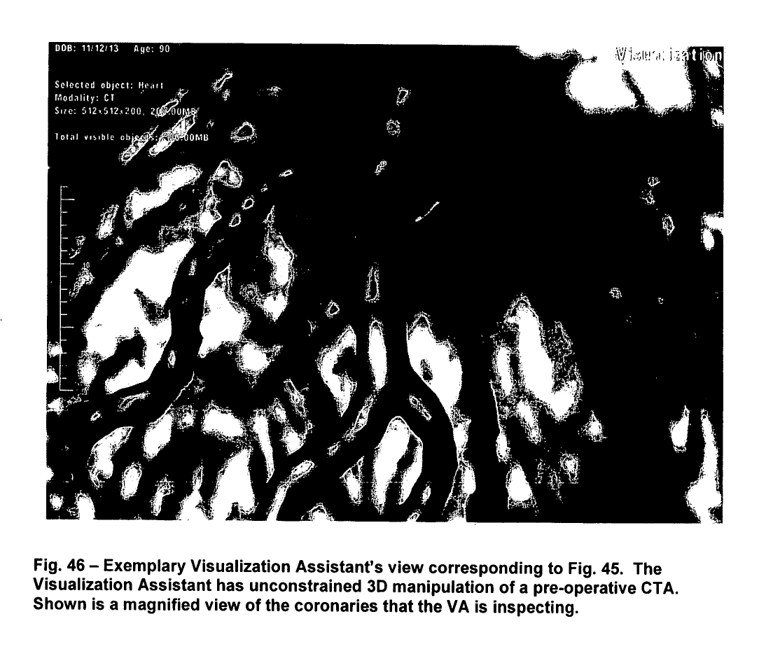

Thus, with reference to FIGS. 44, an exemplary fluoroscopy image obtained from a Cathlab procedure is depicted. The image has been obtained by casting X-rays over a patient's thorax. Visible in the image are the arteries, more precisely, those portions of the interior of the arteries that have taken up an administered contrast agent. FIG. 45 depicts an exemplary standard interventional cardiologist's view. With reference to FIG. 45, an interventional cardiologist sees only a 2D projection of the vessels that have taken up the administrative contrast media, from a viewpoint provided by an exemplary fluoroscopy device. The depicted image of FIG. 45 is a simulated projection of such a conventional interventional cardiologists view (a matching set of actual fluoroscopy image and associated CTA was not available). The simulation was obtained by operating on CTA data (segmenting the coronary arteries of the CTA (thus showing only the arteries and not the other tissue, which is what contrast media does when it flows into the arteries and interacts with X-rays emitted by the fluoroscopy device), coloring them dark as though they were the result of fluoroscopy, and orienting the segmented arteries and taking a snapshot, and then taking snapshots of the CTA without segmentation).

FIG. 46 depicts an exemplary visualization assistant's view corresponding to the clinician's view of FIG. 45. Such an exemplary visualization assistant can collaborate with the interventional cardiologist of FIG. 45. As noted, such a visualization assistant has unconstrained 3D manipulation of a pre-operative CTA. FIG. 46 depicts a magnified view of the coronary arteries that the VA is inspecting. FIGS. 46-48 illustrate an exemplary interaction between interventional cardiologist and visualization assistant according to an exemplary embodiment of the present invention. They depict a manual way of registering the CTA view with the fluoroscopy view. Here, for example, a VA can obtain a fluoroscopy image such as FIG. 45 via DextroNet, and then, for example, using that image can adjust the CTA (e.g., the segmented coronaries) to match this received view. Once the VA is oriented, and knows what the cardiologist is viewing (there are restrictions on the fluoroscopy device, which is usually not tracked, but has some standard positions that cardiologists know well) then the unrestricted 3D manipulation allows the VA to indicate in real-time to the cardiologist what is what. He can, for example, label those vessels with annotations, such as, for example, “Left Coronary Arteries”, or “LCA,” and similarly, for example, “Right Coronary Arteries” or “RCA”, or, for example, he could point at the stenosis in the vessels (in 3D), which can then be provided to the interventional cardiologist in the Cathlab image (a projection, or in stereo if such a display is available). Moreover, for example, a VA could measure, and if the VA can see the new images from the fluoroscope, he can identify where the catheter is and infer the 3D position, and then communicate back to the cardiologist distances to key anatomical landmarks.

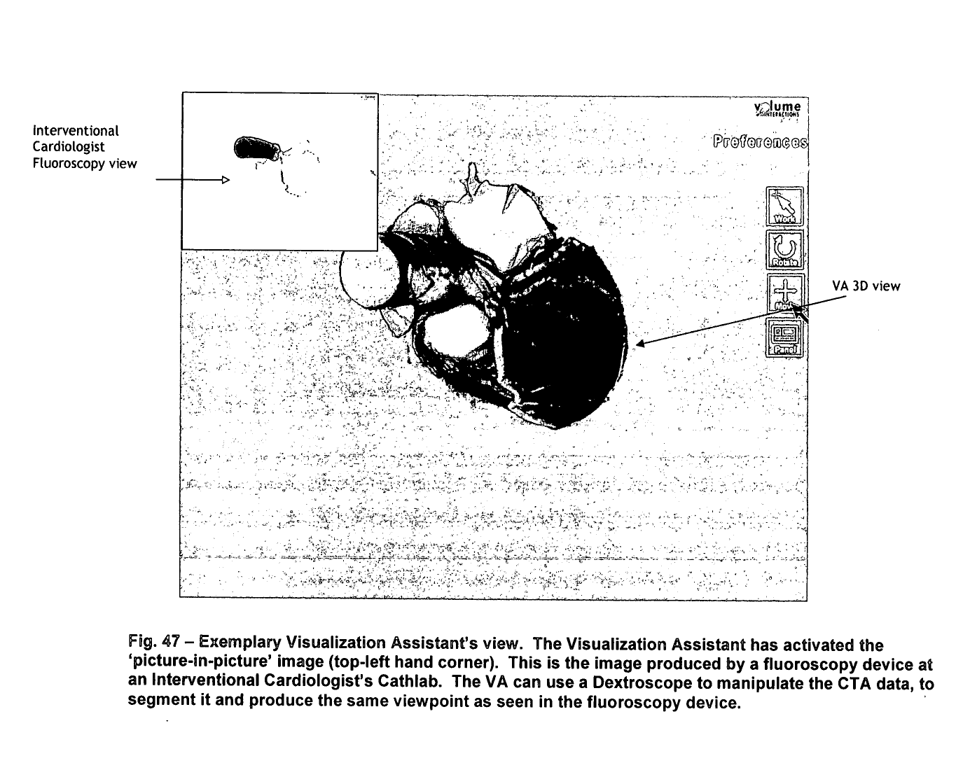

FIG. 47 depicts a similar scenario to that of FIG. 8 described above. The visualization assistant can see both the full 3D and the main image and can also see a snapshot or “picture-in-picture” image in a top left-hand corner. The picture-in-picture image is that produced by an exemplary fluoroscopy device at, for example, an interventional cardiologist's Cathlab machine. It is essentially the image depicted in FIG. 45, described above. The visualization assistant can use a Dextroscope™, or equivalent device, to manipulate the pre-operative CTA data, to segment (or re-segment) and to visualize the vessels from optimally the same viewpoint as seen in the fluoroscopy device. He can do this by aligning the viewpoint to what he sees in the picture-in-picture, for example. Also visible at the far right side of the VA's view are exemplary interactivity buttons, similar to those commonly seen on a DextroLap implementation, illustrating that the VA can, for example, use a DextroLap, if circumstances so necessitate, or for example, he could use a full Dextroscope™.

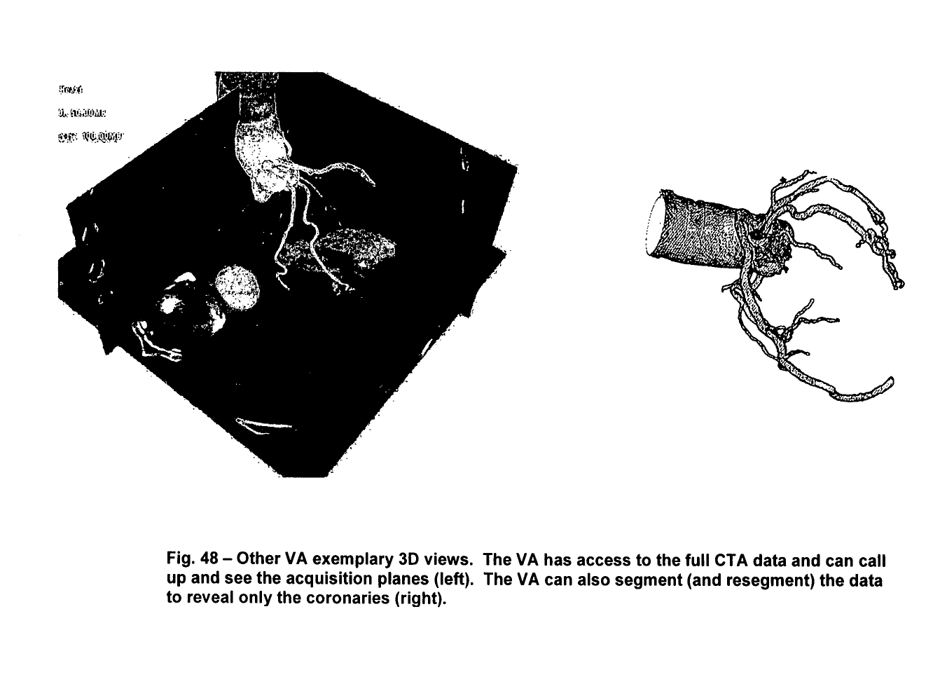

FIG. 48 shows yet alternative exemplary 3D views that the VA can generate. This is, as noted, because the VA has access to the full CTA data and can therefore, for example, bring up acquisition planes, as shown in the left image of FIG. 48, or, for example, can segment the data to reveal only the coronaries, as show, in the right image of FIG. 48.

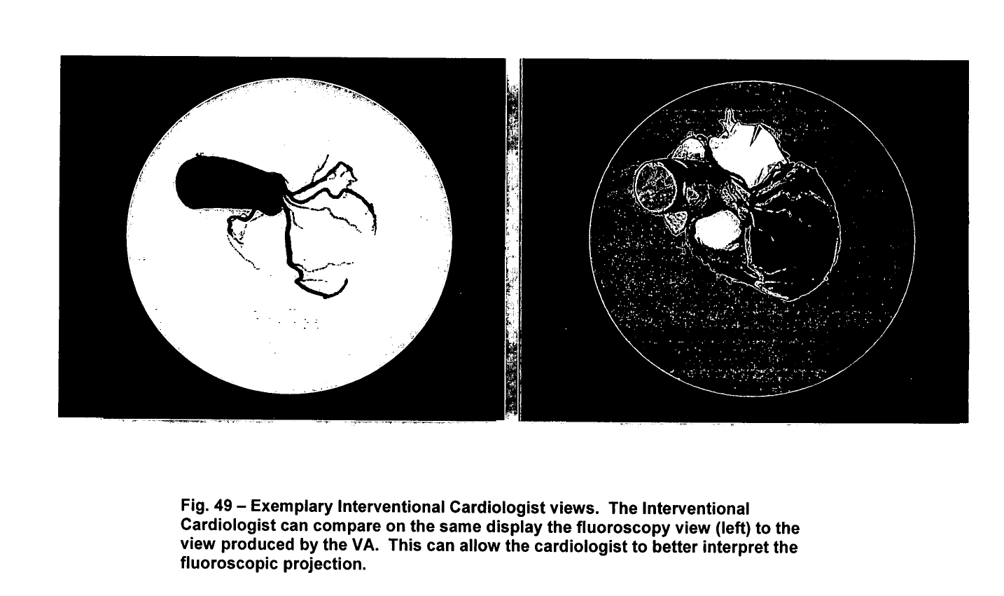

Finally, FIG. 49 depicts side-by-side images that can, for example, be displayed at the interventional cardiologist's Cathlab device. The interventional cardiologist can compare, on the same display, the fluoroscopy view he obtains with his local machine (left) with that of the view produced by the visualization assistant on a, for example, Dextroscope™ or DextroLap machine. This comparison facility can allow the cardiologist to better interpret the fluoroscopic projection. Using communications between the interventional cardiologist and the visualization assistant, the visualization assistant can, for example, refine, re-segment, and optimize, as may be desirable and useful for the interventional cardiologist, the views that he generates locally and sends over the DextroNet to the interventional cardiologist for display (as shown in FIG. 49) and comparison by the interventional cardiologist. This can be done, for example, using a feature such as that of the Cathlab system, which has several monitors showing the fluoroscopy procedure. It would be a simple task to add another monitor with 3D images. These latter images could, for example, match the fluoroscopy or not. Such systems also show the fluoroscopy device position, as well as other patient information. Or, for example, other displays, such as monitor with simple touch screens used in sterile conditions can be used to display the VA's visualizations back to the clinician.

VII. Role Switch

In exemplary embodiments of the present invention, a role-switch function can be supported. Role-switch is a feature in an exemplary DextroNet that allows a teacher and a student (or a surgeon and visualization assistant) to exchange their respective roles online. In a teacher-student paradigm, the student cannot manipulate an object in the 3D dataset except for translating, rotating and pointing at the object. With role-switch, once a student takes over control from a teacher, he can, for example, continue the teacher's work on the object. This suggests a mode for collaboration to some extent. Moreover, since at one time only one teacher exists over network, this collaboration is serial, without conflict problems.

In an exemplary DextroNet, both the teacher and the student can be clients at low level, which makes role-switch natural. Role-switch can make use of the current communications session (i.e., the networking need not be stopped and reconnected) and can exchange the teacher and student roles in high level. In this way, role-switch can be quite fast by avoiding time consumption for reconnection.

Role-switch can support multiple students. The teacher decides to which student he transfers the right of control. Other students can remain as they were, but can, for example, be made aware that the teacher has been changed.

As noted above, in exemplary embodiments of the present invention, both the teacher and the student(s) can be, for example, clients in a low level sense. As shown in FIG. 9, in exemplary embodiments of the present invention a DextroNet can utilize a server-client architecture. In such an architecture, the both teacher and student are clients. The server can also, for example, be used to manage communications between a teacher and multiple students. Thus, a role switch can make use of the current communications session without having to stop and reconnect the networking. During the entire process, no changes of physical connection need to occur. Only the logical new roles need to be assigned and re-registered on the server. A general process to communicate the role change among all clients can be, for example, as follows. After a student appeals for the right of control, the teacher informs other students and the server to be ready for a role-switch. Then, for example, both the teacher and the students can reset and update their tools according to an exemplary role change as follows:

The machine of a teacher who is going to become a student changes the student tool to be the local tool and his teacher tool to be the specified remote tool (i.e., of the new teacher). Other remote student tools are removed from being displayed.

The machine of a student who is going to become a teacher changes his teacher tool to be the local tool, and adds tool representations (student tools) for the other students as well as the teacher who is going to become a student.

Other students' machines update their teacher tool to represent the new teacher. Their local tools remain as student tools.

Once these role changes have been completed, all clients can re-register their new roles on the server. The role switch then can complete.

Since an on-going communication session is used that can support multiple students, management of data flow can require care. Data received before and after an exemplary role-switch needs, for example, to be separated and the re-registration of roles on the server needs, for example, to be synchronized. To achieve this, the whole process can be, for example, separated into three phases: get ready for role-switch (Phase I), change role (Phase II), and re-register the new role on the server (Phase II). At the end of each phase, the states of all clients can be synchronized.

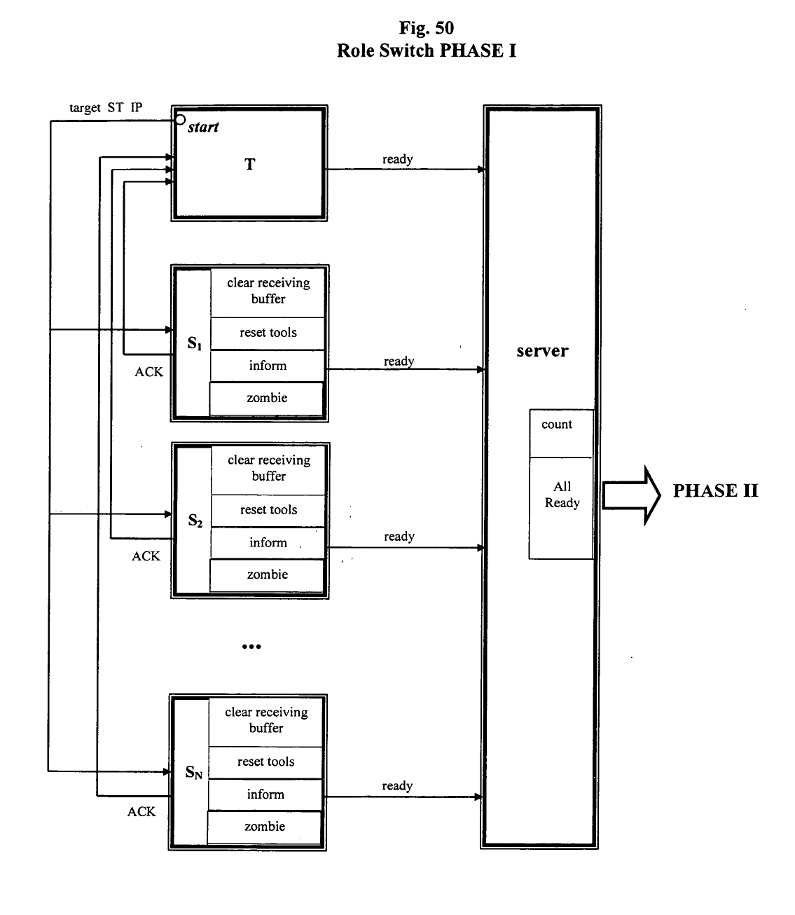

This process can be summarized as follows with reference to FIGS. 50-52.

A. Phase I (FIG. 50):

(1) The teacher signals all the students to whom he will transfer the control. After he receives acknowledgement from all his students, his tools are reset, and the server is informed that he is now ready for role-switch, and enters a state of zombie (i.e., a state in which the machine can only receive—but not transmit—data).

(2) When a student receives the signal from the teacher, his machine checks whether he will become a teacher or still remain a student, and acknowledges the teacher. Meanwhile, the server also needs to be informed that he is now ready for role-switch after he resets his tools. This reset will not affect the changes already on the volume object. Then he enters a passive or “zombie” state, which is, as noted, a state wherein a machine only receives messages without sending anything.

In exemplary embodiments of the present invention a user does not have to worry about all the notifications in a role switch process. All role switch processing can be done automatically once a user presses the “role switch” button (and thus references to a teacher or student “doing something” in the description above and in what follows are actually referring to exemplary software implementing such actions).

In exemplary embodiments of the present invention, a server can be used to administer communications between the teacher and the students. It can have, for example, a stored list to remember their roles. Hence, when a role is switched, the server has to be informed. Moreover, during the role switch, the state of teacher and students have to be synchronized at the end of each phase. The server, for example, can also coordinate this process. For example, at the end of Phase I, a student/teacher has to inform the server if he is ready for role switch. After that, he can enter the zombie state, waiting for an instruction from the server that he can change role now. The server can, for example, count how many clients are ready for role switch. Only after he finds that all clients are ready, he can sends the instruction to everyone so that they can enter Phase II.

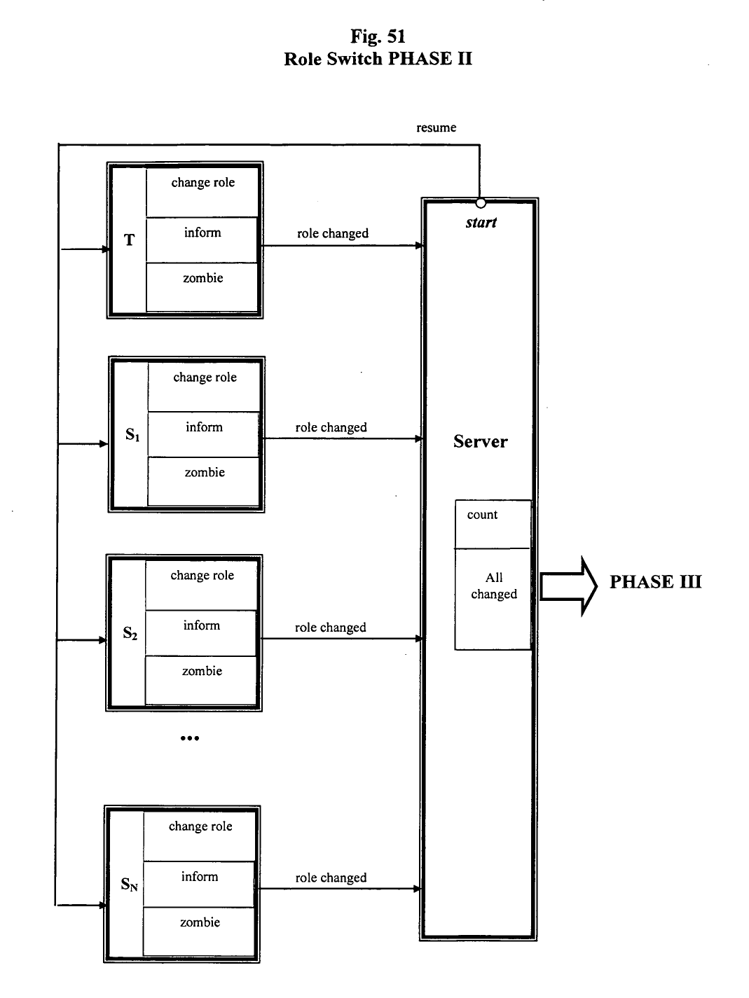

B. Phase II (FIG. 51): (3) When the server finds all the clients are ready for role switch, he sends messages to them and resumes them from zombie.

(4) Once a client (teacher/student) is resumed, the client changes his role, informs the server, and enters zombie state again.

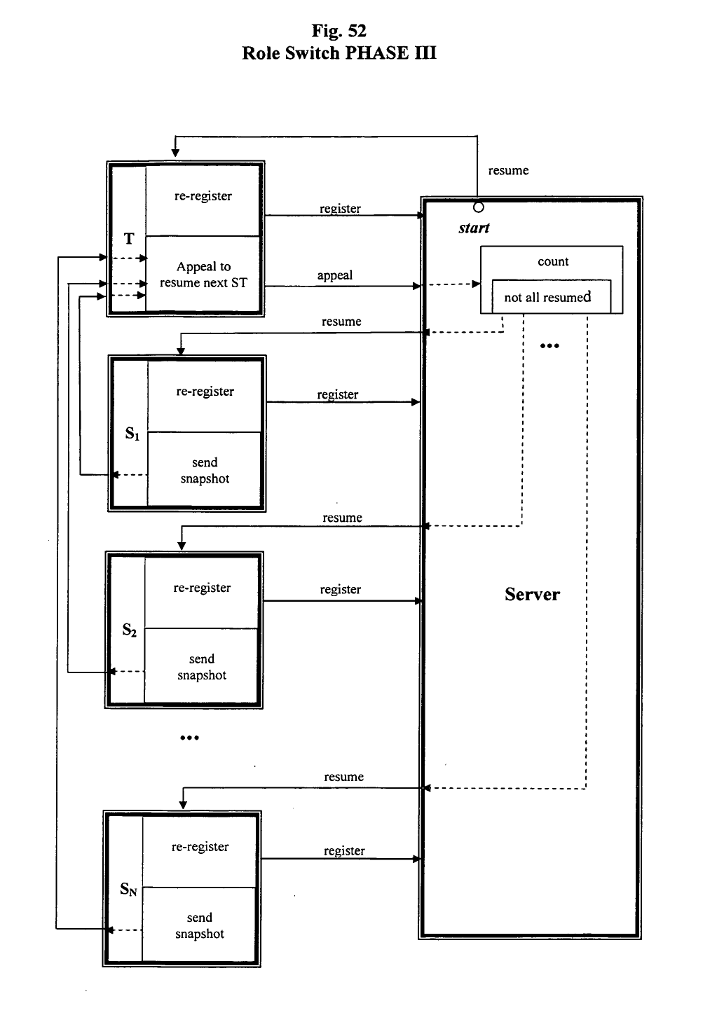

C. Phase III (FIG. 52):

(5) Once the server gets the role-switched message from all his clients, he resumes the teacher first.

(6) The teacher re-registers on the server and informs the server. The server then resumes a student.

(7) After the student re-registers on the server and the teacher receives an initial snapshot from the student, the teacher appeals the server to resume the next student.

(8) Step (7) can be repeated, for example, until all the students have been re-registered.

Additionally, in exemplary embodiments of the present invention, for multiple participants, the teacher role can be passed around from participant to participant, with each role switch following the above-described process.

VIII. Data Format

In exemplary embodiments of the present invention the following strategies can be utilized to ensure the proper display in a remote terminal:

A. Data:

Each side (teacher/student) holds the same copy of data. If the data are different, the whole dataset can be synchronized (compress and send the data files).

B. Initialization:

In exemplary embodiments of the present invention, a virtual control panel can be synchronized on both sides when initiating the networking function. In Dextroscope™/DextroBeam™ workstations for example, a virtual control panel needs to be precisely calibrated with the physical acrylic base where the 3D tracker rests during interactions, so that the virtual tool can touch the corresponding part on the virtual control panel. Thus, calibration and configuration are local, varying from machine to machine. This can, for example, cause a mismatch problem while networking: the teacher's tool can, for example, not be able to touch the student's control panel. To avoid this problem, in exemplary embodiments of the present invention, the control panel can be synchronized. When networking function is activated, for example, the position, orientation and size of the teacher's control panel can be sent to the student, and replace the parameters of the student's own control panel. When the networking function terminates, for example, the ex-configuration of the student can be restored for working stand-alone.

In exemplary embodiments of the present invention the viewpoint on both sides can be synchronized when initiating the networking function. For proper display, the teacher and the student should share the same eye position, look-at position, projection width and height, roll angle, etc. All the information pertaining to the viewpoint should thus be synchronized at the beginning of the networking function.

In exemplary embodiments of the present invention a zoom box on both sides can be synchronized when initiating the networking function. Thus, when an exemplary networking function starts, the zoom boxes on both sides have to be synchronized by the position, orientation, bound, compute screen area, etc.

C. Synchronize the Widgets

In exemplary embodiments of the present invention, when an exemplary networking function starts, initial states of the control panel on both sides may be different, such as, for example, the position of slider bars, the state of buttons and tabs, the list of color lookup tables, etc. All these parameters need to be aligned.

D. Communication

In exemplary embodiments of the present invention, two types of coordinate systems can be used: world coordinates and object coordinates. World coordinates are those attached to a virtual world. Object coordinates are attached to each virtual object in the virtual world. In exemplary embodiments of the present invention, all virtual tools can be displayed in world coordinates. The teacher and the student can each communicate the type of the coordinate system that they use.

When a student is in the engaged mode (“LockOn”), both the teacher and the student send their tool's name, state, position, orientation and size in world coordinates to his peer.

When a student is in the disengaged mode (not “LockOn”), on the teacher's side, if the teacher's tool touches the control panel, the teacher can, for example, send the tool's name, state, position, orientation, and size in world coordinates to the student. Otherwise, he can send the name, state, position, orientation and size in object coordinates to the student. When the student receives the information relevant to the teacher's tool, he can convert the received information from object coordinates to world coordinates, and can then display the teacher's tool in his world. In the meantime, the student can send his tool's name, state, position, orientation and size in object coordinate to the teacher. The teacher can then, for example, convert them to world coordinates before displaying the student's tool. In exemplary embodiments of the present invention the student can decide what action to take based on the position, orientation and state of the teacher's virtual tool in his world.

In exemplary embodiments of the present invention, a DextroNet can synchronize the viewpoint modes on teacher and student sides. When a student chooses to disengage his viewpoint, he can, for example, press a button on his stylus. This action can cause a message to be sent to the teacher's machine to the effect that “I am going to be disengaged. That's all at this moment. The student does not, for example, actually switch his viewpoint. He continues to use the world coordinates from the teacher. When the teacher's machine receives the student's message, it can, for example, then send the student an acknowledgement, and start to transform the object coordinates from then on. Once the student's machine receives such an acknowledgement from the teacher's machine, it can then actually change to be disengaged, and can then utilize the object coordinate.

The situation can be the same, for example, when a student re-engages. Thus, a student's machine can, in exemplary embodiments of the present invention, only changes the student's viewpoint after the teacher's machine has become aware of the student's disengage decision. In this manner, conflicts between the type of coordinates sent by a teacher's machine to a student's machine before and after disengagement or re-engagement can be avoided.

E. Telegram Format

In exemplary embodiments of the present invention, there can, for example, be two telegram formats. One, for example, can be used for updating messages, the other can, for example, be used for files.

1. Format I for Updating Messages

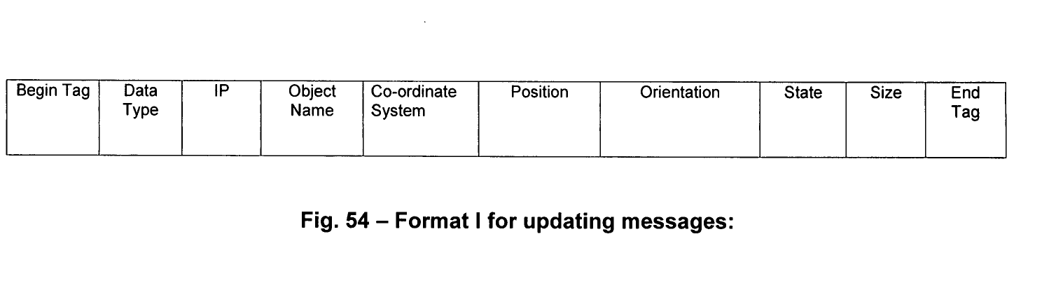

FIG. 54 depicts a first exemplary format for updating messages. The following fields, with the following attributes, can be, for example, used.

Begin Tag: marks the beginning of a telegram (unsigned char);

Data Type: illustrates whether the content is an updating message or a file, for updating message, this value is 2 (unsigned int);

IP: the IP address of the sender (unsigned char);

Object Name: the object that is assigned to utilize this message;

Co-ord System: the coordinate system used to interpret the position, orientation and size in the telegram (unsigned char). There can be, for example, two possible values: “wld” for world co-ord, “app” for object co-ord;

Position: the position of the object in “Object Name”. A position contains three values: x, y, z in float;

Orientation: the orientation of the object in “Object Name”. An orientation is a 4×4 matrix. Each element in the matrix is a float;

State: the state of the object in “Object Name” when necessary (unsigned char). If the object is a tool, the value is one of the four states: MK_CHECK, MK_START_ACTION, MK_DO_ACTION, MK_END_ACTION;

Size: the size of the object in Object Name”. A size contains three values: x, y, z in float; and

End Tag: mark the ending of a telegram (unsigned char).

FIGS. 55(a) through 55(c) illustrate three examples using the format of FIG. 54.

FIG. 55(a) illustrates an updating message for synchronizing the control panel.

FIG. 55(b) illustrates an updating message for synchronizing a widget, and FIG. 55(c) illustrates an updating message for synchronizing a virtual tool.

2. File Transfer

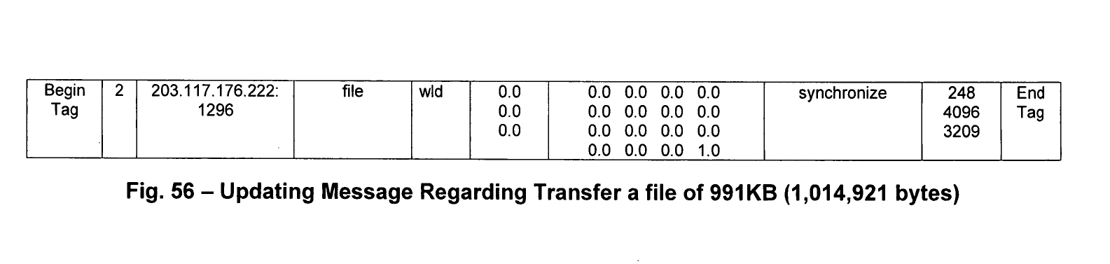

In exemplary embodiments of the present invention, a long file can be split into blocks for transfer. Each telegram can contain one such block. In exemplary embodiments of the present invention, before a file is actually transferred, an updating message can be sent to inform a peer that a file is to be transferred. Format I, as shown in FIG. 54, can be used in such an updating message, provided that the “Size” field can be modified so as to contain Total Block Number (unsigned int), Block Size (unsigned int), and Last Block Size (unsigned int). An example of such an updating message is provided in FIG. 56.

FIG. 56 illustrates an exemplary updating message regarding the transfer of an exemplary file of 991 KB (1,014,921 bytes). Thus, given the data in the Size field, a peer knows that the file has 248 blocks, that each block except the last one has a size of 4096 bytes, and that the last block has 3209 bytes. The file itself can be sent using a second format for updating messages, adapted to file transfer.

3. Format II for Updating Messages

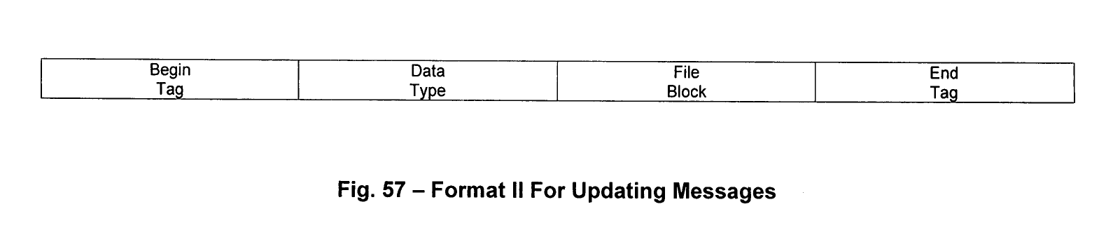

FIG. 57 depicts such a second exemplary format for updating messages. In exemplary embodiments of the present invention, the following fields can be used:

Begin Tag: marks the beginning of a telegram (unsigned char);

Data Type: illustrates whether the content is an updating message or a file, for files, this value is 1 (unsigned int);

File Block: a block of the file in binary (unsigned char); and

End Tag: marks the ending of a telegram (unsigned char).

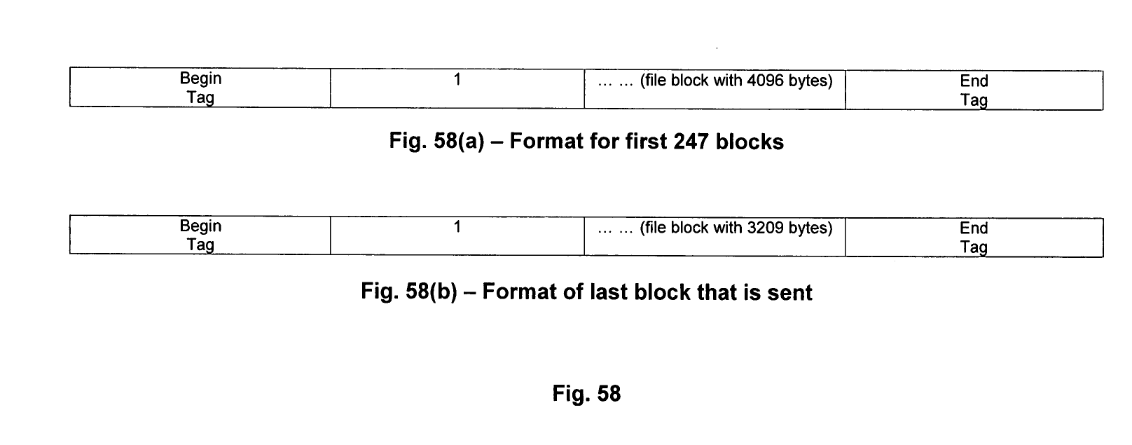

In an exemplary file transfer transmission, the first 247 blocks, each having the 4096 bytes, can, for example, be sent as shown in FIG. 58(a), and the last block, having 3209 blocks, can be sent as shown in FIG. 58(b), using Format II.

While the present invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

1. Apparatus for interactively manipulating a three-dimensional image, the image comprising volumetric data generated from imaging data regarding a subject, the apparatus being configured to:
receive, over a communications link, positional data for one or more remote probes of one or more remote machines;
generate, for display on a local display, a combined three-dimensional scene comprising said at least one remote probe and the three-dimensional image;
manipulate the three-dimensional image in response to manipulations of a local probe by a user local to the apparatus; and
send, over the communications link, data regarding said manipulations by said user local to the apparatus sufficient to allow the said at least one remote machine to display a combined three-dimensional scene comprising an image of the local probe performing manipulations on said three-dimensional image.

2. Apparatus according to claim 1, further configured to filter the data sent regarding said manipulations by said user local to the apparatus in response to network conditions.

3. Apparatus according to claim 2, wherein said filtering drops data packets which do not substantially modify the three-dimensional image.

4. Apparatus according to claim 3, wherein said filtering drops packets that relate to one of tool movement and tool status.

5. Apparatus according to claim 1, further configured to display at least one of an IP address, user name and user designator of the one or more remote machines.

6. Apparatus according to claim 1, wherein the data regarding said manipulations by said user local to the apparatus sent to the said one or more remote machines is sufficient to allow the one or more remote machines to display the image of the local probe performing manipulations on said three-dimensional image by interacting with a virtual control panel of said local machine in the same manner as if said local probe was a probe associated with said one or more remote machines.

7. Apparatus according to claim 1, further configured to receive a snapshot of the display of said one or more remote machines in response to a command of said user local to the apparatus.

8. Apparatus according to claim 1, further configured to cause a synchronization of the three-dimensional image between the apparatus and any of the one or more remote machines in response to a command of said user local to the apparatus.

9. Apparatus according to claim 8, wherein causing said synchronization includes sending a compressed copy of the three-dimensional image as stored on the apparatus to the one or more remote machines.

10. Apparatus according to claim 8, wherein causing said synchronization includes sending a list of interactive commands that were executed on the three-dimensional image at the apparatus.

11. Apparatus according to claim 1, said apparatus being further configured to, in response to a request by a remote user of a remote machine, switch the roles of the local machine and the said remote machine.

12. Apparatus for interactively manipulating a three-dimensional image, the image comprising volumetric data generated from imaging data regarding a subject, the apparatus being configured to:
receive, over a communications link, positional data for a remote probe of a remote machine;
receive positional data for a local probe;
generate, for display on a display, a combined three-dimensional scene comprising the remote probe, the local probe and the three-dimensional image; and
manipulate the three-dimensional image in response to manipulations of the remote probe in a manner substantially equivalent to manipulations of the three-dimensional image by a user local to the remote machine via the local probe.

13. Apparatus according to claim 12, wherein the manipulation of the three-dimensional image in response to the manipulations of the remote probe is displayed as the image of the remote probe interacting with a virtual control panel of said local machine in the same manner as if said remote probe was a probe associated with said apparatus.

14. Apparatus according to claim 12, further configured to display at least one of an IP address, username and user designator of the remote machine.

15. Apparatus according to claim 12, further configured to send a snapshot of the display in response to a command of said remote machine.

16. Apparatus according to claim 12, further configured to synchronize the three-dimensional image using image data sent over the communications link from the remote machine in response to a command from said remote machine.

17. Apparatus according to claim 12, further configured to display the three-dimensional image with one of the same viewpoint as that of a user local to the remote machine and an arbitrary viewpoint different from that of a user local to the remote machine.

18. Apparatus according to claim 17, further configured to display a virtual control panel.

19. Apparatus according to claim 17, further configured to display a specialized local control panel, responsive to commands of a user local to the apparatus, when the three-dimensional image is displayed at an arbitrary viewpoint different from that of a user local to the remote machine.

20. Apparatus according to claim 12, further configured to allow a user to perform local operations on the three-dimensional image.

21. Apparatus according to claim 20, wherein said local operations comprise manipulations that do not affect which voxels are considered as being part of an object.

22. Apparatus according to claim 20, wherein said local operations comprise one or more of translations and rotations of objects and settings of magnification and transparency.

23. Apparatus according to claim 12, further configured to create an additional local copy of the three-dimensional image and manipulate said additional copy in response to manipulations received form a user local to the apparatus.

24. Apparatus according to claim 1, said apparatus being further configured to receive additional data regarding the subject from a remote apparatus local to the subject and local to one of the remote machines, said additional data being co-registered to the three-dimensional image of the subject.

25. Apparatus according to claim 24, wherein said additional data regarding the subject is acquired in substantially real-time.

26. Apparatus according to claim 24, wherein said additional data regarding the subject is one or more of real-time video, pre-recorded video, position data of a probe or instrument local to the subject, fluoroscopic images, ultrasound images and multimodal images.

27. Apparatus according to claim 12, further configured to display additional data regarding the subject from a remote apparatus local to the subject and local to one of the remote machines.

28. Apparatus according to claim 27, wherein said additional data is co-registered to the three-dimensional image of the subject.

29. Apparatus according to claim 27, wherein said additional data is substantially real-time.

30. Apparatus according to claim 27, wherein said additional data is wherein said additional data regarding the subject is one or more of real-time video, pre-recorded video, position data of a probe or instrument local to the subject, fluoroscopic images, ultrasound images and multimodal images.

31. A system for interactively manipulating a three-dimensional image, the image comprising volumetric data generated from imaging data regarding a subject, the system comprising:
a main workstation comprising; a first apparatus being configured to:
receive, over a communications link, positional data for one or more remote probes of one or more remote machines;
generate, for display on a local display, a combined three-dimensional scene comprising said at least one remote probe and the three-dimensional image;
manipulate the three-dimensional image in response to manipulations of a local probe by a user local to the apparatus; and
send, over the communications link, data regarding said manipulations by said user local to the apparatus sufficient to allow the said at least one remote machine to display a combined three-dimensional scene comprising an image of the local probe performing manipulations on said three-dimensional image;
one or more distant workstations, each comprising; a second apparatus, configured to:
receive, over a communications link, positional data for a remote probe of a remote machine;
receive positional data for a local probe;
generate, for display on a display, a combined three-dimensional scene comprising the remote probe, the local probe and the three-dimensional image; and
manipulate the three-dimensional image in response to manipulations of the remote probe in a manner substantially equivalent to manipulations of the three-dimensional image by a user local to the remote machine via the local probe; and
a data network,
wherein the main workstation and each of said one or more distant workstations are connected via the data network.

32. A method for interactively manipulating a three-dimensional image, the image comprising volumetric data generated from imaging data regarding a subject, the method comprising:
providing a first apparatus, said first apparatus being configured to:
receive, over a communications link, positional data for one or more remote probes of one or more remote machines;
generate, for display on a local display, a combined three-dimensional scene comprising said at least one remote probe and the three-dimensional image;
manipulate the three-dimensional image in response to manipulations of a local probe by a user local to the apparatus; and
send, over the communications link, data regarding said manipulations by said user local to the apparatus sufficient to allow the said at least one remote machine to display a combined three-dimensional scene comprising an image of the local probe performing manipulations on said three-dimensional image;
providing one or more second apparati, each of said second apparati being configured to:
receive, over a communications link, positional data for a remote probe of a remote machine;
receive positional data for a local probe;
generate, for display on a display, a combined three-dimensional scene comprising the remote probe, the local probe and the three-dimensional image; and
manipulate the three-dimensional image in response to manipulations of the remote probe in a manner substantially equivalent to manipulations of the three-dimensional image by a user local to the remote machine via the local probe; and
providing a data network and connecting the first apparatus and the one or more second apparati via the data network,
wherein in operation a user at the first apparatus and a user at the one or more second apparati collaboratively visualize a common 3D data set.

33. The method of claim 32, wherein the user at the first apparatus and a user at a second apparatus switch roles at the initiation of the user at the first apparatus.
